(19) United States
(12) Patent Application Publication
(10) Pub. No.: US 2023/0105516 A1
(43) Pub. Date: Apr. 6, 2023

(54) HEAT GENERATING SIDE WINDOW FOR VEHICLE, AND CONTROL APPARATUS FOR CONTROLLING HEAT GENERATING WINDOW FOR VEHICLE

(71) Applicant: ITED INC., Daejeon (KR)

(72) Inventors: Jee Hoon SEO, Namyangju-si (KR); Bu Jong KIM, Seoul (KR); Kum Pyo YOO, Anseong-si (KR)

(21) Appl. No.: 18/078,719

(22) Filed: Dec. 9, 2022

Related U.S. Application Data
(63) Continuation of application No. PCT/KR2021/007300, filed on Jun. 10, 2021.

(30) Foreign Application Priority Data
Jun. 11, 2020 (KR) 10-2020-0071052
Feb. 24, 2021 (KR) 10-2021-0025058
Feb. 24, 2021 (KR) 10-2021-0025059

(51) Int. Cl. B60J 1/00; H05B 3/84; B60J 1/08; H01B 5/00

(52) U.S. Cl. CPC B60J 1/002; H05B 3/84; B60J 1/08; H01B 5/00; H05B 2203/016; H05B 2214/02; B60R 16/02

(57) ABSTRACT

The present application relates to a heat generating side window, for a vehicle, comprising: a substrate comprising an upper edge, a lower edge, a front edge and a rear edge; a heat generating member positioned adjacently to the substrate; an upper busbar positioned on the heat generating member and electrically connected to the heat generating member; and a lower busbar positioned on the heat generating member and electrically connected to the heat generating member.

### CROSS-REFERENCE TO RELATED APPLICATIONS

This application is a bypass continuation application of International PCT Application No. PCT/KR2021/007300, filed on Jun. 10, 2021, which claims priority to Republic of Korea Patent Application No. 10-2020-0071052, filed on Jun. 11, 2020, Republic of Korea Patent Application No. 10-2021-0025059, filed on Feb. 24, 2021, and Republic of Korea Patent Application No. 10-2021-0025058, filed on Feb. 24, 2021, which are incorporated by reference herein in their entirety.

### TECHNICAL FIELD

This application relates to a vehicle window, and more specifically, to a vehicle window capable of performing de-icing and de-fogging or de-icing and defogging by heat generated by a heating member when a voltage is applied to a busbar positioned on the vehicle window.

In addition, the application relates to a control device for controlling a heating window of a vehicle, and specifically, to a control device busbar that outputs a pulse when receiving an electrical signal from an input unit to apply a voltage to a busbar positioned on a vehicle heating window so that a heating member is heated when the voltage is applied to the busbar so as to perform de-icing and defogging on fog, frost, or ice generated on the vehicle window.

### BACKGROUND

When fog, ice, or frost is generated on a window while a vehicle travels due to a difference between an external temperature and an internal temperature of the vehicle, de-icing and defogging are conventionally performed by blowing air to the vehicle window to change a temperature of the window.

However, when air is applied to the vehicle window, the air is circulated to an inner side by a user's operation, and at this time, there is a problem in that the temperature inside the vehicle is also changed, and a temperature inside the vehicle is unintentionally changed. In addition, when de-icing and defogging are performed in the form of indirect heating using air, there is a disadvantage in that it takes a long time.

In order to solve the problem, various attempts for removing fog, ice, or frost due to a difference between temperatures inside and outside a vehicle have been continuously made in an auto manufacturing industry focusing on vehicles, and recently, a method of heating a window using a conductive wire such as a tungsten wire is suggested. However, even in this case, there is a problem in that heating is concentrated only in a region adjacent to the conductive wire, and thus a glass of the vehicle is damaged.

### SUMMARY

One aspect of the present invention is directed to providing a vehicle heating window which performs de-icing and defogging by applying a voltage to the vehicle heating window.

Another aspect of the present invention is directed to providing a control device that applies a voltage to a vehicle heating window to perform de-icing and defogging.

An embodiment of the present invention may provide a heat-generating vehicle side window including a base including an upper edge, a lower edge, a front edge, and a rear edge, a heating member positioned adjacent to the base, an upper busbar positioned on the heating member and electrically connected to the heating member, and a lower busbar positioned on the heating member and electrically connected to the heating member, wherein at least a portion of the heat-generating vehicle side window is covered by a frame including an upper frame, a lower frame, and side frames that are a front frame and a rear frame, the upper busbar has a shape corresponding to the upper edge and is formed in a three-dimensional curved structure having a side curvature and a sectional curvature, the upper busbar includes a first region and a second region, the first region is a region adjacent to the rear edge and has a first side curvature, and the second region is spaced apart from the rear edge and includes a portion having a second side curvature greater than the first side curvature.

An embodiment of the present invention may provide a heat-generating vehicle side window including a base including an upper edge, a lower edge, a front edge, and a rear edge, a heating member positioned adjacent to the base, an upper busbar positioned on the heating member, electrically connected to the heating member, having one end and the other end, and formed to extend to correspond to the upper edge, and a lower busbar positioned on the heating member, electrically connected to the heating member, and having one end and the other end, wherein at least a portion of the heat-generating vehicle side window is covered by a frame including an upper frame, a lower frame, and side frames that are a front frame and a rear frame, the heat-generating vehicle side window is movable, a first virtual line positioned between the one end of the upper busbar and the one end of the lower busbar among a plurality of virtual lines parallel to a moving direction of the heat-generating vehicle side window is present, a distance between the front edge and the first virtual line is longer than a distance between the front edge and the one end of the upper busbar, and the distance between the front edge and the first virtual line is shorter than a distance between the front edge and the one end of the lower busbar.

An embodiment of the present invention may provide a control device for controlling a temperature of a vehicle heating window including a busbar, wherein the control device applies a voltage to the vehicle heating window on the basis of a received electrical signal when receiving the electrical signal from an input unit, the control device sequentially activates a de-icing mode and a defogging mode when receiving a start signal, the control device activates the de-icing mode after receiving the start signal, performs the driving of de-icing when receiving the electrical signal, and activates a defogging mode after terminating the de-icing mode when the driving of the de-icing is terminated, the control device performs the driving of defogging in the defogging mode when receiving the electrical signal from the input unit, the control device outputs a pulse having a first power when driving the de-icing and outputs a pulse having a second power when driving the defogging, and the first power is higher than the second power.

An embodiment of the present invention may provide a vehicle heating window including a heating member positioned in a region adjacent to the vehicle heating window, two or more busbars positioned on the heating member and electrically connected to the heating member, and a control device for controlling a temperature of the vehicle heating window by applying a voltage to the busbar on the basis of a received electrical signal when receiving the electrical signal from an input unit, wherein the control device sequentially activates a de-icing mode and a defogging mode when receiving a start signal, the control device controls the de-icing mode to be activated after receiving the start signal and de-icing for each of the vehicle heating windows to be driven when receiving the electrical signal from the input unit and controls a defogging mode to be activated after terminating the de-icing mode when the driving of the de-icing is terminated, the control device outputs a pulse having a first power when driving the de-icing and outputs a pulse having a second power when driving the defogging, and the first power is higher than the second power.

The entirety of a heat-generating vehicle side window according to an embodiment of the present invention can be uniformly heated, thereby securing durability against thermal stresses.

In the heat-generating vehicle side window according to the embodiment of the present invention, a region adjacent to a side mirror can be preferentially heated, thereby making it easy to secure a user's view when a vehicle travels.

In the heat-generating vehicle side window according to the embodiment of the present invention, a voltage can be selectively applied to a region desired by a user.

A control device according to an embodiment of the present invention can sequentially perform de-icing and defogging.

### BRIEF DESCRIPTION OF THE DRAWINGS

FIG. 1 is an overall view showing an overall structure, a frame, a vehicle heating window, and a control device of a vehicle according to a first embodiment.

FIG. 2 is a view showing a three-dimensional curved structure and sectional curvature of the vehicle.

FIG. 3 is a view showing a three-dimensional curved structure and side curvature of the vehicle.

FIG. 4 is a cross-sectional view showing a cross-sectional structure of the vehicle heating window according to the first embodiment.

FIG. 5 is a view showing a heat-generating vehicle side window according to the first embodiment.

FIG. 6 is a view showing a side curvature of a busbar of the heat-generating vehicle side window according to the first embodiment.

FIG. 7 is a graph showing temperatures of a front region and a rear region when the heat-generating vehicle side window according to the first embodiment is heated.

FIG. 8 is a graph showing temperature rise values of the front region and the rear region of the heat-generating vehicle side window according to the first embodiment.

FIG. 9 is a graph showing a temperature difference between the front region and the rear region of the heat-generating vehicle side window according to the first embodiment on the basis of the temperature rise values in FIG. 8.

FIG. 10 is a view showing a virtual line positioned on the heat-generating vehicle side window according to the first embodiment.

FIG. 11 is a view showing the movement of the heat-generating vehicle side window according to the first embodiment in a first direction or a second direction.

FIG. 12 is a view showing a state in which the heat-generating vehicle side window according to the first embodiment is positioned at a second position.

FIG. 13 is a view showing a heat-generating vehicle side window according to a second embodiment.

FIG. 14 is a view showing a side curvature of a busbar of the heat-generating vehicle side window according to the second embodiment.

FIG. 15 is a graph showing temperatures of a front region and a rear region when the heat-generating vehicle side window according to the second embodiment is heated.

FIG. 16 is a graph showing temperature rise values of the front region and the rear region of the heat-generating vehicle side window according to the second embodiment.

FIG. 17 is a graph showing a temperature difference between the front region and the rear region of the heat-generating vehicle side window according to the second embodiment on the basis of the temperature rise values in FIG. 16.

FIG. 18 is a graph showing the temperature rise values of the front regions when the heat-generating vehicle side windows according to the first embodiment and the second embodiment are heated.

FIG. 19 is a graph showing the temperature rise values of the rear regions of the heat-generating vehicle side windows according to the first embodiment and the second embodiment.

FIG. 20 is a graph showing the temperature differences between the front regions and the rear regions of the heat-generating vehicle side windows according to the first embodiment and the second embodiment.

FIG. 21 is a view showing a heat-generating vehicle side window according to a third embodiment.

FIG. 22 is a waveform diagram showing a sequence of voltages applied to a first lower busbar and a second lower busbar according to the third embodiment.

FIG. 23 is a view showing a heat-generating vehicle side window according to a fourth embodiment.

FIG. 24 is a view showing a heat-generating vehicle side window according to a fifth embodiment.

FIG. 25 is a waveform diagram showing a sequence of voltages applied to a first lower busbar and a second lower busbar according to the fifth embodiment.

FIG. 26 is a cross-sectional view showing a cross-sectional structure of a heat-generating vehicle side window according to a sixth embodiment.

FIG. 27 is a view showing a heat-generating vehicle side window according to a seventh embodiment.

FIGS. 28 and 29 are views showing a heat-generating vehicle side window according to an eighth embodiment.

FIG. 30 is a view showing a heat-generating vehicle side window according to a ninth embodiment.

FIG. 31 is a view of a vehicle heating window system.

FIG. 32 is a flowchart showing a sequence in which de-icing or defogging is performed in a control device according to a tenth embodiment.

FIG. 33 is a waveform diagram showing a time and a voltage when the control device according to the tenth embodiment performs de-icing and defogging.

FIG. 34 is a waveform diagram showing the driving of defogging of the control device according to the tenth embodiment.

FIG. 35 is a waveform diagram showing the driving of de-icing and defogging of the control device according to the tenth embodiment.

FIG. 36 is a waveform diagram showing the driving of de-icing and defogging of the control device according to the tenth embodiment.

FIG. 37 is a waveform diagram showing the driving of de-icing and defogging of a control device according to an eleventh embodiment.

FIGS. 38 and 39 are a flowchart and a waveform diagram showing that a control device according to the twelfth embodiment performs de-icing and defogging and then re-performs the de-icing.

FIG. 40 is a waveform diagram showing the driving of de-icing and defogging of the control device according to the twelfth embodiment.

FIG. 41 is a waveform diagram showing the driving of de-icing and defogging of a control device according to a thirteenth embodiment.

FIG. 42 is a waveform diagram showing the driving of de-icing and defogging of a control device according to a fourteenth embodiment.

FIG. 43 is a view of a vehicle heating window system.

FIG. 44 is a waveform diagram showing a sequence in which the control device applies a voltage to the vehicle heating window.

### DETAILED DESCRIPTION

Embodiments described in the specification are to clearly describe the spirit of the present invention to those skilled in the art to which the present invention pertains and thus are not limited by the embodiments described in the specification, and the scope of the present invention should be construed as including modifications or variations which do not depart from the spirit of the present invention.

Terms used in the specification have been selected as widely used general terms as possible in consideration of the functions in the present invention but may vary depending on the intention of those skilled in the art to which the present invention pertains, custom, or the emergence of new technology. However, unlike the above, when a specific term is defined and used in an arbitrary sense, the meaning of the term will be separately described. Therefore, the terms used in the specification should be construed on the basis of the actual meaning of the terms and the contents throughout the specification rather than the names of simple terms.

Since the drawings attached to the specification are to easily describe the present invention, and the shapes shown in the drawings may be exaggeratedly shown as necessary to help understand the present invention, the present invention is not limited by the drawings.

In addition, components having the same function within the scope of the same idea shown in the drawing of each embodiment will be described using the same reference numerals. The term “and/or” includes one or more combinations which may be defined by the associated configurations.

It should be understood that the term such as “comprise or include” is intended to specify that a feature, a number, a step, an operation, a component, a part, or a combination thereof described in the specification is present and does not preclude the possibility of the presence or addition of one or more other features, numbers, steps, operations, components, parts, or combinations thereof in advance.

In the specification, when it is determined that a detailed description of a known configuration or function related to the present invention may obscure the gist of the present invention, a detailed description thereof will be omitted, as necessary.

According to an embodiment of the present invention, a heat-generating vehicle side window comprising: a base including an upper edge, a lower edge, a front edge, and a rear edge; a heating member positioned adjacent to the base; an upper busbar positioned on the heating member and electrically connected to the heating member; and a lower busbar positioned on the heating member and electrically connected to the heating member, wherein at least a portion of the heat-generating vehicle side window is covered by a frame including an upper frame, a lower frame, and side frames that are a front frame and a rear frame, wherein the upper busbar has a shape corresponding to the upper edge and is formed in a three-dimensional curved structure having a side curvature and a sectional curvature, wherein the upper busbar includes a first region and a second region, wherein the first region is a region adjacent to the rear edge and has a first side curvature, and wherein the second region is spaced apart from the rear edge and includes a portion having a second side curvature greater than the first side curvature.

In addition, wherein the lower busbar is formed in a three-dimensional curved structure having the side curvature and the sectional curvature, wherein the lower busbar includes a third region and a fourth region, wherein the third region is a region adjacent to the rear edge and has a third side curvature, and wherein the fourth region is spaced apart from the rear edge and includes a portion having a fourth side curvature greater than the third side curvature.

In addition, wherein the first region has a first circle that is a virtual circle corresponding to the first side curvature, wherein the second region has a second circle that is a virtual circle corresponding to the second side curvature, and wherein a radius of the first circle is greater than a radius of the second circle.

In addition, wherein the third region has a third circle that is a virtual circle corresponding to the third side curvature, wherein the fourth region has a fourth circle that is a virtual circle corresponding to the fourth side curvature, and wherein a radius of the third circle is greater than a radius of the fourth circle.

In addition, wherein the first region has a first sectional curvature, and wherein the first sectional curvature is smaller than the first side curvature.

In addition, wherein the upper busbar includes a straight region, wherein the straight region is parallel to the lower frame, wherein the straight region is covered by the side frame when the heat-generating vehicle side window moves in a first direction or second direction, wherein the first direction is a direction toward the lower frame, wherein the second direction is a direction toward the upper frame, and wherein the straight region is the first region.

In addition, wherein the upper busbar and the lower busbar include regions to which the side curvature corresponds, wherein the first region and the third region are regions corresponding to each other, and wherein the second region and the fourth region are regions corresponding to each other.

In addition, wherein the upper busbar and the lower busbar include regions to which the side curvature partially corresponds, wherein the first region and the third region are regions corresponding to each other, and wherein the second side curvature of the second region is greater than the fourth side curvature of the fourth region.

In addition, wherein the lower busbar includes a first lower busbar and a second lower busbar, and wherein the first lower busbar and the second lower busbar are positioned to be spaced apart from each other.

In addition, wherein the first lower busbar is positioned between the upper busbar and the second lower busbar.

In addition, wherein the first lower busbar and the second lower busbar are formed to extend from the lower edge to the rear edge.

In addition, wherein the first lower busbar receives a first voltage from a control device, wherein the second lower busbar receives a second voltage from the control device, and wherein the first voltage and the second voltage are alternately applied.

In addition, wherein the second lower busbar includes the third region and the fourth region, and wherein the first lower busbar is formed in a region corresponding to the fourth region of the second lower busbar.

In addition, wherein the third region of the lower busbar and the fourth region of the lower busbar are positioned to be spaced apart from each other.

In addition, wherein the first lower busbar receives a first voltage from a control device, wherein the second lower busbar receives a second voltage from the control device, and wherein the second voltage is applied after the first voltage is applied and a preset time elapses.

In addition, wherein the upper busbar has a higher transmittance from the upper edge toward the lower edge.

In addition, wherein the upper busbar includes a plurality of first metal lines and a plurality of second metal lines, wherein the plurality of first metal lines are parallel to each other and formed to extend from the front edge to the rear edge, wherein the plurality of second metal lines are parallel to each other and formed to extend from the upper edge to the lower edge, and wherein each of the first metal lines crosses each of the second metal lines and is electrically connected to each other.

In addition, wherein a metal line adjacent to the upper edge among the plurality of first metal lines has a greater line width than a metal line adjacent to the lower edge among the plurality of first metal lines.

In addition, wherein an interval between the second metal lines adjacent to the upper edge is smaller than an interval between the second metal lines adjacent to the lower edge.

In addition, wherein at least any one of one end and the other end of the upper busbar has a curved shape, and wherein at least any one of one end and the other end of the lower busbar has a curved shape.

According to an embodiment of the present invention, there may be provided a heat-generating vehicle side window including a base including an upper edge, a front edge, and a rear edge, a heating member positioned adjacent to the base, an upper busbar positioned on the heating member, electrically connected to the heating member, having one end and the other end, and formed to extend to correspond to the upper edge, and a lower busbar positioned on the heating member, electrically connected to the heating member, and having one end and the other end, wherein at least a portion of the heat-generating vehicle side window is covered by a frame including a front frame, a rear frame, an upper frame, and a lower frame, the heat-generating vehicle side window is movable, a first virtual line positioned between the one end of the upper busbar and the one end of the lower busbar among a plurality of virtual lines parallel to a moving direction of the heat-generating vehicle side window is present, a distance between the front edge and the first virtual line is longer than a distance between the front edge and the one end of the upper busbar, and the distance between the front edge and the first virtual line is shorter than a distance between the front edge and the one end of the lower busbar.

In addition, there may be provided a heat-generating vehicle side window in which a second virtual line positioned between the other end of the upper busbar and the other end of the lower busbar among the plurality of virtual lines parallel to the moving direction of the heat-generating vehicle side window is present, the other end of the upper busbar is positioned adjacent to a retreat direction of a vehicle with respect to the second virtual line, and the other end of the lower busbar is positioned adjacent to an advance direction of the vehicle with respect to the second virtual line.

According to an embodiment of the present invention, there may be provided a control device for controlling a temperature of a heat-generating vehicle side window including a busbar, wherein the control device applies a voltage to the vehicle heating window on the basis of a received electrical signal when receiving the electrical signal from an input unit, the control device sequentially activates a de-icing mode and a defogging mode when receiving a start signal, the control device activates the de-icing mode after receiving the start signal, performs the driving of de-icing when receiving the electrical signal from the input unit, and activates the defogging mode after terminating the de-icing mode when the driving of the de-icing is terminated, the control device performs the driving of defogging in the defogging mode when receiving the electrical signal from the input unit, the control device outputs a pulse having a first power when driving the de-icing and outputs a pulse having a second power when driving the defogging, and the first power is higher than the second power.

In addition, there may be provided a control device that applies a first voltage to the busbar in the de-icing mode and applies a second voltage to the busbar in the defogging mode, wherein the first voltage may be higher than the second voltage.

In addition, there may be provided a control device that applies the first voltage to the busbar for a predetermined time in the de-icing mode, and applies the second voltage for the same predetermined time as that in the de-icing mode in the defogging mode.

In addition, there may be provided a control device that applies the voltage to the busbar for a first time in the de-icing mode and applies the voltage to the busbar for a second time in the defogging mode, wherein the first time is longer than the second time.

In addition, there may be provided a control device that applies a predetermined voltage to the busbar for the first time in the de-icing mode and applies the predetermined voltage having the same magnitude as that in the de-icing mode to the busbar for the second time in the defogging mode.

In addition, there may be provided a control device that maintains an active state of the defogging mode until a vehicle is turned off when the defogging mode is activated.

In addition, there may be provided a control device that performs the driving of defogging by outputting a pulse for a first predetermined time and, when receiving the electrical signal while performing the driving of the defogging, performs the driving of the defogging for a longer time than the first predetermined time.

In addition, there may be provided a control device that stops the voltage application during an overheating prevention section when driving the defogging for a second predetermined time.

In addition, there may be provided a control device in which the overheating prevention section is shorter than the first predetermined time.

In addition, there may be provided a control device that outputs a pulse for driving the defogging after passing the overheating prevention section.

In addition, there may be provided a control device that performs the driving of the defogging when receiving the electrical signal after passing the overheating prevention section.

In addition, the input unit is a user interface through which a user input may receive, and there may be provided a control device that performs the driving of the de-icing when receiving a de-icing signal through the user interface in the defogging mode.

In addition, the input unit is a user interface through which a user input may receive, and there may be provided a control device that activates the defogging mode after terminating the de-icing mode and perform the driving of the defogging when receiving a defogging signal through the user interface in the de-icing mode.

In addition, there may be provided a control device that controls the defogging mode to be activated after terminating the de-icing mode when not receiving the electrical signal from the input unit for a preset time in the de-icing mode.

In addition, the input unit is a user interface through which a user input may receive, and there may be provided a control device that outputs a voltage for a shorter time than a predetermined time when receiving an end signal through the user interface in the de-icing mode.

According to an embodiment of the present invention, there may be provided a vehicle heating window including a heating member positioned in a region adjacent to the vehicle heating window, two or more busbars positioned on the heating member and electrically connected to the heating member, and a control device for controlling a temperature of the vehicle heating window by applying a voltage to the busbar on the basis of a received electrical signal when receiving the electrical signal from an input unit, wherein the control device sequentially activates a de-icing mode and a defogging mode when receiving a start signal, the control device controls the de-icing mode to be activated after receiving the start signal and deicing for each of the vehicle heating window to be driven when receiving the electrical signal from the input unit and controls the defogging mode to be activated after terminating the de-icing mode when the driving of the de-icing is terminated, the control device outputs a pulse having a first power when driving the de-icing and outputs a pulse having a second power when driving the defogging, and the first power is higher than the second power.

In addition, there may be provided a vehicle heating window that includes a vehicle front heating window, a heat-generating vehicle side window, and a vehicle rear heating window, and controls the vehicle front heating window and a front region of the heat-generating vehicle side window to be heated within a predetermined time when receiving the electrical signal in the de-icing mode or the defogging mode and control a rear region of the heat-generating vehicle side window and the vehicle rear heating window to be heated after the predetermined time.

According to an embodiment of the present invention, there may be provided a heat-generating vehicle side window including a base made of a transparent material in order to provide a side view to a driver and including a front region and a rear region, a heating member positioned in a region adjacent to the base, an upper busbar positioned on the heating member and electrically connected to the heating member, and a lower busbar positioned on the heating member and electrically connected to the heating member, wherein the heat-generating vehicle side window is heated by a voltage applied to the upper busbar and the lower busbar, a temperature difference between the front region and the rear region in a first section after a time point when the voltage is applied to the upper busbar and the lower busbar is greater than a temperature difference between the front region and the rear region in a second section after the first section, and the first section and the second section is divided on the basis of a median time point.

In addition, there may be provided a heat-generating vehicle side window in which the temperature difference between the front region and the rear region of the first section is greater than a reference temperature difference, the temperature difference between the front region and the rear region in the second section is smaller than the reference temperature difference, and the reference temperature difference is the temperature difference between the front region and the rear region at the median time point.

In addition, there may be provided a heat-generating vehicle side window in which an average temperature difference between the front region and the rear region of the first section is greater than the average temperature difference between the front region and the rear region of the second section, and the median time point is a time point when the average temperature differences of the first section and the second section become different.

In addition, there may be provided a heat-generating vehicle side window in which the second section includes a section in which the temperature difference between the front region and the rear region is constantly maintained.

In addition, there may be provided a heat-generating vehicle side window in which the second section includes some sections in which the temperature of the front region is equally maintained, and includes some sections in which the temperature of the rear region is equally maintained.

In addition, there may be provided a heat-generating vehicle side window in which the temperature difference between the front region and the rear region at a first time point after a time point when the voltage is applied to the upper busbar and the lower busbar is greater than the temperature difference between the front region and the rear region at a second time point after the first time point, the first time point is any one time point of the first section, and the second time point is any one time point of the second section.

In addition, there may be provided a heat-generating vehicle side window in which the first time point is a time point when the temperature of the front region is higher than the temperature of the rear region, and the second time point is a time point when the temperature of the front region is higher than or equal to the temperature of the rear region.

In addition, there may be provided a heat-generating vehicle side window in which the first time point is a time point when the temperature difference between the front region and the rear region is the greatest, and the second time point is a time point when the temperature difference between the front region and the rear region is the smallest.

In addition, there may be provided a heat-generating vehicle side window in which the temperatures of the front region and the rear region at the second time point are the same.

In addition, there may be provided a heat-generating vehicle side window in which temperature rise rates of the front region and the rear region in the first section are greater than temperature rise rates of the front region and the rear region in the second section, and the median time point is a time point when the temperature rise rates of the front region and the rear region become different.

In addition, there may be provided a heat-generating vehicle side window in which the temperature rise rate of the front region in the first section corresponds to the temperature rise rate of the rear region in the second section, and the temperature rise rate of the front region in the second section corresponds to the temperature rise rate of the rear region in the second section.

In addition, there may be provided a heat-generating vehicle side window in which the temperature rise rate of the front region in the first section is greater than the temperature rise rate of the rear region in the first section, and the temperature rise rate of the front region in the second section corresponds to the temperature rise rate of the rear region in the second section.

In addition, there may be provided a heat-generating vehicle side window in which the first section includes a steady section, the steady section is a partial section in which the temperature of the front region is equally maintained, and the steady section is a partial section in which the temperature of the rear region is equally maintained.

In addition, there may be provided a heat-generating vehicle side window in which the steady section is a predetermined time from a time point when the voltage is applied to the busbar.

In addition, there may be provided a heat-generating vehicle side window in which a temperature rise rate in a section adjacent to the steady section of the first section is greater than a temperature rise rate in a section adjacent to the second section of the first section.

In addition, there may be provided a heat-generating vehicle side window in which a temperature rise rate in a section adjacent to the first section of the second section is greater than a temperature rise rate in a section spaced apart from the first section of the second section.

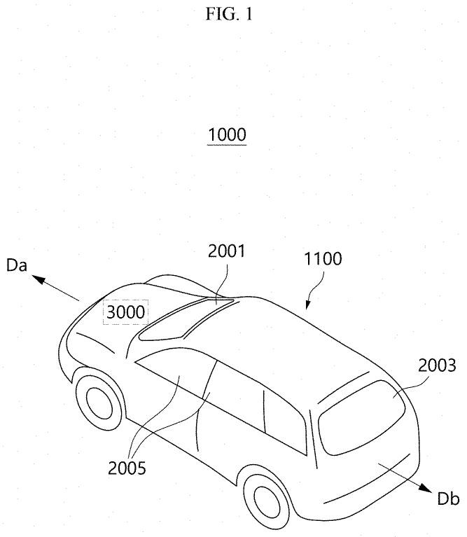

FIG. 1 is an overall view showing the overall structure, a frame 1100, a vehicle heating window 2000, and a control device 3000 of a vehicle 1000 according to a first embodiment.

Referring to FIG. 1, a general advance direction of the vehicle 1000 according to the first embodiment may be defined as a forward direction Da, and a retreat direction of the vehicle 1000 may be defined as a backward direction Db. The forward direction Da and the backward direction Db may be opposite.

The vehicle 1000 may include the frame 1100, the vehicle heating window 2000, and the control device 3000.

The frame 1100 is a skeleton constituting the overall structure of the vehicle 1000 and may be made of a rigid material, such as metal capable of providing functions of damping external shocks, windproofing, waterproofing, and the like. The frame 1100 may be equipped with parts necessary for performing functions of the vehicle 1000, such as the vehicle heating window 2000 or vehicle wheels.

The vehicle heating window 2000 forms a portion of an exterior of the vehicle 1000 and is mounted on the frame 1100. In this case, a portion of the vehicle heating window 2000 may be covered by the frame 1100. The vehicle heating window 2000 can secure a user's visibility to external environments and provide functions of preventing intrusion from an outside of the vehicle 1000, windproofing, waterproofing, and the like.

The vehicle heating window 2000 may be heated by receiving a voltage from the control device 3000, thereby preventing or removing fog, frost, or ice generated in the vehicle 1000. The fog, frost, or ice may already be generated upon starting and may also be generated while a vehicle travels. The removal of the fog is defined as defogging, and the removal of the frost or the ice is defined as de-icing.

The vehicle heating window 2000 may include a vehicle front heating window 2001, a vehicle rear heating window 2003, and a heat-generating vehicle side window 2005.

The vehicle front heating window 2001 may be positioned in a main viewing direction of a driver who drives the vehicle 1000.

The vehicle rear heating window 2003 may be positioned in a direction opposite to the main viewing direction of the driver who drives the vehicle 1000.

The heat-generating vehicle side window 2005 is positioned between the vehicle front heating window 2001 and the vehicle rear heating window 2003. Four heat-generating vehicle side windows 2005 may be mounted on both side surfaces of the vehicle 1000. The heat-generating vehicle side window 2005 may be mounted on a front left surface, front right surface, rear left surface, and rear right surface of both side surfaces of the vehicle 1000. The front side refers to a region of the side surface of the vehicle 1000 in the forward direction Da, and the rear side refers to a region thereof in the backward direction Db. In the embodiment, the heat-generating vehicle side windows 2005 mounted on the front left surface and the front right surface will be mainly described, but features to be described below may also be applied to the heat-generating vehicle side windows 2005 mounted on the rear left surface and the rear right surface.

In addition, only two heat-generating vehicle side windows 2005 may be mounted on both side surfaces of the vehicle 1000. In this case, the heat-generating vehicle side windows 2005 may be mounted only on the front left surface and front right surface of both side surfaces of the vehicle 1000, and a general-purpose window other than the heat-generating vehicle side window 2005 may be mounted on the rear left surface and rear right surface.

The vehicle heating window 2000 may be mounted on the frame 1100 having a shape in which a portion of the vehicle 1000 is open toward the outside. A shape of a portion where the vehicle heating window 2000 is visually recognized may correspond to a shape of the frame 1100.

The control device 3000 may supply a voltage to the vehicle heating window 2000. The control device 3000 may receive a voltage from an external component and supply the voltage to the vehicle heating window 2000 on the basis of the received voltage. For example, the control device 3000 may receive a voltage from a battery of the vehicle and supply a voltage to the vehicle heating window 2000 on the basis of the received voltage.

The vehicle heating window 2000 may be heated by the received voltage and may remove fog, frost, or ice generated on a vehicle glass due to the heat generated at this time.

The vehicle 1000 according to the first embodiment may have a three-dimensional curved structure. The frame 1100 may have a three-dimensional curved structure, and the vehicle heating window 2000 may also have a three-dimensional curved structure.

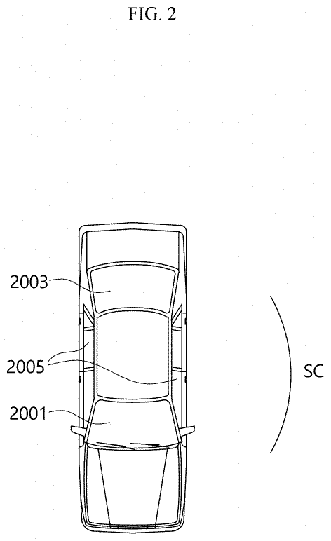

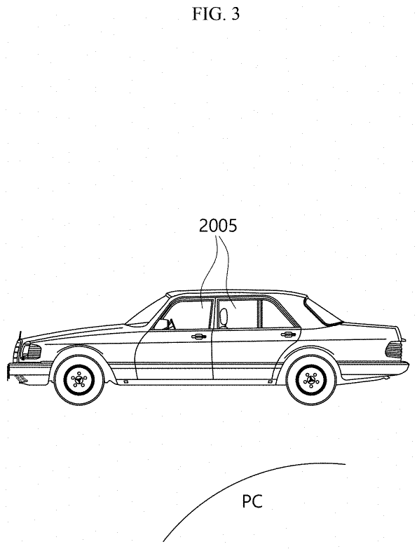

The three-dimensional curved structure of the vehicle 1000 may be defined as a sectional curvature SC in FIG. 2 and a side curvature PC in FIG. 3.

The sectional curvature SC of the vehicle 1000 may be defined as a curvature of an exterior of the vehicle 1000 when the vehicle 1000 is viewed in a direction of gravity, and the side curvature PC of the vehicle 1000 may be defined as a curvature of the exterior of the vehicle 1000 when the vehicle 1000 is viewed from a side surface of the vehicle 1000. The shapes of the vehicle heating window 2000 and the frame 1100 are not limited to the shapes defined in the drawings and may generally be dependent on the overall design of the vehicle 1000.

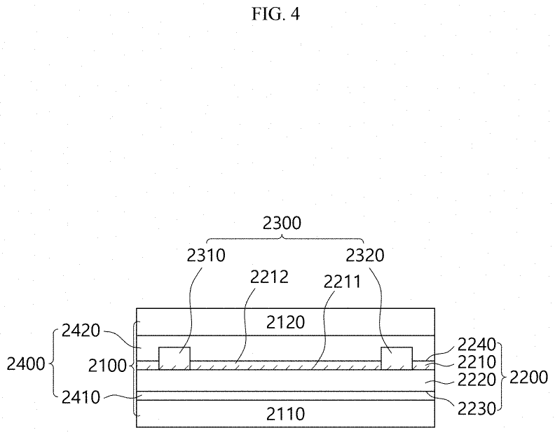

FIG. 4 is a cross-sectional view showing a cross-sectional structure of the vehicle heating window according to the first embodiment.

Referring to FIG. 4, the vehicle heating window 2000 according to the first embodiment may include a base 2100, a heating member 2200, and an intermediate layer 2400. The vehicle heating window 2000 may include a busbar 2300 that is in contact with the heating member 2200.

In the vehicle heating window 2000, the intermediate layer 2400 is injected in a state where the heating member 2200 is positioned in a region adjacent to the base 2100, and thus the heating member 2200 may be fixed to the base 2100.

In the vehicle heating window 2000, the heating member 2200 may be heated by a voltage applied to the heating member 2200 through the busbar 2300, and thus the vehicle heating window 2000 may be heated to remove fog, frost, or ice.

The base 2100 forms a portion of the exterior of the vehicle 1000 and is mounted on the frame 1100. In this case, a portion of the base 2100 may be covered by the frame 1100. The base 2100 may perform functions of preventing intrusion from the outside, mitigating noise, windproofing, and waterproofing.

The base 2100 may be optically transparent. A user of the vehicle 1000 may secure the user's view while the vehicle travels through the base 2100.

The base 2100 may be formed of a glass or plastic consisting of hydrocarbons. The base 2100 may be made of a glass containing plastic or the like, but the present invention is not limited thereto.

One or more substrates 2100 may be provided. As shown in FIG. 4, when two substrates 2100 are provided, the base 2100 may include a first substrate 2110 and a second substrate 2120. The first substrate 2110 may be positioned in a region close to the outside of the vehicle 1000. The second substrate 2120 may be positioned in a region close to the inside of the vehicle 1000. Shapes of the first substrate 2110 and the second substrate 2120 may correspond to each other.

The heating member 2200 may be positioned adjacent to the base 2100. When the base 2100 includes the first substrate 2110 and the second substrate 2120, the heating member 2200 may be positioned between the first substrate 2110 and the second substrate 2120.

The heating member 2200 may be positioned to correspond to the entire region of the base 2100 or positioned to correspond to a portion of the base 2100. Specifically, based on when the base 2100 is mounted on the frame 1100, the heating member 2200 may be positioned in a region corresponding to an opening of the frame 1100 or positioned at the opening of the frame 1100 to overlap a portion of the frame 1100.

The heating member 2200 is a heating element heated by receiving the voltage through the busbar 2300. The heating member 2200 may transmit heat to the base 2100. In this case, the vehicle heating window 2000 may perform defogging or de-icing.

The heating member 2200 may be optically transparent. The heating member 2200 may be formed to be transparent, and thus light transmitting the base 2100 may transmit the heating member 2200 and may be output.

The heating member 2200 may include a heating element 2210 and a substrate 2220.

The heating element 2210 may include a nano-structure 2211 and a matrix 2212.

The nano-structure 2211 may provide a passage through which electrons move. The nano-structure 2211 may include a nano-structure made of silver nano-wires (AgNW), graphene, silver (Ag), gold (Au), platinum (Pt), copper (Cu), or other metals, and the present invention is not limited thereto. The nano-structure 2211 may have a hybrid structure in which two or more types of nano-structures are combined. In other words, the nano-structure 2211 may be formed as a plurality of metal nano-structures. The nano-structure 2211 may be formed in a network structure in which the plurality of metal nano-structures are connected.

The nano-structure 2211 may be imprinted and positioned on the substrate 2220. In this case, the nano-structure 2211 may be partially buried in the substrate 2220. Alternatively, the nano-structure 2211 may be transferred and positioned on the substrate 2220.

When the nano-structure 2211 is imprinted or transferred on the substrate 2220, heat, pressure, or the like may be applied to the nano-structure 2211. Therefore, a size and/or shape of the nano-structure 2211 may be changed. Specifically, a cross section of the nano-structure 2211 may be changed from a circular shape to an elliptical shape. In this case, the surface roughness of the heating element 2210 may be changed. Preferably, the surface roughness of the heating element 2210 can be reduced. Therefore, haze of the light transmitting the heating element 2210 can be reduced.

The matrix 2212 may be used to protect the nano-structure 2211 from external air or moisture and maintain the shape of the nano-structure 2211.

The matrix 2212 may be made of a conductive material. The matrix 2212 may be made of a single material or may also be made of a composite of several materials. The matrix 2212 may be made of the same material as the base 2100. The matrix 2212 may be made of a polymer having a hydrocarbon structure. The matrix 2212 may be made of the conductive material, but the present invention is not limited thereto. When the matrix 2212 is made of the conductive material, the matrix 2212 may provide an additional electrical connection between the nano-structure 2211 and the busbar 2300.

When the nano-structure 2211 is imprinted on the substrate 2220, the matrix 2212 may function to cover the nano-structure 2211 as if the nano-structure 2211 is coated with the nano-structure 2211 after imprinting. When the nano-structure 2211 is transferred to the substrate 2220, the matrix 2212 may function as a sacrificial substrate because the nano-structure 2211 may be positioned on the matrix 2212 and then transferred to the substrate 2220.

The matrix 2212 may be made of a material filling a gap between the nano-structures 2211. Therefore, the surface roughness of the heating member 2200 can be reduced by the matrix 2212. Since the surface roughness of the heating member 2200 affects a degree of scattering, reflection (including diffuse reflection), refraction, diffraction, or dispersion of light, a haze value of the vehicle heating window 2000 may vary. In other words, the haze value of the vehicle heating window 2000 can be reduced by reducing the surface roughness of the heating member 2200.

The substrate 2220 may be positioned in contact with the heating element 2210. The substrate 2220 may support the nano-structure 2211. Specifically, heat or pressure may be applied to the nano-structure 2211 on the substrate 2220 in the imprinting process. In the transfer process, the heating element 2210 may be transferred to the substrate 2220.

The substrate 2220 may be made of a single material and may also be made of a composite of several materials. The substrate 2220 may be made of the same material as the base 2100. The substrate 2220 may be transparent. The substrate 2220 may be made of a material having an adhesive property.

The heating member 2200 may include a first surface 2230 and a second surface 2240. The first surface 2230 may be a surface adjacent to the first substrate 2110, and the second surface 2240 may be a surface adjacent to the second substrate 2120.

The busbar 2300 may be positioned adjacent to the heating member 2200. The busbar 2300 may be electrically connected to the heating element 2210. The busbar 2300 may be positioned in contact with a portion of the second surface 2240. The busbar 2300 may be positioned between the second substrate 2120 and the substrate 2220.

However, a position of the busbar 2300 is not limited to the position defined in the drawing, and the busbar 2300 may also be positioned adjacent to the second substrate 2120. In this case, the heating element 2210 may be positioned between the second substrate 2120 and the substrate 2220.

The busbar 2300 receives an external voltage and transmits the voltage to the heating member 2200, and as a result, the vehicle heating window 2000 is heated to enable defogging or de-icing.

The busbar 2300 may be a passage through which a current flows. Since the busbar 2300 may be formed of a conductor having a lower resistance value than the heating member 2200, a current may flow well compared to the heating member 2200.

The busbar 2300 is optically opaque and may be visually recognized by a user. The busbar 2300 may be made of a metal such as silver (Ag), copper (Cu), or tungsten (W). In addition, the busbar 2300 may include a metal nano-structure and include silver nano-wires (AgNW). The busbar 2300 may also be optically transparent. The busbar 2300 may be a transparent electrode, and specifically, may be made of a transparent conducting oxide (TCO) such as indium tin oxide (ITO).

Two busbars 2300 may be provided. The busbar 2300 may include an upper busbar 2310 and a lower busbar 2320.

The intermediate layer 2400 may be positioned adjacent to the base 2100. The intermediate layer 2400 may be positioned between the first substrate 2110 and the second substrate 2120.

One or more intermediate layers 2400 may be provided. In FIG. 4, two intermediate layers 2400 may be provided. The intermediate layer 2400 may include a first intermediate layer 2410 and a second intermediate layer 2420. The first intermediate layer 2410 may be positioned between the first substrate 2110 and the heating member 2200, and the second intermediate layer 2420 may be positioned between the second substrate 2120 and the heating member 2200.

The intermediate layer 2400 may function to prevent the vehicle heating window 2000 from being completely broken when an external force is applied to the vehicle heating window 2000. Specifically, the intermediate layer 2400 maintains the shape of the base 2100 mounted on the frame 1100 as much as possible when the vehicle heating window 2000 is impacted and the base 2100 is broken. In other words, it is possible to prevent fragments of the base 2100 or the like from falling on the user so that the user is not injured.

The intermediate layer 2400 may be optically transparent and may transmit heat.

The intermediate layer 2400 may have an adhesive property. The intermediate layer 2400 may contain polyvinyl butyral (PVB), polycarbonate, ethylene vinyl acetate (EVA), thermoplastic polyurethane (TOU), ionomer, ionoplast, cast in place (CIP) resin (based on, for example, acrylic, polyurethane, or polyester), thermoplastic material, another suitable polymeric material, or polymer material or a combination thereof, and the present invention is not limited thereto.

The intermediate layer 2400 may be formed by injecting a material between the base 2100 and the heating member 2200 positioned in the region adjacent to the base 2100 and then curing the material. In this case, the intermediate layer 2400 may bond the base 2100 and the heating member 2200. In other words, in the vehicle heating window 2000 in FIG. 4, the heating member 2200 may be fixedly bonded to the first substrate 2110 and the second substrate 2120 by positioning the heating member 2200 between the first substrate 2110 and the second substrate 2120 and then forming the intermediate layer 2400.

With this structure, functions of preventing the noise and windproofing may be excellent compared to the vehicle heating window 2000 having a structure with one base 2100. In addition, it is also possible to prevent the heating member 2200 from being damaged.

The heating element 2210 may also be directly formed on the base 2100. In other words, the heating element 2210 may also be formed in the form of being in direct contact with the base 2100 in a state in which the intermediate layer 2400 and the substrate 2220 are omitted. In this case, the substrate 2220 and the intermediate layer 2400 can be omitted, thereby reducing a manufacturing cost.

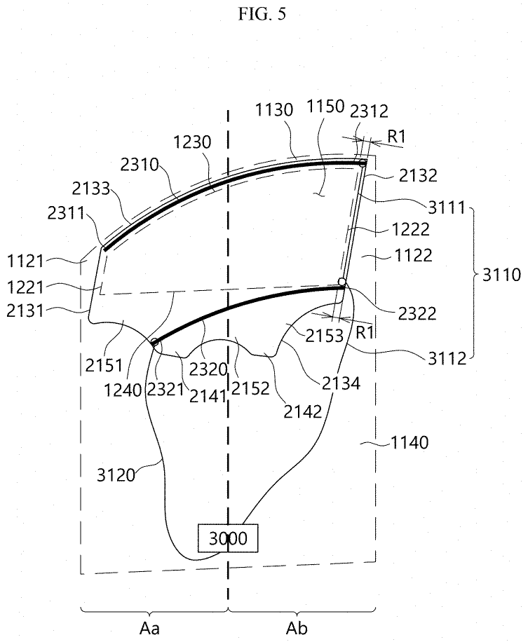

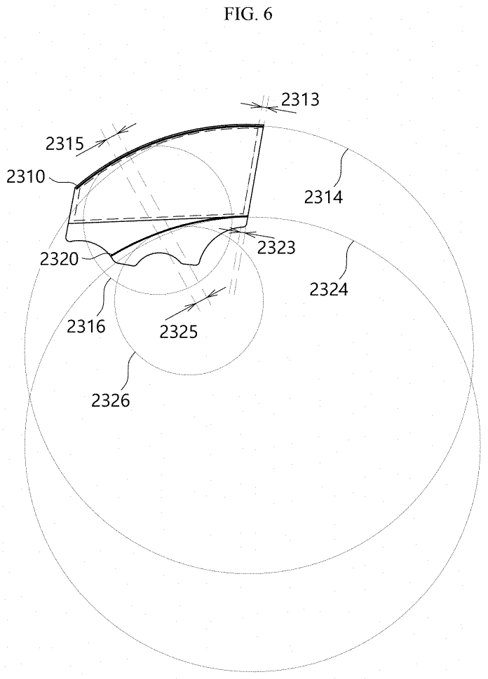

When the vehicle heating window 2000 is mounted on the vehicle 1000, the shape of the vehicle heating window 2000 may be described with reference to FIGS. 5 and 6.

FIG. 5 is a view showing a heat-generating vehicle side window according to the first embodiment. FIG. 6 is a view showing a side curvature of a busbar of the heat-generating vehicle side window according to the first embodiment. The shape of the heat-generating vehicle side window is not limited to the shape defined in the drawings and may generally be dependent on the overall design of the vehicle. In addition, top, bottom, left, and right directions may be based on the drawings shown in FIGS. 5 and 6, and the basis of the directions is not dependent on the drawings.

The heat-generating vehicle side window 2005 according to the embodiment may include the base 2100, the heating member 2200, the busbar 2300, and the intermediate layer 2400, and the busbar 2300 may include the upper busbar 2310 and the lower busbar 2320.

Referring to FIGS. 5 and 6, the heat-generating vehicle side window 2005 according to the first embodiment may be mounted on the frame 1100 of the vehicle 1000.

The frame 1100 may constitute a portion of the vehicle 1000. The frame 1100 may be formed in a state of having an opening 1150, and the vehicle heating window 2000 may be positioned in a region corresponding to the opening 1150. The frame 1100 may be a frame constituting a door of the vehicle 1000.

The frame 1100 may include a rubber packing mounted on the frame 1100. The rubber packing may prevent moisture from passing between the frame 1100 and the vehicle heating window 2000 positioned adjacent to the frame 1100. In addition, it is possible to prevent the movement of the vehicle heating window 2000 mounted on the frame 1100 by the rubber packing. The rubber packing may be defined as a portion of the frame 1100. Hereinafter, the frame 1100 is defined and described in the form including the rubber packing.

The frame 1100 may include a side frame 1120, an upper frame 1130, and a lower frame 1140. The side frame 1120, the upper frame 1130, and the lower frame 1140 may be integrally formed. The side frame 1120 may be adjacent to the vehicle front heating window 2001 and the vehicle rear heating window 2003. The side frame 1120 may include a front frame 1121 and a rear frame 1122. The front frame 1121, the rear frame 1122, the upper frame 1130, and the lower frame 1140 are integrally formed and are to define the frame 1100 for each region.

The frame 1100 may include a frame boundary portion 1200. The frame boundary portion 1200 may include a side frame boundary portion 1220, an upper frame boundary portion 1230, and a lower frame boundary portion 1240. The side frame boundary portion 1220 may include a front frame boundary portion 1221 and a rear frame boundary portion 1222. The opening 1150 may be defined by the frame boundary portion 1200. The opening 1150 may be defined by the side frame boundary portion 1220, the upper frame boundary portion 1230, and the lower frame boundary portion 1240.

The front frame 1121 may be a portion of the side frame 1120 positioned in the forward direction Da of the vehicle 1000. The front frame 1121 may be the side frame 1120 positioned close to the vehicle front heating window 2001. The front frame boundary portion 1221 may be straight or may also be curved.

The rear frame 1122 may be a portion of the side frame 1120 positioned close to the backward direction Db of the vehicle 1000. The rear frame 1122 may be the side frame 1120 positioned close to the vehicle rear heating window 2003. The rear frame boundary portion 1222 may be straight or may also be curved. A length of the rear frame boundary portion 1222 may be greater than a length of the front frame boundary portion 1221. The rear frame boundary portion 1222 may be parallel to the front frame boundary portion 1221.

The upper frame 1130 is the frame 1100 positioned above the vehicle heating window 2000. The upper frame 1130 is positioned between the front frame 1121 and the rear frame 1122. The upper frame boundary portion 1230 may be formed not parallel to the front frame boundary portion 1221 and the rear frame boundary portion 1222.

The upper frame 1130 may include a region having the side curvature PC. The upper frame 1130 may include regions having different side curvatures PC. The side curvature PC for each region of the upper frame 1130 may be zero or more. A curvature of a portion of the upper frame 1130 may also be zero. In this case, the region where the side curvature PC is zero may be straight when viewed from the side.

The lower frame 1140 is the frame 1100 positioned below the heat-generating vehicle side window 2005. The lower frame 1140 is positioned below the upper frame 1130 and positioned between the front frame 1121 and the rear frame 1122. The lower frame boundary portion 1240 may be formed not parallel to the front frame boundary portion 1221 and the rear frame boundary portion 1222. The lower frame boundary portion 1240 may be straight.

The upper frame 1130 and the lower frame 1140 may include a region having the sectional curvature SC. The upper frame 1130 and the lower frame 1140 may include regions having different sectional curvatures SC. The sectional curvatures SC for each region of the upper frame 1130 and each region of the lower frame 1140 may be zero or more.

The base 2100 of the heat-generating vehicle side window 2005 according to the embodiment may have a shape corresponding to a portion of the frame boundary portion 1200. Specifically, the shape of the base 2100 corresponds to the side frame boundary portion 1220 and the upper frame boundary portion 1230 and does not correspond to the lower frame boundary portion 1240, but the present invention is not limited thereto.

The base 2100 may include an edge 2130 and a body 2135.

The edge 2130 may constitute an edge of the base 2100. The edge 2130 may include a front edge 2131, a rear edge 2132, an upper edge 2133, and a lower edge 2134.

The front edge 2131 may be the edge 2130 in the forward direction Da of the vehicle 1000 when the heat-generating vehicle side window 2005 is mounted on the vehicle 1000. The front edge 2131 may be the edge 2130 close to the vehicle front heating window 2001.

The front edge 2131 may be straight. In the embodiment, the front edge 2131 is expressed as being straight, but the front edge 2131 may also be curved.

The front edge 2131 may be parallel to the front frame boundary portion 1221 and may not be visually recognized because the front edge 2131 is covered by the front frame 1121. A length of the front edge 2131 may be longer than the length of the front frame boundary portion 1221.

When the heat-generating vehicle side window 2005 is mounted on the vehicle 1000, the rear edge 2132 may be the edge 2130 in the backward direction Db of the vehicle 1000 among the edges 2130 of the heat-generating vehicle side window 2005. The rear edge 2132 may be the edge 2130 close to the vehicle rear heating window 2003.

The rear edge 2132 may be straight. In the embodiment, the rear edge 2132 is expressed as being straight, but the rear edge 2132 may also be curved.

A length of the rear edge 2132 may be greater than the length of the front edge 2131. The rear edge 2132 may be parallel to the front edge 2131.

The rear edge 2132 may be parallel to the rear frame boundary portion 1222 and may not be visually recognized because the rear edge 2132 is covered by the rear frame 1122. The length of the rear edge 2132 may be greater than the length of the rear frame boundary portion 1222.

The front edge 2131 and the rear edge 2132 may be positioned to face each other.

The upper edge 2133 is the edge 2130 positioned above the heat-generating vehicle side window 2005 and positioned adjacent to the upper frame 1130 when the heat-generating vehicle side window 2005 is mounted on the vehicle 1000.

The upper edge 2133 may include a region having the side curvature PC. The upper edge 2133 may include regions having different side curvatures PC. The side curvature PC for each region of the upper edge 2133 may be zero or more and may not include a region where the side curvature PC is zero either. The side curvature PC of a portion of the upper edge 2133 may also be zero. In this case, the region where the side curvature PC is zero may be straight when viewed from the side.

The upper edge 2133 may include a region having the sectional curvature SC. The upper edge 2133 may include regions having different sectional curvatures SC. The sectional curvature SC for each region of the upper edge 2133 may be zero or more.

The upper edge 2133 may be positioned between the front edge 2131 and the rear edge 2132.

The upper edge 2133 may have a shape corresponding to the upper frame boundary portion 1230 and may not be visually recognized because the upper edge 2133 is covered by the upper frame 1130.

The lower edge 2134 is positioned below the heat-generating vehicle side window 2005. The lower edge 2134 may be positioned inside the lower frame 1140. The lower edge 2134 may be positioned below the lower frame boundary portion 1240.

The lower edge 2134 may include the regions having different side curvatures PC. The side curvature PC for each region of the lower edge 2134 may be zero or more and may not include a region where the side curvature PC is zero either. The side curvature PC of a portion of the lower edge 2134 may also be zero. In this case, the region where the side curvature PC is zero may be straight when viewed from the side.

The lower edge 2134 may include the region having the sectional curvature SC. The lower edge 2134 may include the regions having different sectional curvatures SC. The sectional curvature SC for each region of the lower edge 2134 may be zero or more.

The lower edge 2134 may be positioned between the front edge 2131 and the rear edge 2132 and positioned to face the upper edge 2133.

The lower edge 2134 may also have a shape corresponding to the lower frame boundary portion 1240 and may also have a shape not corresponding thereto.

For example, the lower edge 2134 may include a plurality of protrusions 2140 and a plurality of recesses 2150.

The protrusion 2140 may refer to a structure that relatively protrudes in a direction away from the upper edge 2133. The recess 2150 refers to a structure that is relatively recessed in a direction closer to the upper edge 2133, but the recess 2150 is a relative concept and may not be a structure that is actually recessed.

The protrusion 2140 may include a first protrusion 2141 and a second protrusion 2142.

The protrusion 2140 may be positioned between the recesses 2150.

The first protrusion 2141 may be a portion of the protrusion 2140 in the forward direction Da of the vehicle 1000.

The second protrusion 2142 may be a portion of the protrusion 2140 in the backward direction Db of the vehicle 1000.

The first protrusion 2141 and the second protrusion 2142 may have shapes corresponding to each other. The first protrusion 2141 and the second protrusion 2142 may be positioned below the front edge 2131 and/or the rear edge 2132.

The recess 2150 may include a first recess 2151, a second recess 2152, and a third recess 2153.

The first recess 2151 may include a region connected from the front edge 2131 to the lower edge 2134. In other words, the first recess 2151 may be in contact with the front edge 2131. The first recess 2151 may be positioned between the front edge 2131 and the first protrusion 2141.

The second recess 2152 may be positioned between the first protrusion 2141 and the second protrusion 2142.

The third recess 2153 may include a region connected from the lower edge 2134 to the rear edge 2132. In other words, the third recess 2153 may be in contact with the rear edge 2132. The third recess 2153 may be positioned between the rear edge 2132 and the second protrusion 2142.

The shapes of the protrusions 2140 and the recesses 2150 and the numbers of protrusions 2140 and recesses 2150 are not dependent on the drawings. One or more protrusions 2140 and one or more recesses 2150 may be provided, and the protrusion 2140 and the recess 2150 may not be present.

The lower edge 2134 or a portion adjacent to the lower edge 2134 may be coupled with a displacement device capable of vertically moving the heat-generating vehicle side window 2005. The displacement device may include a window regulator or the like. Specifically, the displacement device may be positioned on the protrusion 2140 of the heat-generating vehicle side window 2005. The displacement device may be positioned over the first protrusion 2141 and the second protrusion 2142. The displacement device may be fixedly installed on the first protrusion 2141 and the second protrusion 2142.

However, when the protrusion 2140 is not present, the displacement device may be positioned in the partial region of the lower edge 2134.

The body 2135 may be a region surrounded by the front edge 2131, the rear edge 2132, the upper edge 2133, and the lower edge 2134. A shape of the body 2135 may be defined by a closed curve defined by the front edge 2131, the rear edge 2132, the upper edge 2133, and the lower edge 2134.

The body 2135 may include a region that may be visually recognized by the user through the opening 1150.

The heat-generating vehicle side window 2005 may move in a state of being mounted on the frame 1100. The heat-generating vehicle side window 2005 may move toward the upper frame 1130 or the lower frame 1140. The heat-generating vehicle side window 2005 may move between a first position and a second position. The position of the heat-generating vehicle side window 2005 when the heat-generating vehicle side window 2005 maximally moves toward the upper frame 1130 may be defined as a first position L1. FIG. 5 shows the heat-generating vehicle side window 2005 positioned at the first position L1.

The heat-generating vehicle side window 2005 may include a front region Aa and a rear region Ab.

The front region Aa may be a partial region of the heat-generating vehicle side window 2005. The front region Aa may be a region including a region extending from the front edge 2131 to a region adjacent to the second recess 2152. The front region Aa may be a region adjacent to the side mirror.

The rear region Ab may be the partial region of the heat-generating vehicle side window 2005. The rear region Ab may be a region including a region extending from the rear edge 2132 to the region adjacent to the second recess 2152. The rear region Ab may be a region adjacent to the vehicle rear heating window 2003.

The front region Aa and the rear region Ab may be in contact with each other in a region adjacent to the second recess 2152. In other words, the front region Aa and the rear region Ab may be divided on the basis of the second recess 2152.

The busbar 2300 may be positioned on upper and lower portions of the heat-generating vehicle side window 2005 and may include the region having the side curvature PC. The busbar 2300 may include the regions having different side curvatures PC. The side curvature PC for each region of the busbar 2300 may be zero or more and may not include the region where the side curvature PC is zero either. The side curvature PC of a portion of the busbar 2300 may also be zero. The region where the side curvature PC is zero may be defined as a straight region R1.

The straight region R1 may be positioned in a region adjacent to the rear edge 2132 among the regions of the busbar 2300 or positioned in contact with the rear edge 2132. In this case, the straight region R1 may be covered by the rear frame 1122. The upper edge 2133 of a region corresponding to the straight region R1 may also have a straight structure. Although not shown in the drawing, the straight region R1 may be positioned in a region adjacent to the front edge 2131 among the regions of the busbar 2300 or positioned in contact with the front edge 2131. In this case, the straight region R1 may be covered by the front frame 1121.

The busbar 2300 may include the region having the sectional curvature SC. The busbar 2300 may include the regions having different sectional curvatures SC. The sectional curvature SC for each region of the busbar 2300 may be zero or more.

The busbar 2300 may include the upper busbar 2310 and the lower busbar 2320.

The upper busbar 2310 is positioned on the upper portion of the heat-generating vehicle side window 2005. When the heat-generating vehicle side window 2005 is positioned at the first position L1, the upper busbar 2310 may be covered by the upper frame 1130.

The upper busbar 2310 may be formed in a shape corresponding to the upper frame boundary portion 1230 and formed in a shape corresponding to the upper edge 2133. The upper busbar 2310 may be formed to be spaced apart from the upper edge 2133. Even when the upper busbar 2310 is positioned to be spaced apart from the upper edge 2133, the upper busbar 2310 may be covered by the upper frame 1130 when the heat-generating vehicle side window 2005 is positioned at the first position L1. All regions of the upper busbar 2310 may have the same separation distances from the upper edge 2133.

The upper busbar 2310 includes one end 2311 of the upper busbar and the other end 2312 of the upper busbar. The one end 2311 of the upper busbar and the other end 2312 of the upper busbar may be both ends of the upper busbar 2310. The one end 2311 of the upper busbar may be defined as the end of the upper busbar 2310 positioned adjacent to the front edge 2131. The other end 2312 of the upper busbar may be defined as the end of the upper busbar 2310 positioned adjacent to the rear edge 2132.

The upper busbar 2310 may include a first region 2313 and a second region 2315. The first region 2313 and the second region 2315 may have the side curvature PC.

The first region 2313 may be a region adjacent to the rear edge 2132. The first region 2313 may not be visually recognized because the first region 2313 is covered by the rear frame 1122. The first region 2313 may include the other end 2312 of the upper busbar.

A first side curvature PC1 may be defined as the side curvature PC of the first region 2313. The first side curvature PC1 may be zero, and in this case, the first region 2313 may be the straight region R1.

A virtual circle corresponding to the first side curvature PC1 may be present in the first region 2313, which may defined as a first circle 2314.

The first side curvature PC1 of the first region 2313 may be smaller than the sectional curvature SC of the first region 2313.

The second region 2315 may be at least a partial region having the side curvature PC greater than the first side curvature PC1 among the regions spaced apart from the rear edge 2132. The second region 2315 may not be visually recognized because the second region 2315 is covered by the front frame 1121. The second region 2315 may include the one end 2311 of the upper busbar.

A second side curvature PC2 may be defined as the side curvature PC of the second region 2315.

A virtual circle corresponding to the second side curvature PC2 may be present in the second region 2315, which may be defined as a second circle 2316.

The second side curvature PC2 of the second region 2315 may be greater than the sectional curvature SC of the second region 2315.

An average side curvature of the first region 2313 may be smaller than an average side curvature of the second region 2315. The first side curvature PC1 may be smaller than the second side curvature PC2. In this case, a radius of the first circle 2314 may be greater than a radius of the second circle 2316.

The lower busbar 2320 is positioned on the lower portion of the heat-generating vehicle side window 2005. When the heat-generating vehicle side window 2005 is positioned at the first position L1, the lower busbar 2320 may be covered by the lower frame 1140.

The lower busbar 2320 may be formed in a shape corresponding to the upper busbar 2310. The lower busbar 2320 may be formed to be spaced apart from the lower edge 2134.

The lower busbar 2320 includes one end 2321 of the lower busbar and the other end 2322 of the lower busbar. The one end 2321 of the lower busbar and the other end 2322 of the lower busbar may be both ends of the lower busbar 2320. The one end 2321 of the lower busbar may be positioned adjacent to the lower edge 2134. Specifically, the one end 2321 of the lower busbar may be positioned adjacent to a region in which the first recess 2151 and the first protrusion 2141 of the lower edge 2134 are connected. Alternatively, the one end 2321 of the lower busbar may be positioned in a region adjacent to the first recess 2151. However, since the shape and position of the lower busbar 2320 are not dependent on the drawing, the one end 2321 of the upper busbar may also be positioned adjacent to the first recess 2151 or the first protrusion 2141 according to the size and shape of the heat-generating vehicle side window 2005. The other end 2322 of the lower busbar may be defined as the end of the lower busbar 2320 positioned adjacent to the rear edge 2132.

The lower busbar 2320 may include a third region 2323 and a fourth region 2325. The third region 2323 and the fourth region 2325 may have the side curvature PC.

The third region 2323 may be a region adjacent to the rear edge 2132. The third region 2323 may not be visually recognized because the third region 2323 is covered by the rear frame 1122. The third region 2323 may include the other end 2322 of the lower busbar.

A third side curvature PC3 may be defined as the side curvature PC of the third region 2323. The third side curvature PC3 may be zero, and in this case, the third region 2323 may be the straight region R1.

A virtual circle corresponding to the third side curvature PC3 may be present in the third region 2323, which may be defined as a third circle 2324.

The third side curvature PC3 of the third region 2323 may be greater than the sectional curvature SC of the third region 2323.

The fourth region 2325 may be at least a partial region having the side curvature PC greater than the third side curvature PC3 among the regions spaced apart from the rear edge 2132. The fourth region 2325 may include the one end 2321 of the lower busbar.

A fourth side curvature PC4 may be defined as the side curvature PC of the fourth region 2325.

A virtual circle corresponding to the fourth side curvature PC4 may be present in the fourth region 2325, which may be defined as a fourth circle 2326.

The fourth side curvature PC4 of the fourth region 2325 may be greater than the sectional curvature SC of the fourth region 2325.

An average side curvature of the third region 2323 may be smaller than an average side curvature of the fourth region 2325. The third side curvature PC3 may be smaller than the fourth side curvature PC4. In this case, a radius of the third circle 2324 may be greater than a radius of the fourth circle 2326.

Areas corresponding to each other may be present in the upper busbar 2310 and the lower busbar 2320.

The side curvatures PC of the upper busbar 2310 and the lower busbar 2320 may correspond to each other. The first region 2313 and the third region 2323 may be regions corresponding to each other, and the second region 2315 and the fourth region 2325 may be regions corresponding to each other. In this case, the radius of the first circle 2314 and the radius of the third circle 2324 may correspond to each other and may also be the same as each other. The radius of the second circle 2316 and the radius of the fourth circle 2326 may correspond to each other and may also be the same as each other.

A distance between the first region 2313 and the third region 2323 and a distance between the second region 2315 and the fourth region 2325 may correspond to the shortest moving distance of electron in the respective corresponding regions. Therefore, the entirety of the heat-generating vehicle side window 2005 may be uniformly heated.

Areas parallel to each other may be present in the upper busbar 2310 and the lower busbar 2320.

Since the first region 2313 constitutes a portion of the upper busbar 2310 and has the side curvature PC, a virtual string connecting both ends of the first region 2313 may be drawn. Since the third region 2323 constitutes a portion of the lower busbar 2320 and has the side curvature PC, a virtual string connecting both ends of the third region 2323 may be drawn. The first region 2313 and the third region 2323 may be defined as regions where the respective strings are parallel to each other.

However, when the first region 2313 and the third region 2323 are the straight region R1, the side curvature PC may not be present. Therefore, virtual strings connecting both ends of the first region 2313 and the third region 2323 may not be present. In this case, straight lines connecting both ends of the first region 2313 and the third region 2323 may be present. The first region 2313 and the third region 2323 may be defined as regions in which the respective straight lines are parallel to each other.

Since the second region 2315 constitutes a portion of the upper busbar 2310 and has the side curvature PC, a virtual string connecting both ends of the second region 2315 may be drawn. Since the fourth region 2325 constitutes a portion of the lower busbar 2320 and has the side curvature PC, a virtual string connecting both ends of the fourth region 2325 may be drawn. The second region 2315 and the fourth region 2325 may be defined as regions in which the respective strings are parallel to each other.

Therefore, the vehicle heating window 2000 may be uniformly heated by arranging the upper busbar 2310 and the lower busbar 2320 as described above.

The heating member 2200 may be positioned over the entire region of the body 2135. The heating member 2200 may be formed in a shape corresponding to the shape of the body 2135.

Alternatively, the heating member 2200 may be positioned on a portion of the body 2135. Specifically, the heating member 2200 may be formed in a shape corresponding to the upper busbar 2310 and the lower busbar 2320. The heating member 2200 may be formed in a shape corresponding to at least a portion of the front edge 2131, the rear edge 2132, and the lower edge 2134 in addition to the upper busbar 2310 and the lower busbar 2320. In this case, the heating member 2200 may not be positioned in a portion of a region adjacent to the lower edge 2134. The heating member 2200 is formed in only a portion of the body 2135, and thus the heating member 2200 may be omitted in a region where heating is not required, thereby reducing a manufacturing cost.

The control device 3000 performs defogging or de-icing by applying a voltage to the busbar 2300 to heat the heating member 2200 so that the heat-generating vehicle side window 2005 is heated.

Specifically, the control device 3000 may receive an electrical signal from a sensor or a user interface, which is an input unit. The electrical signal is a sensor signal or a user input signal and may be an electrical signal for allowing the control device 3000 to output the voltage.

When the electric signal is input to the control device 3000, the control device 3000 may apply the voltage to the busbar 2300 so that the heat-generating vehicle side window 2005 performs the de-icing and/or the defogging.

Specifically, the control device 3000 may perform the de-icing and/or the defogging by applying the voltage to a wire 3100 electrically connected to the upper busbar 2310 and the lower busbar 2320.

The control device 3000 may be a separate control device and may be a main control device for controlling the entire vehicle 1000. When the control device 3000 is the separate control device, the control device 3000 may also be positioned inside the lower frame 1140.

The wire 3100 is a passage through which a current flows and functions to receive the voltage from the control device 3000 and transmit the voltage to the busbar 2300.

One or more wires 3100 may be provided. The wire 3100 may be connected to each of the upper busbar 2310 and the lower busbar 2320. Specifically, the wire 3100 may each be connected to the one end 2311 and/or the other end 2312 of the upper busbar and the one end 2321 and/or the other end 2322 of the lower busbar.

The wire 3100 may include a first wire 3110 and a second wire 3120.

The first wire 3110 may connect the upper busbar 2310 and the control device 3000. The first wire 3110 may be connected to the other end 2312 of the upper busbar. Both ends of the first wire 3110 may be fixed to the other end 2312 of the upper busbar and the control device 3000.

The first wire 3110 may include a fixed region 3111 and a variable region 3112.

The fixed region 3111 may be a region fixed to the heat-generating vehicle side window 2005. The fixed region 3111 may be positioned adjacent to the rear edge 2132 of the heat-generating vehicle side window 2005. The fixed region 3111 may be formed to extend from the other end 2312 of the upper busbar toward the lower busbar 2320 to correspond to the shape of the rear edge 2132. In this case, the fixed region 3111 may be formed not in contact with the lower busbar 2320. The fixed region 3111 may not be visually recognized because the fixed region 3111 is covered by the rear frame 1122.

The fixed region 3111 may electrically connect the other end 2312 of the upper busbar and the variable region 3112.

The fixed region 3111 may be made of a metal paste or the like.

The variable region 3112 may be a region where only a portion is fixed to the heat-generating vehicle side window 2005 and the rest has a degree of freedom. One end of the variable region 3112 may be fixed to a region adjacent to the lower busbar 2320 of the fixed region 3111. The other end of the variable region may be fixed to the control device 3000. The variable region 3112 may be deformed or moved with a degree of freedom in a state in which both ends are fixed to a portion of the fixed region 3111 and the control device 3000.

The variable region 3112 may electrically connect the fixed region 3111 and the control device 3000.

The variable region 3112 may not be visually recognized because the variable region 3112 is covered by the rear frame 1122 and the lower frame 1140.

The variable region 3112 may be an electric wire made of copper or the like.

The second wire 3120 may connect the lower busbar 2320 and the control device 3000. The second wire may be connected to the one end 2321 of the lower busbar.

Both ends of the second wire 3120 may be fixed to the one end 2321 of the lower busbar and the control device 3000. The second wire 3120 may be deformed or moved with a degree of freedom in a state in which both ends are fixed to the one end 2321 of the lower busbar and the control device 3000.

The second wire 3120 may not be visually recognized because the second wire 3120 is covered by the lower frame 1140.

Although the second wire 3120 is shown as being connected to the one end 2321 of the lower busbar in the drawing, the second wire 3120 may also be connected to any position of the lower busbar 2320. Since the lower busbar 2320 is covered by the lower frame 1140 and there is no need to consider that the wire 3100 is visually recognized, the second wire 3120 may be connected to any position of the lower busbar 2320.

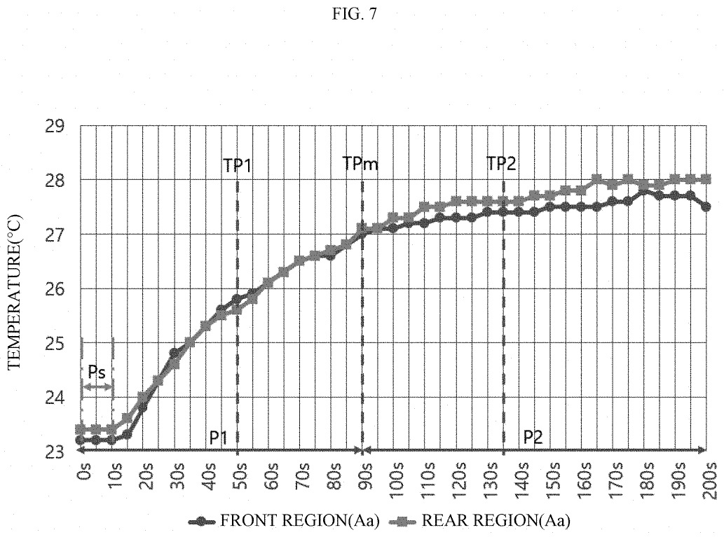

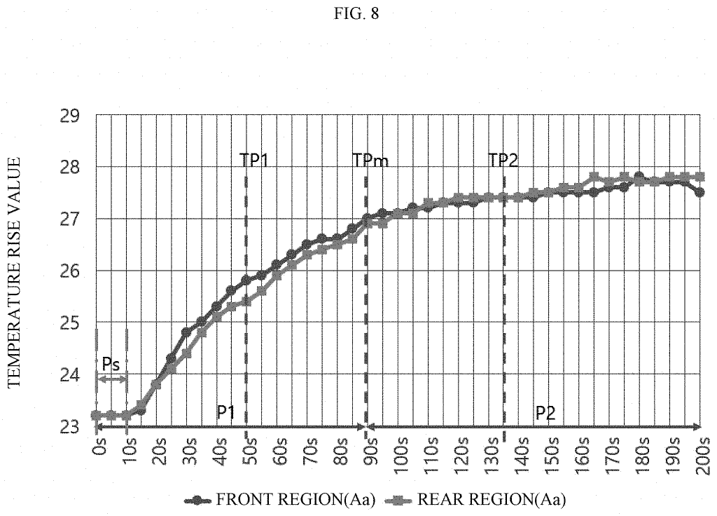

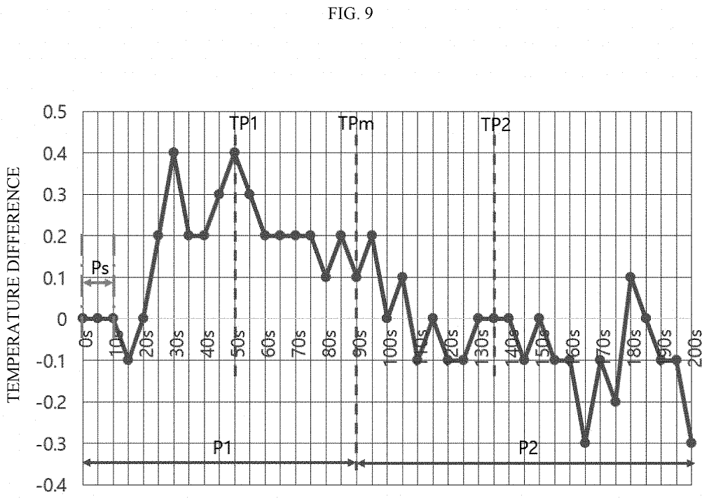

FIG. 7 is a graph showing temperatures of a front region and a rear region when the heat-generating vehicle side window according to the first embodiment is heated. FIG. 8 is a graph showing temperature rise values of the front region and the rear region of the heat-generating vehicle side window according to the first embodiment. FIG. 9 is a graph showing a temperature difference between the front region and the rear region of the heat-generating vehicle side window according to the first embodiment on the basis of the temperature rise values in FIG. 8.

Horizontal axes in FIGS. 7 to 9 indicate a time, and a vertical axis in FIG. 7 corresponds to a temperature. A vertical axis in FIG. 8 corresponds to the temperature rise values of the front region Aa and the rear region Ab. The temperature rise values are values indicating a degree of temperature rise of the front region Aa and the rear region Ab based on a temperature of the front region Aa and a temperature of the rear region Ab when the voltage is applied to the upper busbar 2310 and the lower busbar 2320. A vertical axis in FIG. 9 indicates a temperature difference and indicates the temperature difference between the front region Aa and the rear region Ab based on the temperature rise values of the front region Aa and the rear region Ab in FIG. 8. The temperature difference is obtained by subtracting the temperature rise value of the rear region Ab from the temperature rise value of the front region Aa.

Referring to FIGS. 7 to 9, when the control device 3000 applies the voltage to the upper busbar 2310 and the lower busbar 2320, the heat-generating vehicle side window 2005 may be heated. In this case, a temperature difference may occur in a portion of the heat-generating vehicle side window 2005. A temperature difference may occur between the front region Aa and the rear region Ab of the heat-generating vehicle side window 2005.

After the voltage is applied to the upper busbar 2310 and the lower busbar 2320, the temperature difference between the front region Aa and the rear region Ab may be present, and after a predetermined time elapses therefrom, the temperature difference between the front region Aa and the rear region Ab may be reduced.

When the voltage is applied to the upper busbar 2310 and the lower busbar 2320, a temperature difference may occur in a first section P1 after a time point when the voltage is applied to the upper busbar 2310 and the lower busbar 2320 and a second section P2 after the first section P1. The first section P1 and the second section P2 may be divided on the basis of a median time point TPm. The median time point TPm is a first reference and may divide the first section P1 and the second section P2. The first reference is an arbitrary reference and may be a predetermined reference.

The first section P1 may include a steady section Ps in which the temperature rise values of the front region Aa and the rear region Ab are zero. The steady section Ps may be within a predetermined time just after the voltage is applied to the busbar 2300. In the heat-generating vehicle side window 2005 according to the first embodiment, the steady section Ps may be up to about 10 seconds after the voltage is applied to the busbar 2300. With this configuration, electrons may be relatively uniformly transmitted to the heating member 2200 during the steady section Ps after the voltage is applied to the busbar 2300 so that the heat-generating vehicle side window 2005 is uniformly heated. Therefore, it is possible to prevent a sudden change in the temperature of the heat-generating vehicle side window 2005.

The median time point TPm may be a time point when temperature differences of the first section P1 and the second section P2 become different. The first section P1 may be a section in which the temperature difference is greater than the first reference, and the second section P2 may be a section in which the temperature difference is smaller than the first reference. For example, the temperature difference of the first reference may be 0.1, the first section may be a section in which the temperature difference is greater than 0.1, and the second section may be a section in which the temperature difference is smaller than 0.1.

The temperatures of the front region Aa and the rear region Ab in the first section P1 may be lower than the temperatures of the front region Aa and the rear region Ab in the second section P2. In the first section P1, the temperature of the front region Aa may be higher than the temperature of the rear region Ab. In the second section P2, the temperature of the front region Aa may be higher than or equal to the temperature of the rear region Ab.

The temperature difference between the front region Aa and the rear region Ab in the first section P1 may be greater than the temperature difference between the front region Aa and the rear region Ab in the second section P2.

A temperature difference of the front region Aa from a start time point of the first section P1 to an end time point of the first section P1 may be greater than a temperature difference of the front region Aa from a start time point of the second section P2 to an end time point of the second section P2. A temperature difference of the front region Aa in any one region of the first section P1 may be greater than a temperature difference of the front region Aa in any one region of the second section P2.

A temperature difference of the rear region Ab from the start time point of the first section P1 to the end time point of the first section P1 may be greater than a temperature difference of the rear region Ab from the start time point of the second section P2 to the end time point of the second section P2. A temperature difference of the rear region Ab in any one region of the first section P1 may be greater than a temperature difference of the rear region Ab in any one region of the second section P2.

The median time point TPm may be a time point when average temperature differences of the first section P1 and the second section P2 vary. The first section P1 may be a section in which the average temperature difference is greater than the first reference, and the second section P2 may be a section in which the average temperature difference is smaller than the first reference.

An average temperature difference between the front region Aa and the rear region Ab in the first section P1 may be greater than an average temperature difference between the front region Aa and the rear region Ab in the second section P2.

An average temperature difference of the front region Aa from the start time point of the first section P1 to the end time point of the first section P1 may be greater than an average temperature difference of the front region Aa from the start time point of the second section P2 to the end time point of the second section P2. An average temperature difference of the front region Aa in any one region of the first section P1 may be greater than an average temperature difference of the front region Aa in any one region of the second section P2.

An average temperature difference of the rear region Ab from the start time point of the first section P1 to the end time point of the first section P1 may be greater than an average temperature difference of the rear region Ab from the start time point of the second section P2 to the end time point of the second section P2. An average temperature difference of the rear region Ab in any one region of the first section P1 may be greater than an average temperature difference of the rear region Ab in any one region of the second section P2.

The second section P2 may include some sections in which the temperatures of the front region Aa and the rear region Ab are equally maintained. In this case, a temperature difference between the front region Aa and the rear region Ab may be zero in some sections of the second section P2. An average temperature difference between the front region Aa and the rear region Ab may be zero in some sections of the second section P2.

The median time point TPm may be a time point when slopes, that is, temperature rise rates of the first section P1 and the second section P2 vary. The first section P1 may be a section in which the temperature rise rate is greater than the first reference, and the second section P2 may be a section in which the temperature rise rate is smaller than the first reference.

A temperature rise rate of the front region Aa in the first section P1 may be greater than a temperature rise rate of the front region Aa and greater than a temperature rise rate of the rear region Ab in the second section P2. A temperature rise rate of the rear region Ab in the first section P1 may be greater than the temperature rise rate of the front region Aa and greater than the temperature rise rate of the rear region Ab in the second section P2.

The temperature rise rate of the front region Aa in the first section P1 and the second section P2 may correspond to the temperature rise rate of the rear region Ab in the first section P1 and the second section P2. A partial region where the temperature rise rate of the front region Aa in the first section P1 and the second section P2 corresponds to the temperature rise rate of the rear region Ab in the first section P1 and the second section P2 may be present.

The second section P2 may include some sections in which the temperature of the front region Aa is equally maintained and include some sections in which the temperature of the rear region Ab is equally maintained. In this case, in the partial section of the second section P2, the temperature rise rate of the front region Aa may be zero, and the temperature rise rate of the rear region Ab may be zero.

The temperature rise rate in a section adjacent to the first section P1 of the second section P2 may be greater than the temperature rise rate in a section spaced apart from the first section P1 of the second section P2.

The median time point TPm may be a time point when average temperature rise rates of the first section P1 and the second section P2 vary. The first section P1 may be a section in which the average temperature rise rate is greater than the first reference, and the second section P2 may be a section in which the average temperature rise rate is smaller than the first reference.

The average temperature rise rate of the front region Aa in the first section P1 may be greater than the average temperature rise rate of the front region Aa and greater than the average temperature rise rate of the rear region Ab in the second section P2. The average temperature rise rate of the rear region Ab in the first section P1 may be greater than the average temperature rise rate of the front region Aa and greater than the average temperature rise rate of the rear region Ab in the second section P2.

The average temperature rise rate of the front region Aa in the first section P1 and the second section P2 may correspond to the average temperature rise rate of the rear region Ab in the first section P1 and the second section P2. A partial region where the average temperature rise rate of the front region Aa in the first section P1 and the second section P2 corresponds to the average temperature rise rate of the rear region Ab in the first section P1 and the second section P2 may be present.

The second section P2 may include some sections in which the temperature of the front region Aa is equally maintained and include some sections in which the temperature of the rear region Ab is equally maintained. In this case, the average temperature rise rates of the front region Aa and the rear region Ab may be zero in some sections of the second section P2.

When the voltage is applied to the upper busbar 2310 and the lower busbar 2320, the temperature difference may occur at a first time point TP1 after the time point when the voltage is applied to the upper busbar 2310 and the lower busbar 2320 and a second time point TP2 after the first time point TP1.

The first time point TP1 may be any one time point in the first section P1. The first time point TP1 may be any one time point when the temperature difference between the front region Aa and the rear region Ab is the greatest in the first section P1. At the first time point TP1, a temperature of the front region Aa may be higher than a temperature of the rear region Ab.

The second time point TP2 may be any one time point after the first section P1. The second time point TP2 may be any one time point in the second section P2. The second time point TP2 may be any one time point when the temperature difference between the front region Aa and the rear region Ab is the smallest in the second section P2. A temperature of the front region Aa at the second time point TP2 may be higher than or equal to a temperature of the rear region Ab. At the second time point TP2, the temperatures of the front region Aa and the rear region Ab may be the same.

The temperatures of the front region Aa and the rear region Ab may be higher at the second time point TP2 than at the first time point TP1.

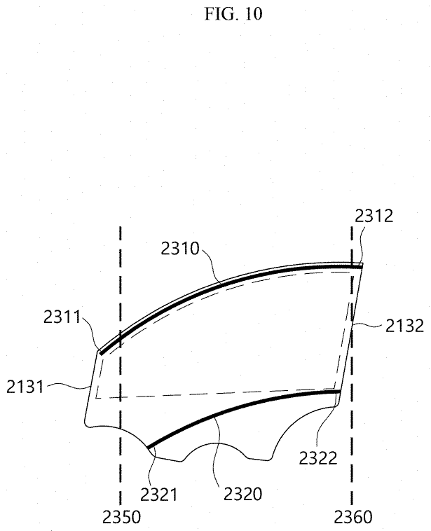

In the heat-generating vehicle side window 2005 according to the first embodiment, the front region Aa and the rear region Ab may be uniformly heated. This can be confirmed from data indicating that the temperature rise rate of the front region Aa and the temperature rise rate of the rear region Ab corresponds to each other in the first section P1, and the temperature rise rate of the front region Aa and the temperature rise rate of the rear region Ab corresponds to each other in the second section P2. In addition, since the temperature rise rate decreases and the temperature difference also decreases from the first section P1 toward the second section P2, the heat-generating vehicle side window 2005 may be heated in a state in which the temperature converges to a constant value without increasing any more when the voltage is applied to the busbar 2300 for a certain time or longer. This is to maintain the heat-generating vehicle side window 2005 heated after the voltage is applied to the busbar 2300 at a predetermined temperature, thereby reducing thermal stress due to the temperature difference applied to the heat-generating vehicle side window 2005 and securing durability. FIG. 10 is a view showing a virtual line positioned on the heat-generating vehicle side window according to the first embodiment.

The shape of the heat-generating vehicle side window is not limited to the shape defined in the drawing and may generally be dependent on the overall design of the vehicle. In addition, top, bottom, left, and right directions may be based on the drawing shown in FIG. 10, and the basis on the directions are not dependent on the drawing.

Referring to FIG. 10, a virtual line perpendicular to the lower frame 1140 may be present between the one end 2311 of the upper busbar and the one end 2321 of the lower busbar of the heat-generating vehicle side window 2005 according to the first embodiment. A plurality of virtual lines may be present, and one of them may be defined as a first virtual line 2350. In other words, the first virtual line 2350 may be positioned between the one end 2311 of the upper busbar and the one end 2321 of the lower busbar.

When the first virtual line 2350 is present, a distance between the front edge 2131 and the first virtual line 2350 may be longer than a distance between the front edge 2131 and the one end 2311 of the upper busbar and may be shorter than a distance between the front edge 2131 and the one end 2321 of the lower busbar. With respect to the first virtual line 2350, the one end 2311 of the upper busbar may be positioned adjacent to the vehicle front heating window 2001, and the one end 2321 of the lower busbar may be positioned adjacent to the vehicle rear heating window 2003.

A virtual line perpendicular to the lower frame 1140 may be present between the other end 2312 of the upper busbar and the other end 2322 of the lower busbar. A plurality of virtual lines may be present, and one of them may be defined as a second virtual line 2360. In other words, the second virtual line 2360 may be positioned between the other end 2312 of the upper busbar and the other end 2322 of the lower busbar.

With respect to the second virtual line 2360, the other end 2312 of the upper busbar may be positioned adjacent to the vehicle rear heating window 2003, and the other end 2322 of the lower busbar may be positioned adjacent to the vehicle front heating window 2001.

The first virtual line 2350 may be positioned closer to the front edge 2131 than the second virtual line 2360. The second virtual line 2360 may be positioned closer to the rear edge 2132 than the first virtual line 2350.

The upper busbar may be formed to be longer than the lower busbar 2320. With this shape, although the upper busbar 2310 and the lower busbar 2320 have the side curvature PC, the upper busbar 2310 and the lower busbar 2320 may be formed to correspond to the shortest moving distance of electron between the respective corresponding regions. Therefore, the heat-generating vehicle side window 2005 may be uniformly heated.

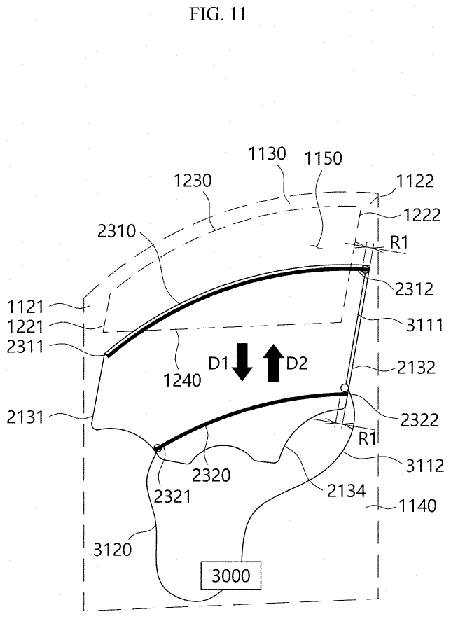

FIG. 11 is a view showing the movement of the heat-generating vehicle side window according to the first embodiment in a first direction or a second direction.

The heat-generating vehicle side window 2005 may move in a first direction D1 or a second direction D2.

Referring to FIG. 11, the first direction D1 is toward the lower frame 1140, and the second direction D2 is toward the upper frame 1130. When moving from a first position L1 in the first direction D1, the heat-generating vehicle side window 2005 may reach a second position L2 as shown in FIG. 9.

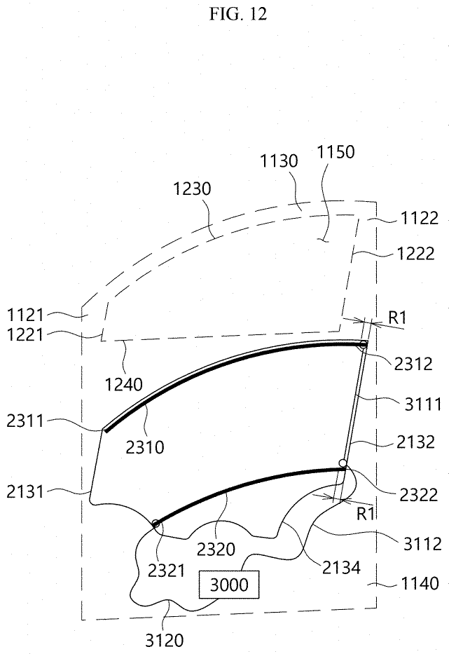

FIG. 12 is a view showing a state in which the heat-generating vehicle side window according to the first embodiment is positioned at the second position. The second position L2 may be defined as a position of the heat-generating vehicle side window 2005 when the heat-generating vehicle side window 2005 maximally moves toward the lower frame 1140. When moving from the second position L2 in the second direction D2, the heat-generating vehicle side window 2005 may reach the first position L1. In other words, the heat-generating vehicle side window 2005 may move in the first direction D1 or the second direction D2.

The shape of the heat-generating vehicle side window 2005 is not limited to the shape defined in the drawing and may generally be dependent on the overall design of the vehicle.

Referring to FIGS. 11 and 12, when the heat-generating vehicle side window 2005 according to the embodiment moves from the first position L1 in the first direction D1 or from the second position L2 in the second direction D2, only a portion of the base 2100, visually recognized by the opening 1150 at the first position L1, may be visually recognized.

When the heat-generating vehicle side window 2005 moves in the first direction D1 or the second direction D2, the upper busbar 2310 may be exposed by the opening 1150. In this case, the upper busbar 2310 may be visually recognized by the user. However, the one end 2311 and the other end 2312 of the upper busbar may not be visually recognized by a driver even when the heat-generating vehicle side window 2005 moves because the one end 2311 and the other end 2312 of the upper busbar may be covered by the side frame 1120. Specifically, a portion of the upper busbar 2310 including the other end 2312 of the upper busbar that is not visually recognized by being covered by the side frame 1120 may be the first region 2313 and may be the straight region R1.

Since the lower busbar 2320 is positioned inside the lower frame 1140, the lower busbar 2320 may not be visually recognized by the driver even when the heat-generating vehicle side window 2005 moves in the first direction D1 or the second direction D2.

The wire 3100 may move together when the heat-generating vehicle side window 2005 moves. The wire 3100 may include the first wire 3110 and the second wire 3120.

The first wire 3110 may not be visually recognized because the first wire 3110 is covered by the rear frame 1122 and the lower frame 1140 when the heat-generating vehicle side window 2005 moves in the first direction D1 or the second direction D2. When the heat-generating vehicle side window 2005 moves in the first direction D1 or the second direction D2, the fixed region 3111 may not be visually recognized because the fixed region 3111 is covered by the rear frame 1122. Therefore, since the fixed region 3111, which is the first wire 3110, is not visually recognized by the driver, it is possible to prevent the disturbance of the driver's view.

In addition, since the fixed region 3111 of the first wire 3110 is fixed to the heat-generating vehicle side window 2005, it is possible to minimize the possibility that the first wire 3110 may be tangled when the heat-generating vehicle side window 2005 moves in the first direction D1 or the second direction D2. Therefore, it is possible to prevent the disconnection of the first wire 3110.

In addition, the first wire 3110 is deformed or moved with a degree of freedom in a state in which both ends of the variable region 3112 of the first wire 3110 are fixed to portions of the fixed region 3111 and the control device 3000, and thus it is possible to prevent the disconnection of the first wire 3110 when the heat-generating vehicle side window 2005 moves in the first direction D1 or second direction D2. The variable region 3112 may also be implemented in the form of moving along a rail.

However, there may be a case in which the first wire 3110 does not include the fixed region 3111 differently from the drawing. In other words, there may be a case in which all of the first wires 3110 include only the variable region 3112. In this situation, when the heat-generating vehicle side window 2005 moves in the first direction D1 or the second direction D2, the variable region 3112 may highly likely be tangled. Therefore, in order to prevent this, a rail having a shape corresponding to the rear edge 2132 may be mounted in a region adjacent to the other end 2312 of the upper busbar. In this case, the variable region 3112 connected to the other end 2312 of the upper busbar may be positioned on the rail and may move together when the heat-generating vehicle side window 2005 moves along the rail.

The other end 2312 of the upper busbar and the first wire 3110 can be protected from moisture such as rain or snow, wind, and the like because the other end 2312 of the upper busbar and the first wire 3110 are covered by the rear frame 1122 and the lower frame 1140. Therefore, it is possible to prevent the upper busbar 2310 and the first wire 3110 from being damaged.

The second wire 3120 may be positioned adjacent to the lower edge 2134. Therefore, since the moving distance of the heat-generating vehicle side window 2005 is shorter than that of the first wire 3110, the second wire 3120 may be less likely tangled.

The second wire 3120 may not be visually recognized by the user because the second wire 3120 is covered by the lower frame 1140. The second wire 3120 may not need to be fixed to the heat-generating vehicle side window 2005. In other words, since the second wire 3120 does not include the fixed region, the number of process operations can be reduced, thereby reducing the manufacturing cost.

Although the second wire 3120 is connected to the one end 2321 of the lower busbar in the drawing, the second wire 3120 may also be positioned at any position of the lower busbar 2320. This is because the second wire 3120 may not be visually recognized by the user because the second wire 3120 is covered by the lower frame 1140. Since the shape of the wire 3100 is not dependent on the drawing, the wire 3100 may also be connected to the one end 2311 of the upper busbar in addition to the first wire 3110. A wire connected to one end of the upper busbar may have a shape corresponding to the first wire 3110.

Although not shown in the drawing, the wire connected to the one end 2311 of the upper busbar may also include the fixed region and the variable region.

The fixed region may be positioned adjacent to the front edge 2131. The fixed region may be formed to extend from the one end 2311 of the upper busbar toward the lower busbar 2320 to correspond to the shape of the front edge 2131. In this case, the fixed region may be formed not in contact with the lower busbar 2320. The fixed region may not be visually recognized because the fixed region is covered by the front frame 1121.

The fixed region may electrically connect the one end 2311 of the upper busbar and the variable region.

The one end of the variable region may be fixed to a region adjacent to the lower busbar 2320 of the fixed region. The variable region may be deformed or moved with a degree of freedom in a state in which both ends are fixed to a portion of the fixed region and the control device 3000.

The variable region may electrically connect the fixed region and the control device 3000.

The variable region may not be visually recognized because the variable region is covered by the front frame 1121 and the lower frame 1140.

Although not shown in the drawing, both ends of the second wire 3120 may be fixed to the one end 2321 of the lower busbar and the control device 3000. The second wire 3120 may be deformed or moved with a degree of freedom in a state in which both ends are fixed to the one end 2321 of the lower busbar and the control device 3000.

When the heat-generating vehicle side window 2005 according to the first embodiment is positioned at the second position L2, referring to FIG. 12, the heat-generating vehicle side window 2005 may not be visually recognized by the driver because the heat-generating vehicle side window 2005 is completely covered by the lower frame 1140. In other words, the base 2100, the busbar 2300, and the wire 3100 may be covered by the lower frame 1140.

The heat-generating vehicle side window 2005 may be heated when positioned as shown in FIG. 5 or positioned as shown in FIG. 11. Preferably, the heat-generating vehicle side window 2005 may be heated when positioned at the first position L1 as shown in FIG. 5. This is because the driving of the de-icing or the defogging does not need to be performed for the heat-generating vehicle side window 2005 when many regions of the heat-generating vehicle side window 2005 are covered by the lower frame 1140. In addition, when the heat-generating vehicle side window 2005 is heated in the frame 1100, this may also affect parts mounted inside the vehicle 1000. In other words, when the heat-generating vehicle side window 2005 according to the first embodiment is moving in the first direction D1 or the second direction D2 or positioned at the second position L2, the control device 3000 may not apply a voltage to the busbar 2300.

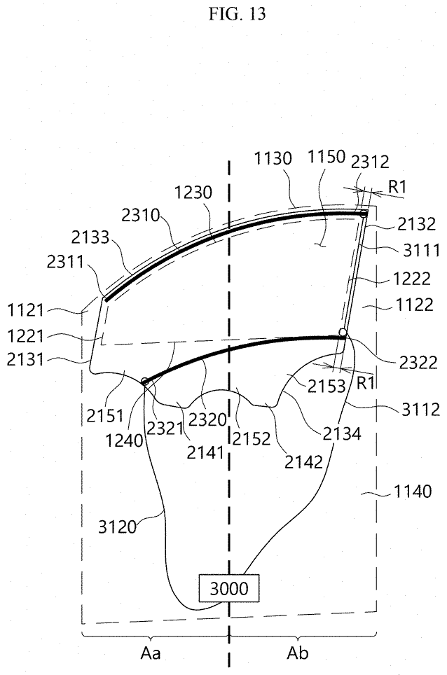

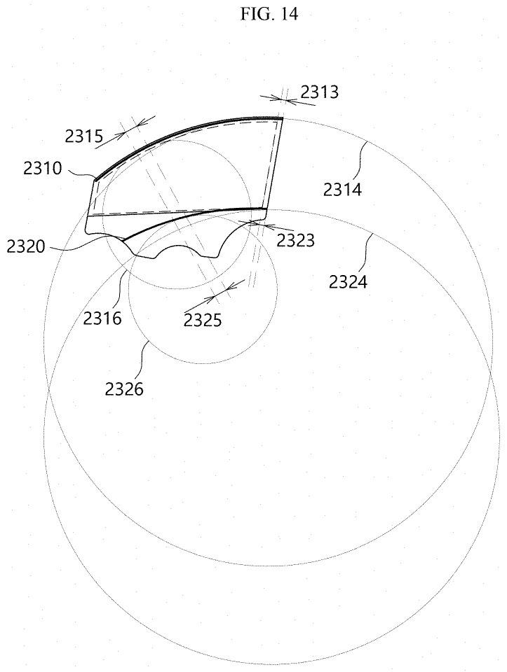

FIG. 13 is a view showing a heat-generating vehicle side window according to a second embodiment. FIG. 14 is a view showing a side curvature of a busbar of the heat-generating vehicle side window according to the second embodiment.

The shape of the heat-generating vehicle side window is not limited to the shape defined in the drawings and may generally be dependent on the overall design of the vehicle. In addition, top, bottom, left, and right directions may be based on the drawings shown in FIGS. 13 and 14, and the basis on the directions are not dependent on the drawings.

A difference between a heat-generating vehicle side window 2005 according to the second embodiment and the heat-generating vehicle side window 2005 according to the first embodiment is a shape of the lower busbar 2320, and the remaining configuration is the same. Therefore, in describing the heat-generating vehicle side window 2005 according to the second embodiment, the same reference numerals are denoted by the components common to the first embodiment, and detailed descriptions will be omitted.

Referring to FIGS. 13 and 14, regions corresponding to each other may be present in the upper busbar 2310 and the lower busbar 2320 according to the second embodiment.

The upper busbar 2310 may include the first region 2313 and the second region 2315, and the lower busbar 2320 may include the third region 2323 and the fourth region 2325.

The first region 2313 and the third region 2323 may be regions corresponding to each other. Specifically, the first side curvature PC1 and the third side curvature PC3 may correspond to each other. The radius of the first circle 2314 and the radius of the third circle 2324 may correspond to each other or may also be the same as each other. A distance between the first region 2313 and the third region 2323 may correspond to the shortest moving distance of electron in the respective corresponding regions.

On the other hand, the second region 2315 and the fourth region 2325 may not correspond to each other. Specifically, the second side curvature PC2 and the fourth side curvature PC4 may not correspond to each other. The second side curvature PC2 may be greater than the fourth side curvature PC4. The radius of the second circle 2316 may be smaller than the radius of the fourth circle 2326. A distance between the second region 2315 and the fourth region 2325 may correspond to the shortest moving distance of electron in the respective corresponding regions.

The distance between the first region 2313 and the third region 2323 may be longer than the distance between the second region 2315 and the fourth region 2325. The shortest moving distance of electron between the first region 2313 and the third region 2323 may be longer than the shortest moving distance of electron between the second region 2315 and the fourth region 2325.

Areas parallel to each other may be present in the upper busbar 2310 and the lower busbar 2320.

Since the first region 2313 has the side curvature PC, a virtual string connecting both ends of the first region 2313 may be drawn. Since the third region 2323 has the side curvature PC, a virtual string connecting both ends of the third region 2323 may be drawn. The first region 2313 and the third region 2323 may also be defined as regions in which the respective strings are parallel to each other.

The second region 2315 may include a virtual string connecting both ends of the second region 2315 because the second region 2315 constitutes a portion of the upper busbar 2310. The fourth region 2325 may include a virtual string connecting both ends of the fourth region 2325 because the fourth region 2325 constitutes a portion of the lower busbar 2320. The string of the second region 2315 and the string of the fourth region 2325 may not be parallel to each other.

The string of the second region 2315 may have a greater angle than the string of the fourth region 2325 with respect to the lower frame 1140.

The fourth region 2325 may be positioned closer to the upper busbar 2310 than the fourth region 2325 according to the first embodiment. The fourth region 2325 may be positioned closer to the second region 2315 than the fourth region 2325 according to the first embodiment.

Therefore, the heat-generating vehicle side window 2005 according to the second embodiment may have a region adjacent to the vehicle front heating window 2001 or a region adjacent to the front edge 2131 that is heated relatively faster than the heat-generating vehicle side window 2005 according to the first embodiment. Since a side mirror is positioned adjacent to the vehicle front heating window 2001 or the front edge 2131, the region of the heat-generating vehicle side window 2005 where the side mirror may be visually recognized is defogged more quickly, and thus the driver may visually recognize the side mirror more quickly.

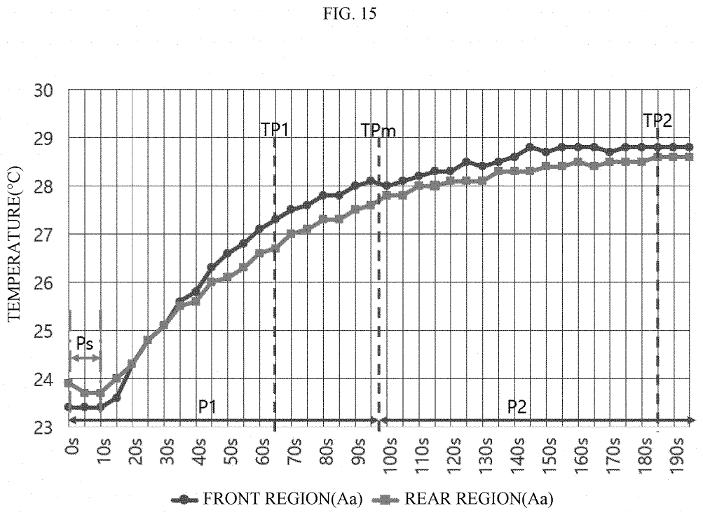

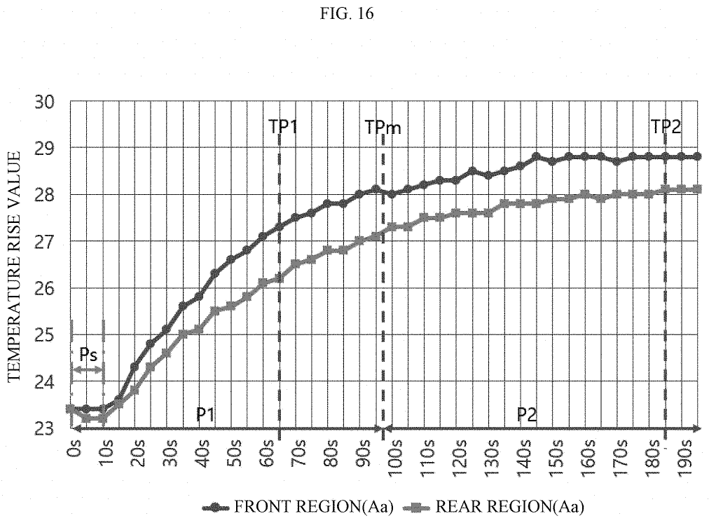

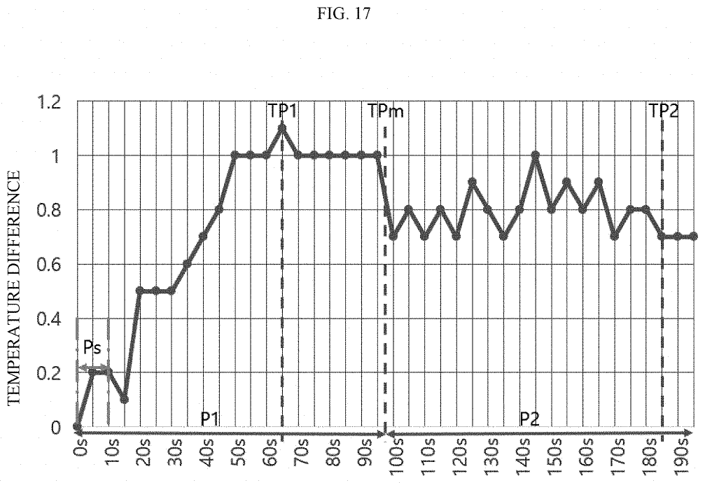

FIG. 15 is a graph showing temperatures of a front region and a rear region when the heat-generating vehicle side window according to the second embodiment is heated. FIG. 16 is a graph showing temperature rise values of the front region and the rear region of the heat-generating vehicle side window according to the second embodiment. FIG. 17 is a graph showing a temperature difference between the front region and the rear region of the heat-generating vehicle side window according to the second embodiment on the basis of the temperature rise values in FIG. 16.

Horizontal axes in FIGS. 15 to 17 indicate a time, and a vertical axis in FIG. 15 corresponds to a temperature. A vertical axis in FIG. 16 corresponds to the temperature rise values of the front region Aa and the rear region Ab. The temperature rise values are values indicating a degree of temperature rise of the front region Aa and the rear region Ab based on a temperature of the front region Aa and a temperature of the rear region Ab when the voltage is applied to the upper busbar 2310 and the lower busbar 2320. A vertical axis in FIG. 17 indicates a temperature difference and indicates the temperature difference between the front region Aa and the rear region Ab based on the temperature rise values of the front region Aa and the rear region Ab in FIG. 16. The temperature difference is obtained by subtracting the temperature rise value of the rear region Ab from the temperature rise value of the front region Aa.

A difference between the heat-generating vehicle side window 2005 according to the second embodiment and the heat-generating vehicle side window according to the first embodiment is a shape of the lower busbar 2320, and the remaining configuration is the same. Therefore, in describing the heating characteristics of the heat-generating vehicle side window 2005 according to the second embodiment, the same reference numerals are denoted by the data results common to the first embodiment, and detailed descriptions will be omitted.

Referring to FIGS. 15 to 17, when the control device 3000 applies the voltage to the upper busbar 2310 and the lower busbar 2320, the heat-generating vehicle side window 2005 may be heated. In this case, a temperature difference may occur between the front region Aa and the rear region Ab, which are portions of the heat-generating vehicle side window 2005.

After the voltage is applied to the upper busbar 2310 and the lower busbar 2320, the temperature difference between the front region Aa and the rear region Ab may be present, and after a predetermined time elapses therefrom, the temperature difference between the front region Aa and the rear region Ab may be reduced.

When the voltage is applied to the upper busbar 2310 and the lower busbar 2320, the temperature difference may occur in the first section P1 after the time point when the voltage is applied to the upper busbar 2310 and the lower busbar 2320 and the second section P2 after the first section P1. The first section P1 and the second section P2 may be divided on the basis of the median time point TPm. The median time point TPm is a first reference and may divide the first section P1 and the second section P2. The first reference may be a predetermined reference.

The first section P1 may include a steady section Ps in which the temperature rise values of the front region Aa and the rear region Ab are zero. In the heat-generating vehicle side window 2005 according to the second embodiment, the steady section Ps may be up to about 10 seconds after the voltage is applied to the busbar 2300. With this configuration, electrons may be relatively uniformly transmitted to the heating member 2200 during the steady section Ps after the voltage is applied to the busbar 2300 so that the heat-generating vehicle side window 2005 is heated relatively uniformly. Therefore, it is possible to prevent a sudden change in the temperature of the heat-generating vehicle side window 2005.

The temperatures of the front region Aa and the rear region Ab in the first section P1 may be lower than the temperatures of the front region Aa and the rear region Ab in the second section P2. In the first section P1, the temperature of the front region Aa may be higher than the temperature of the rear region Ab. In the second section P1, the temperature of the front region Aa may be higher than or equal to the temperature of the rear region Ab.

The temperature difference between the front region Aa and the rear region Ab in the first section P1 may be greater than the temperature difference between the front region Aa and the rear region Ab in the second section P2.

A temperature difference of the front region Aa from a start time point of the first section P1 to an end time point of the first section P1 may be greater than a temperature difference of the front region Aa from a start time point of the second section P2 to an end time point of the second section P2. A temperature difference of the front region Aa in any one region of the first section P1 may be greater than a temperature difference of the front region Aa in any one region of the second section P2.

A temperature difference of the rear region Ab from the start time point of the first section P1 to the end time point of the first section P1 may be greater than a temperature difference of the rear region Ab from the start time point of the second section P2 to the end time point of the second section P2. A temperature difference of the rear region Ab in any one region of the first section P1 may be greater than a temperature difference of the rear region Ab in any one region of the second section P2.

An average temperature difference between the front region Aa and the rear region Ab in the first section P1 may be greater than an average temperature difference between the front region Aa and the rear region Ab in the second section P2.

An average temperature difference of the front region Aa from the start time point of the first section P1 to the end time point of the first section P1 may be greater than an average temperature difference of the front region Aa from the start time point of the second section P2 to the end time point of the second section P2. An average temperature difference of the front region Aa in any one region of the first section P1 may be greater than an average temperature difference of the front region Aa in any one region of the second section P2.

An average temperature difference of the rear region Ab from the start time point of the first section P1 to the end time point of the first section P1 may be greater than an average temperature difference of the rear region Ab from the start time point of the second section P2 to the end time point of the second section P2. An average temperature difference of the rear region Ab in any one region of the first section P1 may be greater than an average temperature difference of the rear region Ab in any one region of the second section P2.

A temperature rise rate of the front region Aa in the first section P1 may be greater than a temperature rise rate of the front region Aa and a temperature rise rate of the rear region Ab in the second section P2. A temperature rise rate of the rear region Ab in the first section P1 may be greater than a temperature rise rate of the front region Aa and the temperature rise rate of the rear region Ab in the second section P2.

The temperature rise rate of the front region Aa in the first section P1 may be greater than the temperature rise rate of the rear region Ab in the first section P1. The temperature rise rate of the front region Aa in the second section P2 may correspond to the temperature rise rate of the rear region Ab in the second section P2. The temperature rise rate of the front region Aa in the second section P2 may be present in a portion corresponding to the temperature rise rate of the rear region Ab in the second section P2.

The second section P2 may include some sections in which the temperature of the front region Aa is equally maintained and include some sections in which the temperature of the rear region Ab is equally maintained. In this case, the temperature rise rates of the front region Aa and the rear region Ab may be zero in some sections of the second section P2.

The temperature rise rate in a section adjacent to the first section P1 of the second section P2 may be greater than the temperature rise rate in a section spaced apart from the first section P1 of the second section P2.

An average temperature rise rate of the front region Aa in the first section P1 may be greater than an average temperature rise rate of the front region Aa and an average temperature rise rate of the rear region Ab in the second section P2. An average temperature rise rate of the rear region Ab in the first section P1 may be greater than the average temperature rise rate in the front region Aa and the average temperature rise rate of the rear region Ab in the second section P2.

The average temperature rise rate of the front region Aa in the first section P1 may be greater than the average temperature rise rate of the rear region Ab in the first section P1. The average temperature rise rate of the front region Aa in the second section P2 may correspond to the average temperature rise rate of the rear region Ab in the second section P2. A portion where the average temperature rise rate of the front region Aa in the second section P2 corresponds to the average temperature rise rate of the rear region Ab in the second section P2 may be present.

The second section P2 may include some sections in which the temperature of the front region Aa is equally maintained and include some sections in which the temperature of the rear region Ab is equally maintained. In this case, the average temperature rise rates of the front region Aa and the rear region Ab may be zero in some sections of the second section P2.

When the voltage is applied to the upper busbar 2310 and the lower busbar 2320, the temperature difference may occur at a first time point TP1 after the time point when the voltage is applied to the upper busbar 2310 and the lower busbar 2320 and a second time point TP2 after the first time point TP1.

The first time point TP1 may be any one time point when the temperature difference between the front region Aa and the rear region Ab is the greatest in the first section P1. At the first time point TP1, a temperature of the front region Aa may be higher than a temperature of the rear region Ab.

The second time point TP2 may be any one time point when the temperature difference between the front region Aa and the rear region Ab is the smallest in the second section P2. At the second time point TP2, a temperature of the front region Aa may be higher than or equal to a temperature of the rear region Ab.

The temperatures of the front region Aa and the rear region Ab may be higher at the second time point TP2 than at the first time point TP1.

In the heat-generating vehicle side window 2005 according to the second embodiment, the front region Aa and the rear region Ab may be non-uniformly heated. This can be confirmed from data indicating that the temperature rise rate of the front region Aa in the first section P1 is greater than the temperature rise rate of the rear region Ab. Therefore, the de-icing and the defogging may be performed more easily in the front region Aa positioned adjacent to the side mirror than in the rear region Ab.

Thereafter, the heat-generating vehicle side window 2005 may be uniformly heated in the second section P2 after passing the median time point TPm. This can be confirmed from data indicating that the temperature rise rates of the front region Aa and the rear region Ab and the temperature difference therebetween in the second section P2 are smaller than those of the first section P1 and the temperature rise rates of the front region Aa and the rear region Ab correspond to each other.

The fact that the heat-generating vehicle side window 2005 is non-uniformly heated after the voltage is applied to the busbar 2300 and is uniformly heated eventually after a predetermined time elapses is to maintain the heated heat-generating vehicle side window 2005 at a predetermined temperature, thereby reducing thermal stress due to the temperature difference applied to the heat-generating vehicle side window 2005 and securing durability. Comparing the heating characteristic of the heat-generating vehicle side window 2005 according to the first embodiment and the heating characteristic of the heat-generating vehicle side window 2005 according to the second embodiment, the following commonalities and differences may be derived.

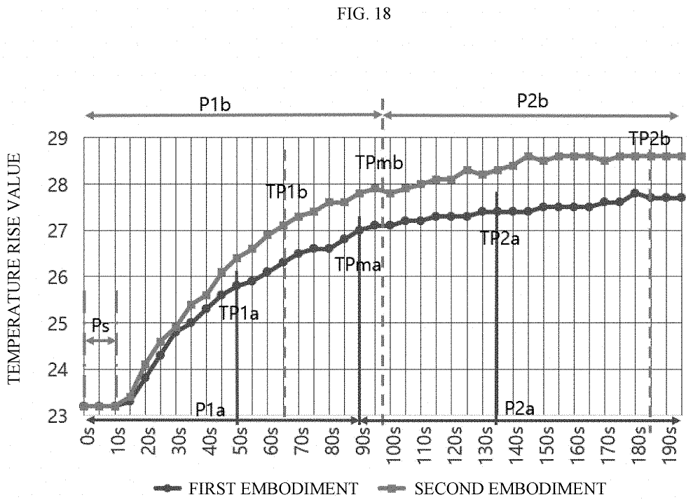

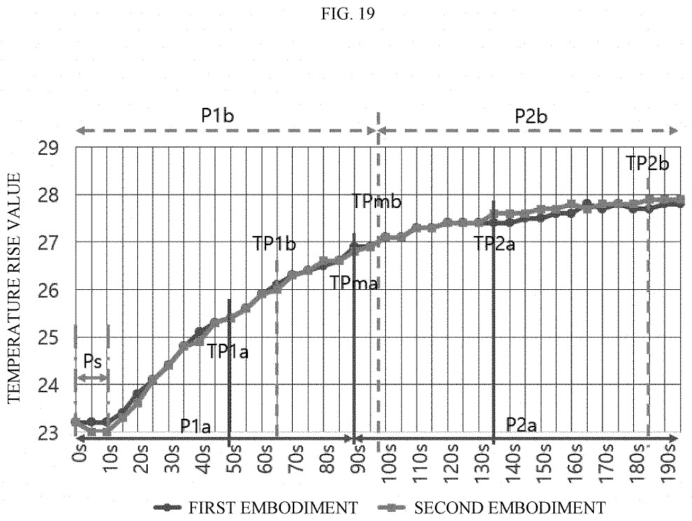

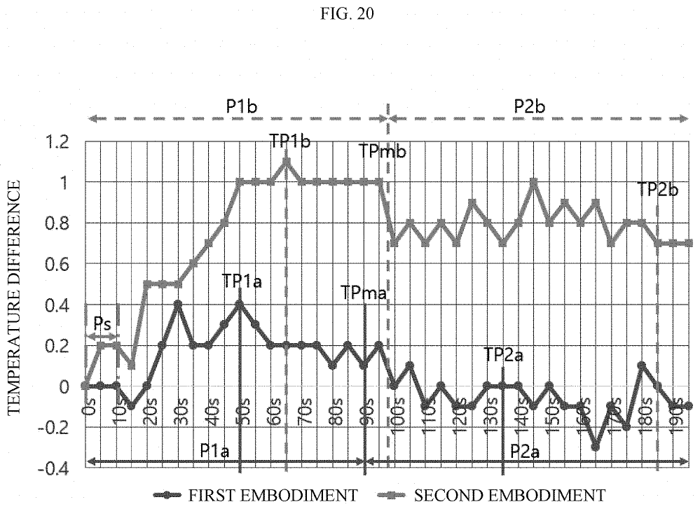

FIG. 18 is a graph showing the temperature rise values of the front regions when the heat-generating vehicle side windows according to the first embodiment and the second embodiment are heated. FIG. 19 is a graph showing the temperature rise values of the rear regions of the heat-generating vehicle side windows according to the first embodiment and the second embodiment. FIG. 20 is a graph showing the temperature differences between the front regions and the rear regions of the heat-generating vehicle side windows according to the first embodiment and the second embodiment.

Horizontal axes in FIGS. 18 to 20 indicate a time, and vertical axes in FIGS. 18 and 19 correspond to the temperature rise values of the front region Aa and the rear region Ab. The temperature rise values are values indicating a degree of temperature rise of the front region Aa and the rear region Ab based on a temperature of the front region Aa and a temperature of the rear region Ab when the voltage is applied to the upper busbar 2310 and the lower busbar 2320. A vertical axis in FIG. 20 indicates the temperature difference and indicates the temperature difference between the front region Aa and the rear region Ab based on the temperature rise values of the front region Aa and the rear region Ab in FIGS. 18 and 19. The temperature difference is obtained by subtracting the temperature rise value of the rear region Ab from the temperature rise value of the front region Aa.

Referring to FIGS. 18 to 20, the heat-generating vehicle side windows 2005 according to the first embodiment and the second embodiment may include the steady section Ps. The steady section Ps may be a section in which electrons are transmitted from the control device 3000 to the heating member 2200 through the busbar 2300. Since electrons are relatively uniformly transmitted to the heating member 2200 during the steady section Ps, the heat-generating vehicle side window 2005 may be relatively uniformly heated. Therefore, it is possible to prevent a sudden change in the temperature of the heat-generating vehicle side window 2005.

Based on the steady section Ps, a temperature rise rate in a section adjacent to the steady section Ps of first sections P1a and P1b may be greater than a temperature rise rate in a section adjacent to second sections P2a and P2b of the first sections P1a and P1b.

Comparing temperature rise values of the front regions Aa according to the first embodiment and the second embodiment in FIG. 18, the heat-generating vehicle side window 2005 according to the second embodiment is heated quickly at a higher temperature than the heat-generating vehicle side window 2005 according to the first embodiment for a certain time. Here, the certain time may be the first sections P1a and P1b. A temperature of the front region Aa at any one time point in the first sections P1a and P1b may be lower in the first embodiment than in the second embodiment. In the second sections P2a and P2b after the first section P1a and P1b are terminated and median time points TPma and TPmb passes, the heat-generating vehicle side window 2005 may be heated while converging to a predetermined temperature.

Since a distance between the upper busbar 2310 and the lower busbar 2320 of the front region Aa according to the second embodiment is shorter than a distance between the upper busbar 2310 and the lower busbar 2320 of the front region Aa according to the first embodiment, the front region Aa according to the second embodiment may be heated faster than the front region Aa according to the first embodiment. This is because when power per unit area is calculated by dividing all upper busbars 2310 by the same length and dividing the lower busbar 2320 to correspond thereto so that all lower busbars 2320 have the same length, the power per unit area is inversely proportional to the distance between the upper busbar 2310 and the lower busbar 2320. Therefore, since the front region Aa according to the second embodiment may be heated faster than the front region Aa according to the first embodiment, the heat-generating vehicle side window 2005 according to the second embodiment is further optimized for the de-icing and the defogging for the side mirror than the heat-generating vehicle side window 2005 according to the first embodiment.

Comparing temperature rise values of the rear regions Ab according to the first embodiment and the second embodiment in FIG. 19, the rear region Ab according to the first embodiment is heated in the form corresponding to the temperature of the rear region Ab according to the second embodiment. At any one time point after the voltage is applied to the busbar 2300, a temperature of the rear region Ab according to the first embodiment may correspond to a temperature of the rear region Ab according to the second embodiment. This may be because the distances between the upper busbars 2310 and the lower busbars 2320 positioned in the rear regions Ab according to the first embodiment and the second embodiment correspond to each other. In other words, in the first sections P1a and P1b and the second sections P2a and P2b, the temperature differences and the temperature rise rates of the rear regions Ab according to the first embodiment and the second embodiment may correspond to each other.

Referring to FIG. 20, the temperature difference of the heat-generating vehicle side window 2005 according to the second embodiment may be greater than the temperature difference of the heat-generating vehicle side window 2005 according to the first embodiment. The temperature difference is obtained by subtracting the temperature rise value of the rear region Ab from the temperature rise value of the front region Aa, and when the temperature rise values of the rear regions Ab according to the first embodiment and the second embodiment correspond to each other, the temperature difference according to the second embodiment having a greater temperature rise value of the front region Aa may be greater than the temperature difference according to the first embodiment.

The temperature difference of the heat-generating vehicle side window 2005 according to the first embodiment is mostly in the range of about 0 to 0.2. Therefore, it can be confirmed that the heat-generating vehicle side window 2005 according to the first embodiment is uniformly heated as the temperature difference between the front region Aa and the rear region Ab according to the first embodiment does not occur or is smaller than the temperature difference between the front region Aa and the rear region Ab according to the second embodiment to be described below.

It can be confirmed that the temperature difference of the heat-generating vehicle side window 2005 according to the second embodiment is in the range of about 0 to 1.1 and is greater than the temperature difference according to the first embodiment. In other words, it can be confirmed that the entirety of the heat-generating vehicle side window 2005 is non-uniformly heated because the temperature of the front region Aa according to the second embodiment is higher than the temperature of the front region Aa according to the first embodiment and the front region Aa is heated faster than the rear region Ab in the heat-generating vehicle side window 2005 according to the second embodiment compared to the heat-generating vehicle side window 2005 according to the first embodiment.

In the heat-generating vehicle side window 2005 according to the second embodiment, the front region Aa according to the second embodiment is heated at a higher temperature than the front region Aa according to the first embodiment, and the temperature difference between the front region Aa and the rear region Ab according to the second embodiment in the first section P1b is greater than the temperature difference between the front region Aa and the rear region Ab according to the first embodiment in the first section P1a. Therefore, a time for which after the control device 3000 applies the voltage to the busbar 2300, the front region Aa and the rear region Ab are required to converge to a predetermined temperature and to be uniformly heated while reducing the temperature difference between the front region Aa and the rear region Ab may be longer in the second embodiment than that in the first embodiment. In other words, the first section P1b in the second embodiment may be longer than the first section P1a in the first embodiment. The first section P1a in the first embodiment may be shorter than the first section P1b in the second embodiment, and the second section P2a in the first embodiment may be longer than the second section P2b in the second embodiment. Therefore, in the median time points TPma and TPmb dividing the first sections P1a and P1b and the second sections P2a and P2b, the median time point TPmb in the second embodiment may be a later time point than the median time point TPma in the first embodiment.

The first time point TP1b in the second embodiment may be a time point that is later than the first time point TP1a in the first embodiment, and the second time point TP2b in the second embodiment may be a time point that is later than the second time point TP2a in the first embodiment. This can be confirmed from the data in FIGS. 18 to 20.

In the first embodiment, since the first section P1a is shorter than in the second embodiment, the second section P2a in which the front region Aa and the rear region Ab are heated as the front region Aa and the rear region Ab converge to a predetermined temperature is reached quickly. In other words, the temperature change of the heat-generating vehicle side window 2005 is terminated earlier than in the second embodiment, and the heat-generating vehicle side window 2005 is heated while maintaining the predetermined temperature. Therefore, the time for which thermal stress is applied to the heat-generating vehicle side window 2005 can be reduced, thereby minimizing damage to the heat-generating vehicle side window 2005.

In the second embodiment, the temperature difference between the front region Aa and the rear region Ab is greater than in the first embodiment, and the first section P1b is longer than in the first embodiment. This means that the time for which the front region Aa is maintained at a higher temperature than the rear region Ab is longer than in the first embodiment, and since the front region Aa where the side mirror is positioned is well heated and thus the de-icing and the defogging of the front region Aa will be performed more effectively than the rear region Ab, it is easy to secure the user's view when the vehicle 1000 travels.

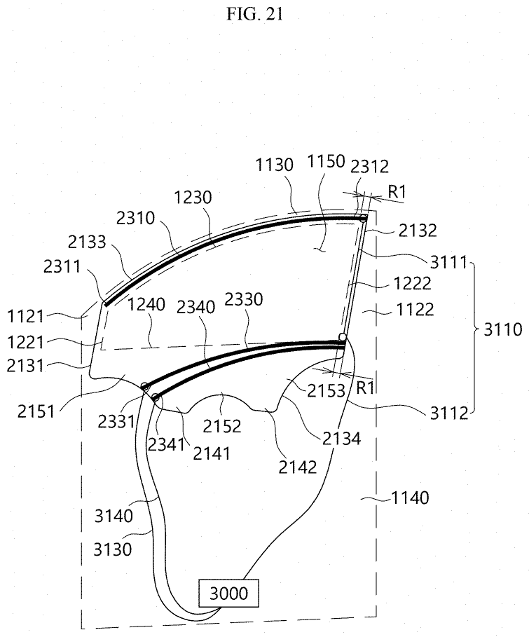

FIG. 21 is a view showing a heat-generating vehicle side window according to a third embodiment.

A difference between the heat-generating vehicle side window 2005 according to the third embodiment and the heat-generating vehicle side window 2005 according to the first embodiment is the number of lower busbars 2320 and a shape of the lower busbar 2320, and the remaining configuration is the same. Therefore, in describing the heat-generating vehicle side window 2005 according to the third embodiment, the same reference numerals are denoted by the components common to the first embodiment, and detailed descriptions thereof will be omitted.

Referring to FIG. 21, the heat-generating vehicle side window 2005 according to the third embodiment may include two lower busbars 2320. The lower busbar 2320 may include a first lower busbar 2330 and a second lower busbar 2340.

The first lower busbar 2330 may be positioned closer to the upper busbar 2310 than the second lower busbar 2340. The first lower busbar 2330 and the second lower busbar 2340 may be formed in a state of not being in contact with each other. The first lower busbar 2330 and the second lower busbar 2340 may be formed to be spaced apart from each other.

Although not shown in the drawing, the heat-generating vehicle side window 2005 according to the third embodiment may include a virtual line parallel to a first direction D1 or a second direction D2, which is a moving direction of the heat-generating vehicle side window 2005. The virtual line may be present while passing the first lower busbar 2330 and the second lower busbar 2340. In this case, a distance between one point at which the virtual line and the first lower busbar 2330 meet and the lower frame boundary portion 1240 may be shorter than a distance between one point at which the virtual line and the second lower busbar 2340 meet and the lower frame boundary portions 1240.

The first lower busbar 2330 corresponds to the position and shape of the lower busbar 2320 in the second embodiment. The second lower busbar 2340 corresponds to the position and shape of the lower busbar 2320 in the first embodiment. The wire 3100 may be connected to each of the first lower busbar 2310 and the second lower busbar 2320. One or more wires 3100 may also be connected to each of the first lower busbar 2330 and the second lower busbar 2340. For example, the wire 3100 may also be connected to the one end 2331 and/or the other end 2332 of the first lower busbar and the one end 2341 and/or the other end 2342 of the second lower busbar.

In the drawing, the wire 3100 may include a third wire 3130 and a fourth wire 3140.

The third wire 3130 may connect the first lower busbar 2330 and the control device 3000. The third wire 3130 may be connected to the one end 2331 of the first lower busbar. Both ends of the third wire 3130 may be fixed to the one end 2331 of the first lower busbar and the control device 3000. The third wire 3130 may be deformed or moved with a degree of freedom in a state in which both ends are fixed to the one end 2331 of the first lower busbar and the control device 3000.

The fourth wire 3140 may connect the second lower busbar 2340 and the control device 3000. The fourth wire 3140 may be connected to the one end 2341 of the second lower busbar. Both ends of the fourth wire 3140 may be fixed to the one end 2341 of the second lower busbar and the control device 3000. The fourth wire 3140 may be deformed or moved with a degree of freedom in a state in which both ends are fixed to the one end 2341 of the second lower busbar and the control device 3000.

The third wire 3130 and the fourth wire 3140 may not be visually recognized because the third wire 3130 and the fourth wire 3140 are covered by the lower frame 1140. Although the third wire 3130 and the fourth wire 3140 are shown as being connected to the one end 2331 of the first lower busbar and the one end 2341 of the second lower busbar in the drawing, the third wire 3130 and the fourth wire 3140 may also be connected to any position of the first lower busbar 2330 and the second lower busbar 2340. Since the first lower busbar 2330 and the second lower busbar 2340 are covered by the lower frame 1140 and thus there is no need to consider that the wire 3100 is visually recognized, the third wire 3130 and the fourth wire 3140 may also be connected to any position of the first lower busbar 2330 and the second lower busbar 2340.

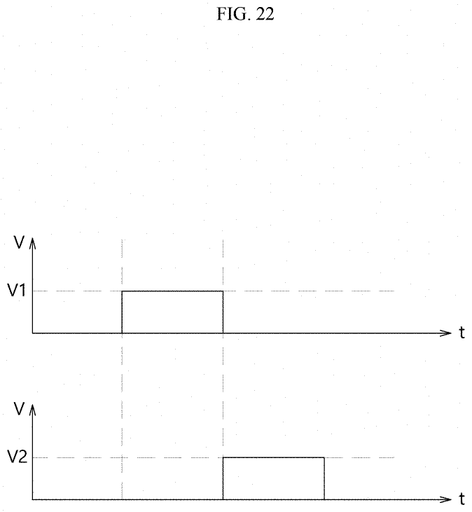

FIG. 22 is a waveform diagram showing a sequence of voltages applied to a first lower busbar and a second lower busbar according to the third embodiment.

Referring to FIG. 22, the control device 3000 may output a voltage to each of the first lower busbar 2330 and the second lower busbar 2340. A first voltage V1 may be applied to the first lower busbar 2330, and a second voltage V2 may be applied to the second lower busbar 2340.

The control device 3000 may sequentially apply the voltages to the first lower busbar 2330 and the second lower busbar 2340. The control device 3000 may control the voltages not to be simultaneously applied to the first lower busbar 2330 and the second lower busbar 2340.

The control device 3000 may apply the voltage to the first lower busbar 2330 prior to the second lower busbar 2340. Specifically, when the control device 3000 applies the first voltage V1 to the first lower busbar 2330 and then the application of the first voltage V1 is terminated, the control device 3000 may apply the second voltage V2 to the second lower busbar 2340. In other words, the control device 3000 may alternately apply the first voltage V1 and the second voltage V2.

The control device 3000 may first apply the first voltage V1 to the first lower busbar 2330 to be heated as in the heat-generating vehicle side window 2005 in the second embodiment. Thereafter, the control device 3000 may apply the second voltage V2 to the second lower busbar 2340 to be heated as in the heat-generating vehicle side window 2005 in the first embodiment.

Therefore, since the heat-generating vehicle side window 2005 may be preferentially defogged or de-iced in a region adjacent to the side mirror, the driver can more quickly detect external environments.

However, since the application of the voltages to the first lower busbar 2330 and the second lower busbar 2340 is not dependent on the drawing, the control device 3000 may simultaneously output the first voltage V1 and the second voltage V2 and simultaneously apply the voltages to the first lower busbar 2330 and the second lower busbar 2340. Alternatively, the second voltage V2 may also be first applied to the second lower busbar 2340 according to the user's intention.

Magnitudes of the first voltage V1 and the second voltage V2 may also be the same as or different from each other.

The control device 3000 may output the first voltage V1 and the second voltage V2 according to a value detected by a sensor or a user input.

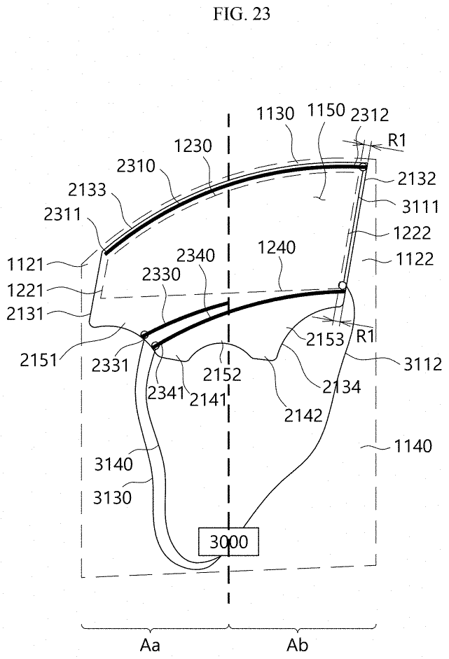

FIG. 23 is a view showing a heat-generating vehicle side window according to a fourth embodiment.

A difference between the heat-generating vehicle side window 2005 according to the fourth embodiment and the heat-generating vehicle side window 2005 according to the third embodiment is a shape of the first lower busbar 2330, and the remaining configuration is the same. Therefore, in describing the heat-generating vehicle side window 2005 according to the fourth embodiment, the same reference numerals are denoted by the components common to the third embodiment, and detailed descriptions will be omitted.

Referring to FIG. 23, the heat-generating vehicle side window 2005 according to the fourth embodiment may include two lower busbars 2320. The lower busbar 2320 may include a first lower busbar 2330 and a second lower busbar 2340.

The first lower busbar 2330 may be positioned in only a region adjacent to the vehicle front heating window 2001. The first lower busbar 2330 may be positioned closer to the upper busbar 2310 than the second lower busbar 2340. A length of the first lower busbar 2330 may be smaller than that of the second lower busbar 2340.

The one end 2331 of the first lower busbar may be positioned adjacent to the front edge 2131. The one end 2331 of the first lower busbar may be positioned adjacent to the first recess 2151. The other end 2332 of the first lower busbar may be positioned in a region adjacent to the second recess 2152. The other end 2332 of the first lower busbar may be positioned in a region adjacent to a middle portion of the second lower busbar 2340.

The first lower busbar 2330 may be formed in a manner in which the first lower busbar 2330 in the third embodiment is only formed from the region adjacent to the first recess 2151 to the region adjacent to the second recess 2152.

The first lower busbar 2330 and the second lower busbar 2340 may not be visually recognized by the user because the first lower busbar 2330 and the second lower busbar 2340 are covered by the lower frame 1140.

The heat-generating vehicle side window 2005 according to the fourth embodiment may include the front region Aa and the rear region Ab. The front region Aa and the rear region Ab may be divided by the positions of the first lower busbar 2330 and the second lower busbar 2340.

The front region Aa may be a region including the first lower busbar 2330. The front region Aa may be a region corresponding to a region where the de-icing DI or the defogging DF is performed when the voltage is applied to the first lower busbar 2330. The front region Aa may be a region where the side mirror is more easily visually recognized when the driving of the de-icing DI or the defogging DF is performed.

The rear region Ab may be a region including a portion of the second lower busbar 2340.

Although not shown in the drawing, the heat-generating vehicle side window 2005 according to the fourth embodiment may include a virtual line parallel to the first direction D1 or the second direction D2 that is a moving direction of the heat-generating vehicle side window 2005. The virtual line may be present while passing the first lower busbar 2330 and the second lower busbar 2340. In this case, a distance between one point at which the virtual line and the first lower busbar 2330 meet and the lower frame boundary portion 1240 may be shorter than a distance between one point at which the virtual line and the second lower busbar 2340 meet and the lower frame boundary portions 1240.

A length of the first lower busbar 2330 in the fourth embodiment is smaller than that of the first lower busbar 2330 in the third embodiment. Therefore, the driver can visually recognize the side mirror more quickly by intensively defogging the region of the heat-generating vehicle side window 2005 in which the side mirror may be visually recognized. In addition, power consumption can also be less than that of the heat-generating vehicle side window 2005 according to the third embodiment.

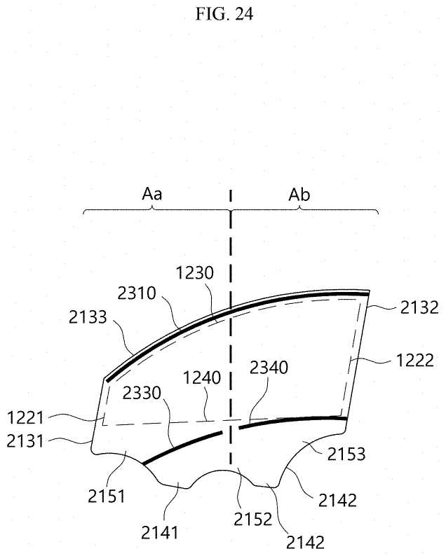

FIG. 24 is a view showing a heat-generating vehicle side window according to a fifth embodiment.

A difference between the heat-generating vehicle side window 2005 according to the fifth embodiment and the heat-generating vehicle side window 2005 according to the second embodiment is a shape of the lower busbar 2320, and the remaining configuration is the same. Therefore, in describing the heat-generating vehicle side window 2005 according to the fifth embodiment, the same reference numerals are denoted by the components common to the second embodiment, and detailed descriptions thereof will be omitted.

Referring to FIG. 24, the heat-generating vehicle side window 2005 according to the fifth embodiment may include a first lower busbar 2330 and a second lower busbar 2340. The first lower busbar 2330 and the second lower busbar 2340 may be positioned inside the lower frame 1140. Therefore, the first lower busbar 2330 and the second lower busbar 2340 may not be visually recognized by the user because the first lower busbar 2330 and the second lower busbar 2340 are covered by the lower frame 1140. The first lower busbar 2330 and the second lower busbar 2340 may be formed in a state of not being in contact with each other. The first lower busbar 2330 and the second lower busbar 2340 may be formed to be spaced apart from each other.

The one end 2331 of the first lower busbar may be positioned in a region adjacent to the front edge 2131. The one end 2331 of the first lower busbar may be positioned in a region adjacent to the first recess 2151. The other end 2332 of the first lower busbar may be positioned in a region adjacent to the second recess 2152. The first lower busbar 2330 may be formed in a manner that the lower busbar 2320 in the second embodiment is only formed from the region adjacent to the front edge 2131 or the first recess 2151 to the region adjacent to the second recess 2152.

The one end 2341 of the second lower busbar may be positioned in the region adjacent to the second recess 2152. The other end 2342 of the second lower busbar may be positioned in a region adjacent to the rear edge 2132. The other end 2342 of the second lower busbar may be positioned in a region adjacent to the third recess 2153. The second lower busbar 2340 may be formed in a manner that the lower busbar 2320 in the second embodiment is only formed from the region adjacent to the second recess 2152 to the region adjacent to the rear edge 2132 or the third recess 2153.

The heat-generating vehicle side window 2005 according to the fifth embodiment may include a front region Aa and a rear region Ab. The front region Aa may be defined in the same manner as the front region Aa in the fourth embodiment. The rear region Ab may be a region including the second lower busbar 2340. The rear region Ab may be a region corresponding to a region where the de-icing DI or the defogging DF is performed when the voltage is applied to the second lower busbar 2340. The rear region Ab may be defined in the same manner as the rear region Ab in the fourth embodiment except for the differences described above.

The first lower busbar 2330 in the fifth embodiment may correspond to a portion of the lower busbar 2320 in the second embodiment. The second lower busbar 2340 in the fifth embodiment may correspond to a portion of the lower busbar 2320 in the second embodiment. In other words, each of the first lower busbar 2330 and the second lower busbar 2340 in the fifth embodiment may correspond to a shape in which any one region of the lower busbar 2320 in the second embodiment is cut off. The lengths of the first lower busbar 2330 and the second lower busbar 2340 may be smaller than that of the lower busbar 2320 in the second embodiment. When the defogging or the de-icing is performed by applying the voltage to the first lower busbar 2330, power consumption can be relatively less than in the second embodiment.

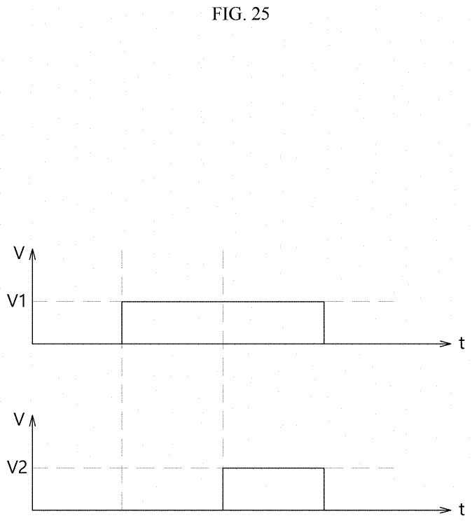

FIG. 25 is a waveform diagram showing a sequence of voltages applied to a first lower busbar and a second lower busbar according to the fifth embodiment.

Referring to FIG. 25, the control device 3000 may output a voltage to each of the first lower busbar 2330 and the second lower busbar 2340. The control device 3000 may sequentially apply the voltages to the first lower busbar 2330 and the second lower busbar 2340.

The control device 3000 may apply the voltage to the first lower busbar 2330 prior to the second lower busbar 2340. Specifically, after the control device 3000 applies the first voltage V1 to the first lower busbar 2330 and a preset time elapses, the second voltage V2 may be applied to the second lower busbar 2340. In other words, the control device 3000 may apply the first voltage V1 to the first lower busbar 2330 and then simultaneously apply the first voltage V1 and the second voltage V2.

The control device 3000 may first apply the first voltage V1 to the first lower busbar 2330 to be heated as in the heat-generating vehicle side window 2005 according to the fourth embodiment. Thereafter, the control device 3000 applies the second voltage V2 to the second lower busbar 2340 in a state of applying the first voltage V1 to the first lower busbar 2330 to be heated as in the heat-generating vehicle side window 2005 according to the second embodiment. In summary, the heat-generating vehicle side window 2005 may preferentially perform the defogging or de-icing in a region adjacent to the side mirror with less power consumption than the heat-generating vehicle side window 2005 according to the second embodiment, thereby allowing the driver to detect the external environments more quickly while increasing energy efficiency.

However, since the application of the voltages to the first lower busbar 2330 and the second lower busbar 2340 is not dependent on the drawing, the control device 3000 may alternately output the first voltage V1 and the second voltage V2 as well. This is to allow the defogging or de-icing to be selectively performed in only a region desired by the driver.

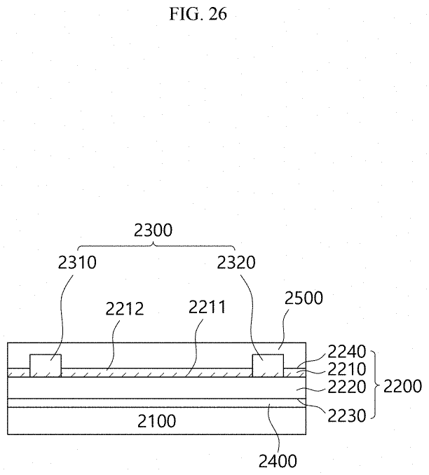

FIG. 26 is a cross-sectional view showing a cross-sectional structure of a heat-generating vehicle side window according to a sixth embodiment. Top, bottom, left, and right directions may be based on the drawing shown in FIG. 26, and the basis on the directions are not dependent on the drawing.

Referring to FIG. 26, the heat-generating vehicle side window 2005 according to the sixth embodiment may include only one base 2100 compared to the heat-generating vehicle side window 2005 according to the first embodiment and may further include a coating layer 2500. In other words, the heat-generating vehicle side window 2005 according to the sixth embodiment may include the base 2100, the heating member 2200, the intermediate layer 2400, and the coating layer 2500. The heat-generating vehicle side window 2005 may include the busbar 2300 that is in contact with the heating member 2200.

The base 2100 is a surface positioned on the lower portion of the heat-generating vehicle side window 2005 in the drawing and one base 2100 may be provided.

The heating member 2200 may be positioned adjacent to the base 2100. The first surface 2230 may be a surface adjacent to the base 2100, and the second surface 2240 may be a surface positioned in an opposite direction adjacent to the base 2100.

The busbar 2300 may be positioned adjacent to the heating member 2200. Specifically, the busbar 2300 may be electrically connected to the heating element 2210. The busbar 2300 may be positioned in contact with a portion of the second surface 2240.

However, the position of the busbar 2300 is not limited to the shape defined in the drawing, and the busbar 2300 may be positioned adjacent to the base 2100. In this case, the heating element 2210 may be positioned between the base 2100 and the substrate 2220.

The intermediate layer 2400 may be positioned adjacent to the heating member 2200.

The intermediate layer 2400 may be positioned adjacent to the base 2100. The intermediate layer 2400 may be positioned between the base 2100 and the heating member 2200. The intermediate layer 2400 may bond the heating member 2200 to the base 2100.

The coating layer 2500 may be positioned on the heating member 2200. The coating layer 2500 may be positioned in contact with the second surface 2240 and the busbar 2300.

The coating layer 2500 may be formed in the form of covering the heating member 2200 and the busbar 2300. This is to protect the heating member 2200 and the busbar 2300 from foreign substances introduced from the outside. In addition, the coating layer 2500 may prevent physical damage to the heating member 2200 and the busbar 2300 due to an external impact.

Since the heat-generating vehicle side window 2005 according to the sixth embodiment may have a smaller weight than the heat-generating vehicle side window 2005 according to the first embodiment, it is possible to improve the fuel efficiency of the vehicle 1000. In addition, a manufacturing process operation of the heat-generating vehicle side window 2005 can be reduced, thereby reducing the manufacturing cost.

However, a cross-sectional structure in the embodiment may be formed in a structure other than that of the drawing, and the present invention is not limited to the structure of the drawing. For example, the heating element 2210 may be formed directly on the base 2100, and the intermediate layer 2400 may also be omitted. In other words, the heating element 2210 may also be configured in the form of being directly in contact with the base 2100 in a state in which the intermediate layer 2400 and the substrate 2220 are omitted. In this case, the intermediate layer 2400 can be omitted, thereby reducing the manufacturing cost.

The base 2100 may be positioned adjacent to an outer side of the vehicle 1000. The heating member 2200, the busbar 2300, the intermediate layer 2400, and the coating layer 2500 may be positioned closer to an inner side of the vehicle 1000 than the base 2100.

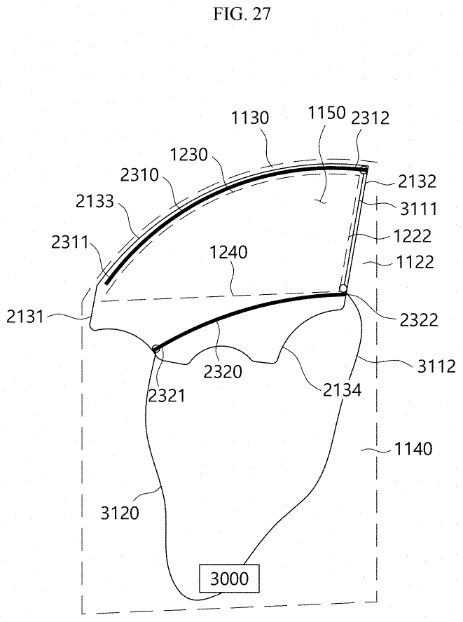

FIG. 27 is a view showing a heat-generating vehicle side window according to a seventh embodiment.

A difference between the heat-generating vehicle side window 2005 according to the seventh embodiment and the heat-generating vehicle side window 2005 according to the first embodiment is a shape of the front frame 1121 and whether the front frame boundary portion 1221 is present, and the remaining configuration is the same. Therefore, in describing the heat-generating vehicle side window 2005 according to the seventh embodiment, the same reference numerals are denoted by the components common to the first embodiment, and detailed descriptions thereof will be omitted.

Referring to FIG. 27, in the heat-generating vehicle side window 2005 according to the seventh embodiment, the front frame 1121 and the front frame boundary portion 1221 may not be present.

The vehicle 1000 may be designed in a shape in which the lower frame 1140 is directly connected to the upper frame 1130 without the front frame 1121. In this case, the frame boundary portion 1200 may also be designed to have a shape corresponding thereto. In other words, the frame boundary portion 1200 may be designed in a shape in which the lower frame boundary portion 1240 is directly connected to the upper frame boundary portion 1230 without the front frame boundary portion 1221. A length of the front edge 2131 of the heat-generating vehicle side window 2005 may be smaller than in the first embodiment. The purpose of the design of the vehicle 1000 is to reduce a resistance due to wind while the vehicle travels.

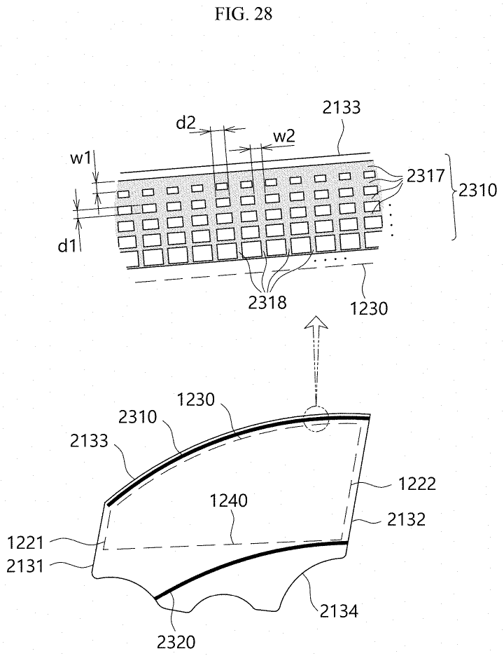

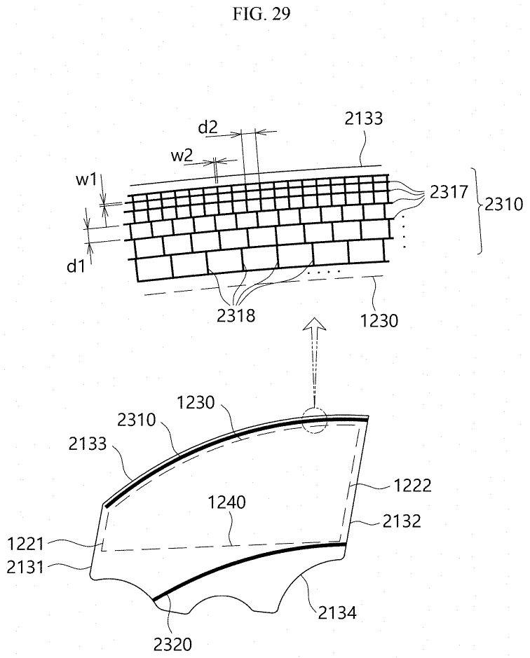

FIGS. 28 and 29 are views showing a heat-generating vehicle side window according to an eighth embodiment. A shape in the eighth embodiment may also be configured in a shape other than that of the drawing, and the present invention is not limited to the shape of the drawing.

A difference between the heat-generating vehicle side window 2005 according to the eighth embodiment and the heat-generating vehicle side window 2005 according to the first embodiment is a shape of the upper busbar 2310, and the remaining configuration is the same. Therefore, in describing the heat-generating vehicle side window 2005 according to the eighth embodiment, the same reference numerals are denoted by the components common to the first embodiment, and detailed descriptions thereof will be omitted.

The upper busbar 2310 in the eighth embodiment may be formed in a metal mesh or metal grid structure.

The upper busbar 2310 may include a plurality of first metal lines 2317 and a plurality of second metal lines 2318. The plurality of first metal lines 2317 and the plurality of second metal lines 2318 may be formed to cross each other. The plurality of first metal lines 2317 and the plurality of second metal lines 2318 may be electrically connected to each other.

The plurality of first metal lines 2317 may be formed to extend from the front edge 2131 to the rear edge 2132. The adjacent first metal lines 2317 may be formed parallel to each other.

The plurality of second metal lines 2318 may be formed to extend from the upper edge 2133 to the lower edge 2134. The adjacent second metal lines 2318 may be formed parallel to each other.

The plurality of first metal lines 2317 and the plurality of second metal lines 2318 may be formed in a matrix shape while crossing each other.

Referring to FIG. 28, the upper busbar 2310 may include the first metal line 2317 and the second metal line 2318.

The adjacent first metal lines 2317 may have different line widths. One first metal line 2317 may be formed to have the same line width in a direction extending from the front edge 2131 to the rear edge 2132.

The plurality of first metal lines 2317 may have a smaller line width w1 from the upper edge 2133 toward the lower edge 2134. In other words, the first metal line 2317 adjacent to the upper edge 2133 among the plurality of first metal lines 2317 may have the greatest line width w1, and the first metal line 2317 adjacent to the lower edge 2134 may have the smallest line width w1. The adjacent first metal lines 2317 may have an interval d1 between the adjacent first metal lines 2317 that is changed from the upper edge 2133 toward the lower edge 2134 by the variable line width w1.

One second metal line 2318 may have a different line width w2 in a direction extending from the upper edge 2133 to the lower edge 2134. The second metal line 2318 may have a smaller line width w2 from the upper edge 2133 toward the lower edge 2134. In other words, the second metal line 2318 may gradually become narrower from the upper edge 2133 toward the lower edge 2134.

The second metal line 2318 may have the line width w2 corresponding to the line width w1 of the first metal line 2317 that meets while extending from the upper edge 2133 to the lower edge 2134.

The plurality of parallel second metal lines 2318 may have shapes corresponding to each other. Each of the second metal lines 2318 may have a shape which gradually becomes narrower from the upper edge 2133 toward the lower edge 2134. The adjacent second metal lines 2318 may have an interval d2 between the adjacent second metal lines 2318 that is changed by the variable line width w2.

Referring to FIG. 29, the upper busbar 2310 may include the first metal line 2317 and the second metal line 2318. The first metal line 2317 and the second metal line 2318 may be formed to have the corresponding line widths w1 and w2. The first metal line 2317 and the second metal line 2318 may be formed to have the same line widths w1 and w2.

The adjacent first metal lines 2317 may have different intervals d1 from each other. The interval d1 between the plurality of first metal lines 2317 may increase from the upper edge 2133 toward the lower edge 2134. In other words, the first metal lines 2317 adjacent to the upper edge 2133 may have the smallest interval d1, and the first metal lines 2317 adjacent to the lower edge 2134 may have the greatest interval d1.

The adjacent second metal lines 2318 may have different intervals d2 from each other. The intervals d2 between the plurality of second metal lines 2318 may gradually increase from the upper edge 2133 toward the lower edge 2134.

In summary, occupied areas per unit area of the first metal line 2317 and the second metal line 2318 may decrease from the upper edge 2133 toward the lower edge 2134. In addition, although not shown in FIGS. 28 and 29, thicknesses of the first metal line 2317 and the second metal line 2318 may decrease from the upper edge 2133 toward the lower edge 2134. In this case, occupied volumes per unit volume of the first metal line 2317 and the second metal line 2318 may decrease from the upper edge 2133 toward the lower edge 2134. Therefore, a transmittance of the upper busbar 2310 may increase from the upper edge 2133 toward the lower edge 2134, and the upper busbar 2310 may be visually recognized by the driver in a gradated shape. In other words, in the upper busbar 2310 in the eighth embodiment as described above, a proportion of the upper busbar 2310 recognized by the driver may be relatively smaller than that of the upper busbar 2310 in the first embodiment.

When the heat-generating vehicle side window 2005 is positioned at the first position L1, a portion of the upper busbar 2310 may be visually recognized as if it is naturally connected to the rubber packing constituting the upper frame 1130 even when the portion of the upper busbar 2310 is not covered by the upper frame 1130.

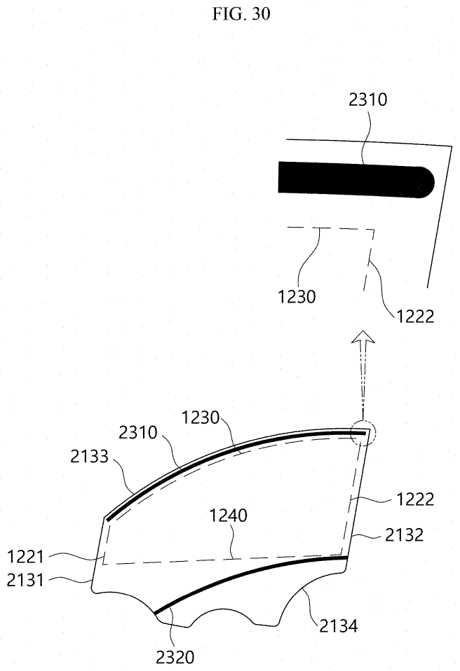

FIG. 30 is a view showing a heat-generating vehicle side window according to a ninth embodiment.

A difference between the heat-generating vehicle side window 2005 according to the ninth embodiment and the heat-generating vehicle side window 2005 according to the first embodiment is a shape of the upper busbar 2310, and the remaining configuration is the same. Therefore, in describing the heat-generating vehicle side window 2005 according to the ninth embodiment, the same reference numerals are denoted by the components common to the first embodiment, and detailed descriptions thereof will be omitted.

Referring to FIG. 30, one end and/or the other end of the busbar 2300 may be formed in a curved shape. Preferably, the one end 2311 and the other end 2312 of the upper busbar and the one end 2321 and the other end 2322 of the lower busbar may have a curved shape.

The one end 2311 and the other end 2312 of the upper busbar having a curved shape may not be visually recognized by the driver because the one end 2311 and the other end 2312 of the upper busbar are covered by the side frame 1120. The one end 2311 and the other end 2312 of the upper busbar may not still be visually recognized even when the heat-generating vehicle side window 2005 moves in the first direction D1 or the second direction D2.

When the one end and the other end of the busbar 2300 have the curved shape, a degree at which a hot spot is generated may be less than the busbar 2300 having an uncurved shape. Therefore, it is possible to reduce the possibility that the heat-generating vehicle side window 2005 is damaged due to the hot spot.

The structure of the heat-generating vehicle side window according to the embodiment may also be applied to electrochromic. Uniform discoloration may be possible in the entire region by the structure of the heat-generating vehicle side window according to the embodiment.

In this case, the heat-generating vehicle side window according to the embodiment may freely adjust a transmittance of sunlight introduced from the outside. Therefore, it is possible to control the external light irradiated to the driver, thereby securing the user's view and improving the driving convenience.

The heat-generating vehicle side window structure in the embodiment may also be applied to energy harvesting. In this case, energy efficiency can be increased by transmitting the electrical energy produced by the energy harvesting structure through the busbar.

In addition, the heat-generating vehicle side window structure in the embodiment may also be applied to other electric devices that may be attached to the window of the vehicle.

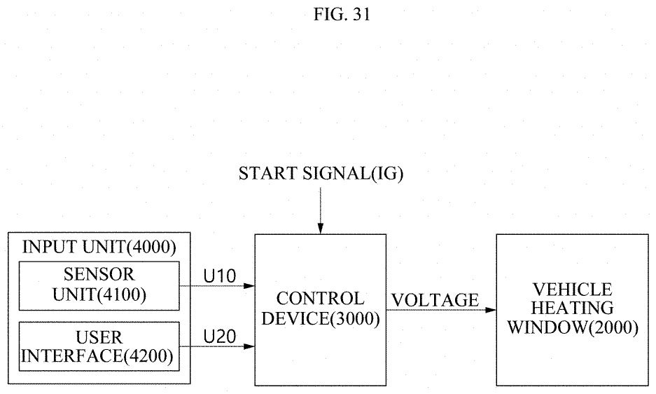

FIG. 31 is a view of a vehicle heating window system.

The vehicle heating window system may include an input unit 4000, a control device 3000, and a vehicle heating window 2000.

The input unit 4000 may output an input signal to the control device 3000. The control device 3000 may apply a voltage to the vehicle heating window 2000 on the basis of the input signal. The vehicle heating window 2000 may be heated on the basis of the voltage applied from the control device 3000.

The input unit 4000 may output a signal on a state of the vehicle 1000 or a signal on a user input. The state of the vehicle 1000 may be a state in which fog, frost, or ice is generated on the vehicle heating window 2000. The signal on the state of the vehicle 1000 and the signal on the user input may be electrical signals.

The input unit 4000 may include at least one of a sensor unit 4100 and a user interface 4200.

The sensor unit 4100 may detect environmental information of the vehicle 1000. The sensor unit 4100 may detect internal and external environmental information of the vehicle 1000. The sensor unit 4100 may detect information on a state of the vehicle heating window 2000. The sensor unit 4100 may detect information on a transmittance of the vehicle heating window 2000. The sensor unit 4100 may detect whether fog, frost, or ice is generated on the vehicle heating window 2000. The sensor unit 4100 may detect a degree at which fog, frost, or ice is generated on the vehicle heating window 2000.

The sensor unit 4100 may include at least one of an optical sensor, a humidity sensor, an infrared sensor, and a carbon dioxide sensor. The optical sensor may be a rain sensor. The sensor unit 4100 may include a plurality of sensors, and in this case, the sensor unit 4100 may detect information on the state of the vehicle heating window 2000 on the basis of values detected by the plurality of sensor units 4100.

The sensor unit 4100 may output a sensor signal U10 to the control device 3000. The sensor signal U10 may be a signal based on the information on the state of the vehicle heating window 2000 detected by the sensor unit 4100.

The sensor unit 4100 may output the sensor signal U10 corresponding to the degree at which fog, frost, or ice is generated to the control device 3000. Alternatively, the sensor unit 4100 may output the sensor signal U10 indicating whether fog, frost, or ice is generated to the control device 3000.

The user interface 4200 may be a means capable of receiving a command from a user. The user interface 4200 may also be a partial configuration of the vehicle 1000 or a component included in a device configured separately from the vehicle 1000.

When the user interface 4200 is the partial configuration of the vehicle 1000, the user interface 4200 may be implemented as a button, a touch panel, or the like installed inside the vehicle 1000.

When the user interface 4200 is a component included in the device configured separately from the vehicle 1000, the user interface 4200 may be implemented as a mobile device wirelessly connected to the vehicle 1000.

The user interface 4200 may output a user input signal U20 when a command is input from the user. The user input signal U20 may be a signal corresponding to the user's command.

The sensor signal U10 and the user input signal U20 may be transmitted to the control device 3000. However, although not shown in the drawing, the sensor signal U10 and the user input signal U20 may be transmitted to the control device 3000 through a separate control device. The separate control device may be a main controller for controlling the entire vehicle 1000.

When the sensor signal U10 and the user input signal U20 are transmitted to the control device 3000 through the main controller, the sensor unit 4100 and the user interface 4200 are components already installed on or connected to the vehicle 1000. In other words, the vehicle heating window system may control the vehicle heating window 2000 using the sensor unit 4100 and the user interface 4200 implemented in a conventional vehicle.

The control device 3000 may receive a start signal IG. The start signal IG may be an electrical signal for making the vehicle 1000 mechanically and electrically operable.

After receiving the start signal IG, the control device 3000 may receive the sensor signal U10 or the user input signal U20. The control device 3000 may receive the start signal IG and output a voltage when receiving the sensor signal U10 or the user input signal U20.

The control device 3000 may output a voltage based on a magnitude of the sensor signal U10. The control device 3000 may output a different voltage on the basis of the magnitude of the sensor signal U10.

For example, the control device 3000 may also output a voltage having a different level on the basis of the magnitude of the sensor signal U10, and the control device 3000 may also adjust a voltage application time on the basis of the magnitude of the sensor signal U10. Alternatively, the control device 3000 may also output the voltage only when the magnitude of the sensor signal U10 exceeds a threshold. The threshold may be a value preset by a user.

Alternatively, the control device 3000 may output the voltage to the vehicle heating window 2000 when receiving the sensor signal U10. In other words, the control device 3000 may output the voltage when a non-zero voltage is transmitted to the sensor signal U10. In this case, the sensor unit 4100 may be configured to output the sensor signal U10 by comparing the detected value and the threshold.

The vehicle heating window 2000 may be heated by receiving the voltage from the control device 3000. The vehicle heating window 2000 may be heated at a different intensity on the basis of the voltage received from the control device 3000. The vehicle heating window 2000 may be heated for a different heating time or at a different heating intensity.

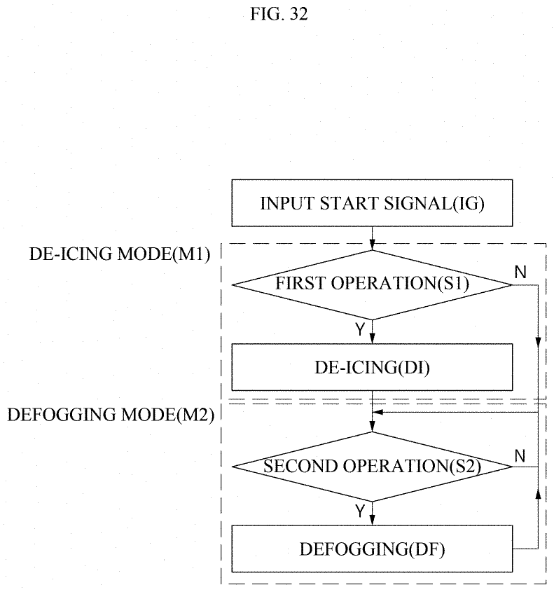

FIG. 32 is a flowchart showing a sequence in which de-icing or defogging is performed in a control device according to a tenth embodiment.

Referring to FIG. 32, when receiving an electrical signal, a control device 3000 according to the tenth embodiment may perform the driving of the de-icing DI or the defogging DF by outputting a voltage.

The de-icing DI may heat the vehicle heating window 2000 to remove the frost or ice generated on the vehicle heating window 2000. The defogging DF may heat the vehicle heating window 2000 to remove the fog generated on the vehicle heating window 2000. The vehicle heating window 2000 may be heated by receiving the voltage from the control device 3000.

The de-icing DI may require more heat than the defogging DF. Therefore, the de-icing DI may have a longer heating time or greater heating intensity than those of the defogging DF. Specifically, when the voltages applied by the control device 3000 to the vehicle heating window 2000 are the same, the de-icing DI time may be longer than the defogging DF time. When the de-icing DI time and the defogging DF time are the same, the magnitude of the voltage applied by the control device 3000 may be greater for the de-icing DI than the defogging DF. However, as necessary, the control device may also perform the de-icing DI and the defogging DF at the same voltage and time.

The control device 3000 may be driven in a de-icing mode M1 and a defogging mode M2.

The control device 3000 may first receive the start signal IG. When the start signal IG is transmitted to the control device 3000, the control device 3000 may activate the de-icing mode M1.

The de-icing mode M1 is a state in which the control device 3000 is set to perform the driving of the de-icing DI. The de-icing mode M1 may be a mode that is automatically set when the start signal IG is input to the control device 3000.

The control device 3000 may perform the driving of the de-icing DI through a first operation S1 in the de-icing mode M1.

The first operation S1 may be an operation in which the control device 3000 determines whether the driving of the de-icing DI needs to be performed. The first operation S1 may be an operation in which the control device 3000 determines whether the driving of the de-icing DI is required on the basis of the magnitude of the sensor signal U10. Alternatively, the control device 3000 may determine whether the driving of the de-icing DI is required on the basis of whether the sensor signal U10 is input.

When the control device 3000 determines whether the driving of the de-icing DI is required on the basis of the magnitude of the sensor signal U10, the first operation S1 may be an operation in which the control device 3000 determines whether the driving of the de-icing DI is required on the basis of the magnitude of the sensor signal U10. In this case, in the first operation S1, the control device 3000 may determine whether the driving of the de-icing DI is required by comparing a preset threshold with the sensor signal U10.

When the control device 3000 determines whether the driving of the de-icing DI is required on the basis of whether the sensor signal U10 is input, the first operation S1 may be an operation in which the control device 3000 determines whether the driving of the de-icing DI is required on the basis of whether the sensor signal U10 is input.

When the control device 3000 determines that the driving of the de-icing DI needs to be performed in the first operation S1, the control device 3000 may perform the driving of the de-icing DI.

Alternatively, when receiving the user input signal U20 regardless of the input or the magnitude of the sensor signal U10, the control device 3000 may perform the driving of the de-icing DI.

When the driving of the de-icing DI is terminated, the control device 3000 may terminate the de-icing mode M1. However, when the control device 3000 determines that the driving of the de-icing DI is not required in the first operation S1, the control device 3000 may not perform the de-icing DI. Specifically, when it is determined that the sensor signal U10 or the user input signal U20 is not input to the control device 3000 in the first operation S1, the control device 3000 may not perform the de-icing DI. In this case, the de-icing mode M1 may be terminated after a preset time elapses. The preset time may be a time that may be arbitrarily set by a user or may also be a time that is set at the time of manufacturing the vehicle 1000.

The preset time may be calculated on the basis of an input time of the start signal IG. In other words, the control device 3000 may set the de-icing mode M1 on the basis of the input time of the start signal IG. In other words, the control device 3000 may activate the de-icing mode M1 when receiving the start signal IG and terminate the de-icing mode M1 when not receiving the sensor signal U10 or the user input signal U20 for a predetermined time from the input time of the start signal IG.

When the de-icing mode M1 is terminated, the control device 3000 may activate the defogging mode M2.

The defogging mode M2 is a state in which the control device 3000 is set to perform the defogging DF. The defogging mode M2 may be a mode that is automatically set when the de-icing mode M1 is terminated. The defogging mode M2 may be terminated when the vehicle 1000 is turned off.

The control device 3000 may perform the driving of the defogging DF through a second operation S2 in the defogging mode M2.

The second operation S2 may be an operation in which the control device 3000 determines whether the defogging DF needs to be performed. The control device 3000 may determine whether the driving of the defogging DF is required on the basis of the magnitude of the sensor signal U10. Alternatively, the control device 3000 may determine whether the driving of the defogging DF is required on the basis of whether the sensor signal U10 is input.

When the control device 3000 determines whether the driving of the defogging DF is required on the basis of the magnitude of the sensor signal U10, the second operation S2 may be an operation in which the control device 3000 determines whether the driving of the defogging DF is required on the basis of the magnitude of the sensor signal U10. In this case, in the second operation S2, the control device 3000 may determine whether the driving of the defogging DF is required by comparing a preset threshold with the sensor signal U10.

The thresholds compared with the sensor signal U10 by the control device 3000 in the first operation S1 and the second operation S2 may be different from each other. The threshold required for driving the defogging DF may be smaller than the threshold required for driving the de-icing DI.

When the control device 3000 determines whether the driving of the defogging DF is required on the basis of whether the sensor signal U10 is input, the second operation S2 may be an operation in which the control device 3000 determines whether the driving of the defogging DF is required on the basis of whether the sensor signal U10 is input.

When the control device 3000 determines that the driving of the defogging DF needs to be performed in the second operation S2, the control device 3000 may perform the driving of the defogging DF.

Alternatively, the control device 3000 may perform the driving of the defogging DF when receiving the user input signal U20 regardless of the input or the magnitude of the sensor signal U10.

However, when the control device 3000 determines that the driving of the defogging DF is not required in the second operation S2, the control device 3000 may not perform the defogging DF. Specifically, when it is determined that the sensor signal U10 or the user input signal U20 is not input to the control device 3000 in the second operation S2, the control device 3000 may not perform the defogging DF.

Even when the control device 3000 does not perform the driving of the defogging DF as well as performs the driving of the defogging DF, the defogging mode M2 is not terminated and may be continuously maintained in an active state. In other words, even after the de-icing DI and/or the defogging DF is terminated, the defogging mode M2 may still be activated. Therefore, when receiving the sensor signal U10 or the user input signal U20 is input to the control device 3000 during the traveling period of the vehicle 1000, the control device 3000 may continuously perform the defogging DF.

The control device 3000 may automatically activate the de-icing mode M1 after the start signal IG is input to the control device 3000. In this case, since the de-icing DI may be performed according to the situation of the vehicle 1000 even without a separate user input, it is possible to remove frost or ice conveniently and more quickly.

Since the defogging mode M2 is sequentially activated when the de-icing mode M1 is terminated, the defogging DF may also be performed according to a situation of the vehicle 1000 even without a separate user input, and thus it is possible to remove fog conveniently and more quickly.

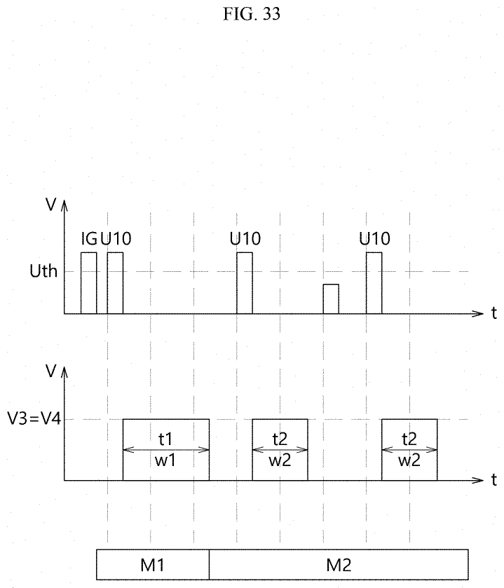

FIG. 33 is a waveform diagram showing a time and a voltage when the control device according to the tenth embodiment performs de-icing and defogging. A horizontal axis of the table indicates a time, and a vertical axis indicates a voltage.

Referring to FIG. 33, the control device 3000 may perform the de-icing DI in a state in which the de-icing mode M1 is activated and perform the defogging DF in a state in which the defogging mode M2 is activated.

When receiving the start signal IG, the control device 3000 may activate the de-icing mode M1.

When the sensor signal U10 is input to the control device 3000 in the de-icing mode M1, the control device 3000 may perform the driving of the de-icing DI by outputting a voltage. In this case, the control device 3000 may output a third voltage V3. When the sensor signal U10 is input to the control device 3000 in the de-icing mode M1, the control device 3000 may perform the driving of the de-icing DI by outputting the third voltage V3 for a predetermined time. In this case, the control device 3000 may perform the driving of the de-icing DI by outputting the third voltage V3 for a first time t1.

After the control device 3000 performs the de-icing DI, the de-icing mode M1 may be terminated. When the de-icing mode M1 is terminated, the control device 3000 may activate the defogging mode M2.

When the sensor signal U10 is input to the control device 3000 in the defogging mode M2, the control device 3000 may perform the defogging DF by outputting a voltage. In this case, the control device 3000 may output a fourth voltage V4. When the sensor signal U10 is input to the control device 3000 in the defogging mode M2, the control device 3000 may perform the driving of the defogging DF by outputting the fourth voltage V4 for a predetermined time. In this case, the control device 3000 may perform the driving of the defogging DF by outputting the fourth voltage V4 for a second time t2.

In the defogging mode M2, the control device 3000 may determine whether to perform the driving of the defogging DF according to the magnitude of the sensor signal U10. The control device 3000 may perform the defogging DF when receiving a signal that is greater than or equal to a threshold Uth. In other words, as shown in the drawing, the defogging DF may not be performed when a signal that is smaller than or equal to the threshold Uth is input, and the defogging DF may be performed when receiving a signal greater than or equal to the threshold Uth. Although not shown in the drawing, even when the control device 3000 determines whether to perform the driving of the de-icing DI in the de-icing mode M1, the determination is made in the same manner as described above, and the control device 3000 may perform the driving of the de-icing DI.

The defogging mode M2 may still be activated as long as the vehicle 1000 is not turned off even after the driving of the defogging DF is terminated. Therefore, when the sensor signal U10 is continuously input to the control device 3000 in the defogging mode M2, the control device 3000 may repeatedly perform the defogging DF.

The control device 3000 in the tenth embodiment may output pulses having different powers according to modes. A pulse that may be output by the control device 3000 in the de-icing mode M1 and a pulse that may be output by the control device 3000 in the defogging mode M2 may have different powers. The control device 3000 may output pulses having different powers when driving the de-icing DI and when driving the defogging DF.

The control device 3000 may output a pulse having a first power w1 when driving the de-icing DI and output a pulse having a second power w2 when driving the defogging DF.

When driving the de-icing DI, the control device 3000 may output the third voltage V3 for the first time t1. At this time, the output power may be the first power w1. When driving the defogging DF, the control device 3000 may output the fourth voltage V4 for the second time t2. At this time, the output power may be the second power w2. The first power w1 may be higher than the second power w2.

The first power w1 may be proportional to a magnitude of the third voltage V3 and a length of the first time t1, and the second power w2 may be proportional to a magnitude of the fourth voltage V4 and a length of the second time t2. In the drawing, the magnitudes of the third voltage V3 and the fourth voltage V4 are the same, and the control device 3000 may adjust magnitudes of the output powers by controlling the lengths of the first time t1 and the second time t2. In this case, the first time t1 may be longer than the second time t2.

When driving the de-icing DI, the control device 3000 may output relatively higher power than when driving the defogging DF. Therefore, it is possible to more effectively remove frost or ice that may be present in the stage when the vehicle 1000 is started.

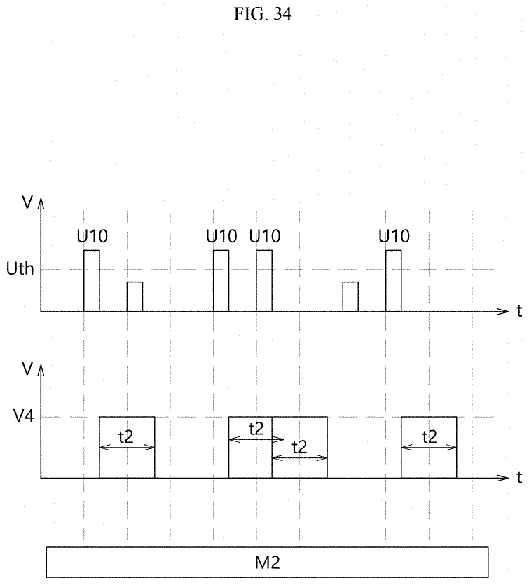

FIG. 34 is a waveform diagram showing the driving of defogging of the control device according to the tenth embodiment.

Referring to FIG. 34, the control device 3000 according to the tenth embodiment may continuously perform the defogging DF in the defogging mode M2.

In the defogging mode M2, the control device 3000 may repeatedly receive the sensor signal U10. The sensor signal U10 may be a signal that is greater than or equal to the threshold Uth. In this case, the control device 3000 may continuously perform the driving of the defogging DF.

When fog is continuously generated on the vehicle heating window 2000, the sensor unit 4100 may continuously output the sensor signal U10 even when the driving of the defogging DF is being performed. In this case, the control device 3000 may receive the sensor signal U10.

When the control device 3000 receives the sensor signal U10 while driving the defogging DF, the control device 3000 may continuously perform the driving of the defogging DF. The control device 3000 may perform the driving of the defogging DF for a relatively long time. The control device 3000 may perform the driving of the defogging DF for a longer time than the second time t2.

The control device 3000 may perform the defogging DF in response to the lastly received sensor signal U10 and then terminate the defogging DF.

Although not shown in the drawing, the control device 3000 may continuously perform the de-icing DI in the de-icing mode M1 like the defogging DF.

In the de-icing mode M1, the control device 3000 may repeatedly receive the sensor signal U10. The sensor signal U10 may be a signal that is greater than or equal to the threshold Uth. In this case, the control device 3000 may continuously perform the de-icing DI. When frost or ice is continuously present on the vehicle heating window 2000, the sensor unit 4100 may continuously output the sensor signal U10 even when the driving of the de-icing DI is being performed. In this case, the control device 3000 may receive the sensor signal U10. In this case, the sensor signal U10 input to the control device 3000 may be a signal that is greater than or equal to the threshold Uth.

When the control device 3000 receives a signal that is greater than or equal to the threshold Uth while driving the de-icing DI, the control device 3000 may continuously perform the driving of the de-icing DI. The control device 3000 may perform the driving of the de-icing DI for a relatively long time. The control device 3000 may perform the driving of the de-icing DI for a longer time than the first time t1.

The control device 3000 may terminate the de-icing DI after performing the de-icing DI in response to the lastly received sensor signal U10.

When the control device 3000 performs the driving of the de-icing DI or the defogging DF for a longer time, the control device 3000 may remove fog, frost, ice, or the like generated on the vehicle heating window 2000 relatively quickly. Therefore, it may be much easier to secure the driver's view when the vehicle 1000 travels.

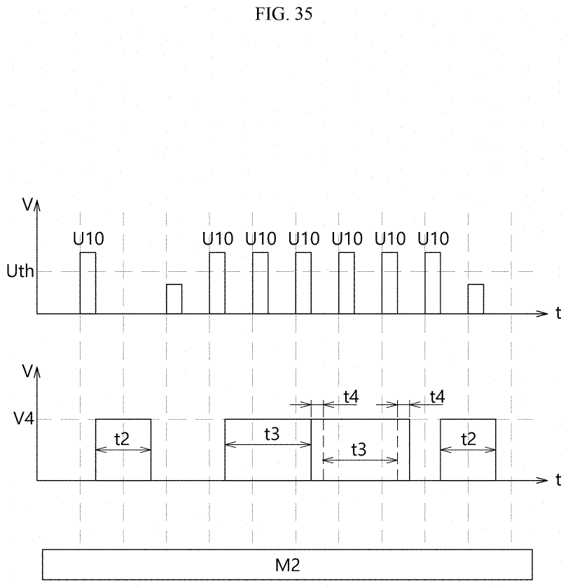

FIG. 35 is a waveform diagram showing the driving of de-icing and defogging of the control device according to the tenth embodiment.

Referring to FIG. 35, the control device 3000 according to the tenth embodiment may repeatedly perform the defogging DF.

In the defogging mode M2, the control device 3000 may repeatedly receive the sensor signal U10. The sensor signal U10 may be a signal that is greater than or equal to the threshold Uth. In this case, the control device 3000 may continuously perform the defogging DF.

When fog is continuously generated on the vehicle heating window 2000, the sensor unit 4100 may continuously output the sensor signal U10 even when the driving of the defogging DF is being performed. In this case, the control device 3000 may receive the sensor signal U10.

When the control device 3000 receives the sensor signal U10 while driving the defogging DF, the control device 3000 may repeatedly perform the driving of the defogging DF. The control device 3000 may perform the driving of the defogging DF for a relatively long time.

However, the control device 3000 may perform an overheating prevention operation to prevent overheating of the vehicle heating window 2000. The overheating prevention operation may be an operation in which the control device 3000 stops the output of the voltage to the vehicle heating window 2000 during an overheating prevention section.

The control device 3000 may perform the overheating prevention operation when the sensor signal U10 is repeatedly inputted to the control device 3000 several times while the driving of the defogging DF is performed. The number of times of input of the sensor signal U10 that causes the control device 3000 to perform the overheating prevention operation may be predefined. Preferably, the sensor signal U10 may be repeatedly input to the control device 3000 three or more times. The control device 3000 may extend a driving time of the defogging DF whenever receiving the sensor signal U10. The control device 3000 may perform the driving of the defogging DF for a third time t3.

When the number of times of input of the sensor signal U10 satisfies an overheating prevention operation condition, the control device 3000 may not output a voltage during the overheating prevention section. The overheating prevention section may be a fourth time t4. The third time t3 may be longer than the second time t2, and the fourth time t4 may be shorter than the second time t2.

When the control device 3000 performs the driving of the defogging DF for a preset time, the control device 3000 may perform the overheating prevention operation. The preset time may be a time that may be arbitrarily set by a user or may also be a time that is set at the time of manufacturing the vehicle 1000. The preset time may be the third time t3.

When a driving execution time of the defogging DF satisfies the overheating prevention operation condition, the control device 3000 may not output a voltage for the fourth time t4 that is the overheating prevention section. The third time t3 may be longer than the second time t2, and the fourth time t4 may be shorter than the second time t2.

When the control device 3000 performs the overheating prevention operation described above and the fourth time t4 elapses, the control device 3000 re-performs the driving of the defogging DF regardless of the input of the sensor signal U10. In other words, when the fourth time t4 elapses, the control device 3000 may re-perform the driving of the defogging DF by outputting the fourth voltage V4.

Alternatively, after performing the overheating prevention operation, the control device 3000 may perform the driving of the defogging DF in response to the sensor signal U10 received after the fourth time t4 elapses. In other words, when the sensor signal U10 is input to the control device 3000 after the fourth time t4 elapses, the control device 3000 may perform the driving of the defogging DF by outputting the fourth voltage V4. This may mean that the control device 3000 performs the overheating prevention operation, and the driving of the defogging DF is terminated, and the driving of a new defogging DF starts to be performed by a later newly inputted sensor signal U10. The control device 3000 may perform the defogging DF in response to the lastly received sensor signal U10 and then terminate the defogging DF.

All types of the driving of the defogging DF after performing the overheating prevention operation described above are shown in the drawing but the present invention is not limited thereto, which may be preset by the user or may be preset at the time of manufacturing the vehicle 1000.

Although not shown in the drawing, the control device 3000 may repeatedly receive the sensor signal U10 even when the driving of the de-icing DI is being performed in the de-icing mode M1 like the defogging DF. In this case, the control device 3000 may continuously perform the de-icing DI.

However, when the control device 3000 satisfies the overheating prevention operation condition in the de-icing mode M1, the control device 3000 may perform the overheating prevention operation. The overheating prevention operation condition of the control device 3000 in the de-icing mode M1 may be the same as the overheating prevention operation condition of the control device 3000 in the defogging mode M2.

When the control device 3000 satisfies the overheating prevention operation condition, the control device 3000 may perform the driving of the de-icing DI for a longer time than the first time t1 and may not perform the driving of the de-icing DI for a shorter time than the first time t1, which is the overheating prevention section.

When the control device 3000 does not perform the de-icing DI in the overheating prevention section, the driving of the de-icing DI is terminated. When the driving of the de-icing DI is terminated, the de-icing mode M1 may be terminated, and the defogging mode M2 may be activated.

When the driving of the defogging DF or the de-icing DI is continuously performed for a long time, the vehicle heating window 2000 may be overheated. In this case, the vehicle heating window 2000 may be broken. Therefore, in order to prevent such a risk, the control device 3000 may perform the overheating prevention operation.

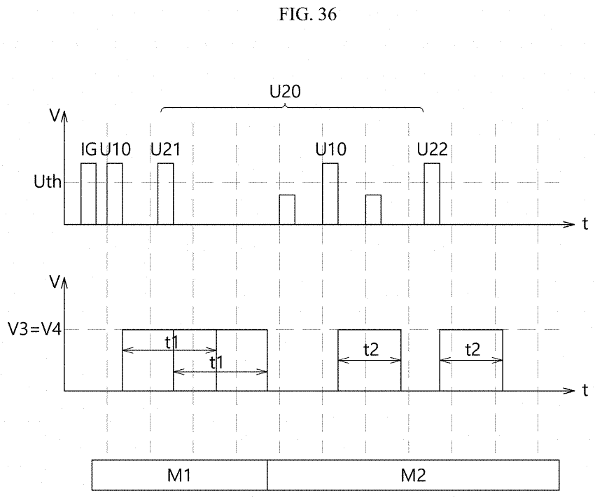

FIG. 36 is a waveform diagram showing the driving of de-icing and defogging of the control device according to the tenth embodiment.

Referring to FIG. 36, when the control device 3000 according to the tenth embodiment receives the sensor signal U10 or the user input signal U20, the control device 3000 may perform the driving of the de-icing DI or the defogging DF.

In the de-icing mode M1 or the defogging mode M2, the control device 3000 may receive the sensor signal U10 and the user input signal U20. In this case, the control device 3000 may perform the driving of the de-icing DI or the defogging DF.

In the de-icing mode M1 or the defogging mode M2, the sensor signal U10 may be periodically transmitted to the control device 3000. However, unlike the sensor signal U10, the user input signal U20 may not be periodically transmitted to the control device 3000. The user input signal U20 may be output through the user interface 4200 when a user desires. Therefore, the control device 3000 may receive the user input signal U20 at any time.

The user input signal U20 may include a de-icing signal U21 and a defogging signal U22. The de-icing signal U21 may be an electrical signal output through the user interface 4200 by the user input in the de-icing mode M1. The defogging signal U22 may be an electrical signal output through the user interface 4200 by the user input in the defogging mode M2.

When the sensor signal U10 and the de-icing signal U21 are transmitted to the control device 3000 in the de-icing mode M1, the control device 3000 may perform the driving of the de-icing DI. When the sensor signal U10 and the defogging signal U22 are transmitted to the control device 3000 in the defogging mode M2, the control device 3000 may perform the driving of the defogging DF.

Although not shown in the drawing, when the de-icing signal U21 is transmitted to the control device 3000 while the driving of the de-icing DI is being performed, the control device 3000 may continuously perform the driving of the de-icing DI like the sensor signal U10 is transmitted thereto. When the defogging signal U22 is transmitted to the control device 3000 while the driving of the defogging DF is being performed, the control device 3000 may continuously perform the driving of the defogging DF as if the sensor signal U10 is transmitted thereto. In other words, when receiving the user input signal U20 while performing the de-icing DI and the defogging DF, as shown in FIGS. 34 and 35, the control device 300 may perform the driving of the de-icing DI and or the defogging DF.

The user may output the user input signal U20 through the user interface 4200 even when fog, ice, or frost is not generated on the vehicle heating window 2000. In other words, the user may output the user input signal U20 through the user interface 4200 when the user desires. The user may enable the driving of the de-icing DI and the defogging DF to be performed when the user desires.

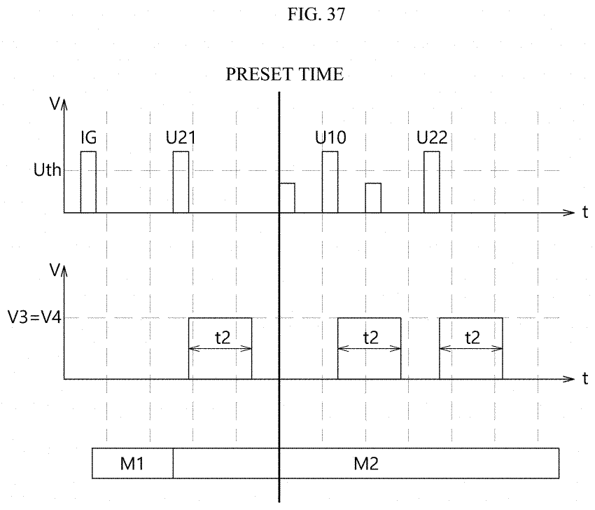

FIG. 37 is a waveform diagram showing the driving of de-icing and defogging of a control device according to an eleventh embodiment. A horizontal axis of the table indicates a time, and a vertical axis indicates a voltage.

A difference between the control device 3000 according to the eleventh embodiment and the control device 3000 according to the tenth embodiment is activation conditions of the de-icing mode M1 and the defogging mode M2, and the remaining configuration is the same. Therefore, in describing the control device 3000 according to the eleventh embodiment, the same reference numerals are denoted by the components common to the tenth embodiment, and detailed descriptions thereof will be omitted.

Referring to FIG. 37, the control device 3000 according to the eleventh embodiment may perform the de-icing DI in the de-icing mode M1 and perform the defogging DF in the defogging mode M2.

When receiving the start signal IG, the control device 3000 may activate the de-icing mode M1. In general, when an electrical signal is input to the control device 3000 in the de-icing mode M1, the control device 3000 may perform the driving of the de-icing DI and then terminate the de-icing mode M1. However, when the electrical signal is not input to the control device 3000 in the de-icing mode M1, the control device 3000 may terminate the de-icing mode M1 after a preset time elapses. The preset time may be a time that may be arbitrarily set by a user or may also be a time that is already set in the vehicle 1000.

In the de-icing mode M1, the control device 3000 may receive the sensor signal U10 and the user input signal U20. In the de-icing mode M1, the control device 3000 may receive not only the sensor signal U10 and the de-icing signal U21 but also the defogging signal U22.

In the de-icing mode M1, the control device 3000 may receive the defogging signal U22 in a state of not driving the de-icing DI as shown in the drawing, or also receive the defogging signal U22 while driving the de-icing DI.

When the control device 3000 receives the defogging signal U22 in a state of not driving the de-icing DI in the de-icing mode M1, the control device 3000 may perform the driving of the defogging DF. In other words, in this case, the control device 3000 may terminate the de-icing mode M1 even when the preset time at which the de-icing mode M1 is set to be activated does not elapse, and perform the driving of the defogging DF by activating the defogging mode M2.

Although not shown in the drawing, when the control device 3000 receives the defogging signal U22 while driving the de-icing DI in the de-icing mode M1, the control device 3000 may perform the driving of the defogging DF. In other words, in this case, the control device 3000 may perform the driving of the de-icing DI and terminate the de-icing mode M1, and may activate the defogging mode M2 by activating the defogging mode M2.

Even when the control device 3000 performs the driving of the de-icing DI in the de-icing mode M1, the user may want to perform the driving of the defogging DF for reasons such as fuel cost reduction. In this case, the user may directly output the defogging signal U22 through the user interface 4200, and the control device 3000 may receive the defogging signal U22 and perform the driving of the defogging DF.

The user may output the defogging signal U22 through the user interface 4200 when the user desires. The user may terminate the de-icing mode M1 when the user desires and activate the defogging mode M2 to enable the driving of the defogging DF to be performed.

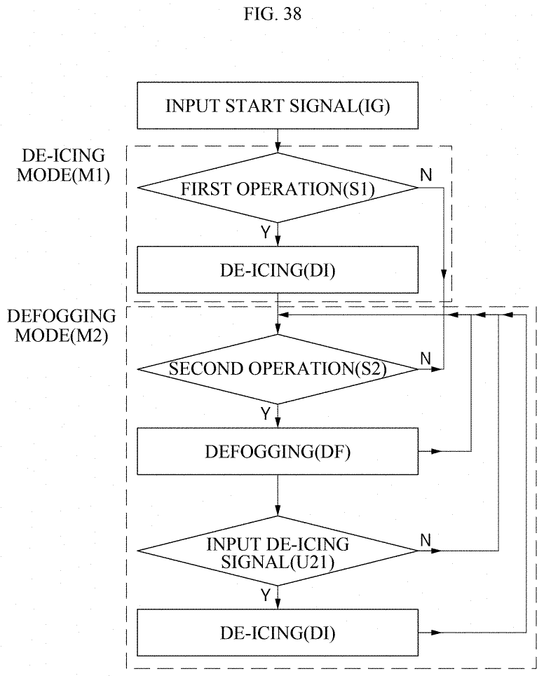

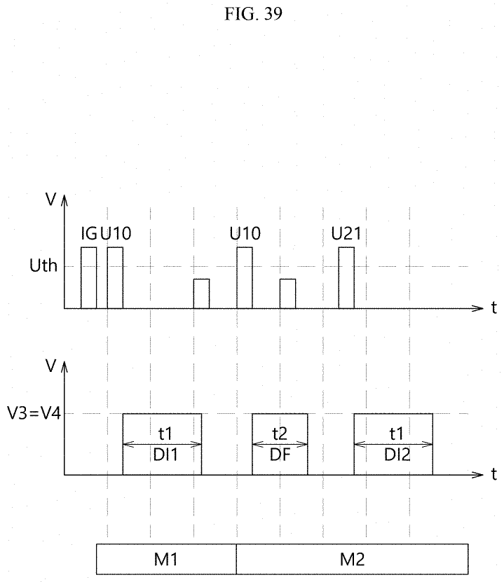

FIGS. 38 and 39 are a flowchart and a waveform diagram showing that a control device according to the twelfth embodiment performs de-icing and defogging and then re-performs the de-icing.

A difference between the control device 3000 according to the twelfth embodiment and the control device 3000 according to the tenth embodiment is whether the driving of the de-icing DI is performed in the defogging mode M2, and the remaining configuration is the same. Therefore, in describing the control device 3000 according to the twelfth embodiment, the same reference numerals are denoted by the components common to the tenth embodiment, and detailed descriptions thereof will be omitted.

Referring to FIG. 38, the control device 3000 may perform the driving of the de-icing DI in the defogging mode M2.

While the vehicle 1000 travels in a state in which the defogging mode M2 is activated, frost or ice may not be removed therefrom even when the defogging DF for the vehicle heating window 2000 is performed. In this case, in the defogging mode M2, the user may demand the driving of the de-icing DI. The vehicle heating window 2000 may need to perform the de-icing DI in the defogging mode M2.

When the de-icing signal U21 is output from the user interface 4200 through the user input in the defogging mode M2, the control device 3000 may receive the de-icing signal U21 and perform the driving of the de-icing DI.

Alternatively, even when ice, frost, or fog that is present on the vehicle heating window 2000 is removed or only fog is present by driving the defogging DF in the defogging mode M2, the user may demand the driving of the de-icing DI. In this case, the de-icing signal U21 may be output from the user interface 4200 by the user input in the defogging mode M2, and the control device 3000 may receive the de-icing signal U21 and perform the driving of the de-icing DI.

Although not shown in the drawing, even when the control device 3000 does not perform the driving of the defogging DF after the second operation S2 in the defogging mode M2, the control device 3000 may receive the de-icing signal U21 and perform the driving of the de-icing DI when the de-icing signal U21 is output from the user interface 4200 by the user input.

The control device 3000 may perform the driving of the de-icing DI regardless of whether the driving of the defogging DF is performed in the defogging mode M2. In other words, when the de-icing signal U21 is transmitted to the control device 3000 in the defogging mode M2, the control device 3000 may perform the driving of the de-icing DI.

Referring to FIG. 39, the driving of the de-icing DI may include driving of a first de-icing DI1 and driving of a second de-icing DI2.

The first de-icing DI1 may be the de-icing DI performed by the control device 3000 in the de-icing mode M1.

The second de-icing DI2 may be the de-icing DI performed by the control device 3000 in the defogging mode M2. The control device 3000 may drive the second de-icing DI2 only when receiving the de-icing signal U21 in the defogging mode M2.

The control device 3000 may perform the driving of the second de-icing DI2 at the same voltage and time as the voltage and time required for driving the first de-icing DI1. The control device 3000 may perform the driving of the second de-icing DI2 at the third voltage V3 for the first time t1 like driving the first de-icing DI1. The driving of the first de-icing DI1 and the driving of the second de-icing DI2 may be the same as the driving of the de-icing DI performed by the control device 3000 according to the tenth embodiment.

The user may enable the driving of the de-icing DI to be performed at any time when the user desires. For example, when frost or ice is generated on the vehicle heating window 2000 while the vehicle 1000 travels or even when only fog is present on the vehicle heating window 2000, the user may enable the driving of the de-icing DI to be performed at any time.

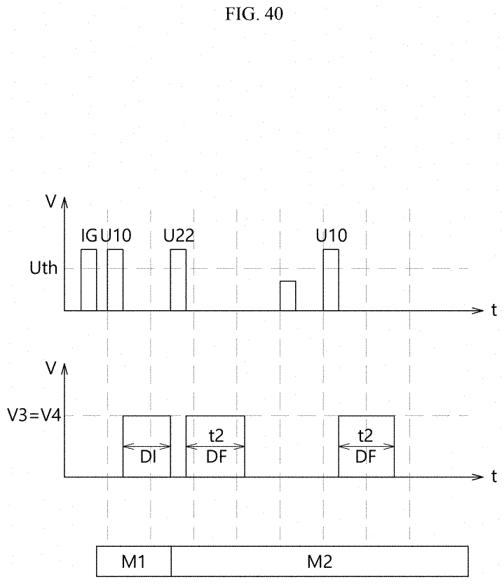

FIG. 40 is a waveform diagram showing the driving of de-icing and defogging of the control device according to the twelfth embodiment.

A difference between the control device 3000 according to the twelfth embodiment and the control device 3000 according to the tenth embodiment is whether the driving of the defogging DF is performed in the de-icing mode M1, and the remaining configuration is the same. Therefore, in describing the control device 3000 according to the twelfth embodiment, the same reference numerals are denoted by the components common to the tenth embodiment, and detailed descriptions thereof will be omitted.

Referring to FIG. 40, the control device 3000 according to the twelfth embodiment may perform the defogging DF when receiving the defogging signal U22 in the de-icing mode M1.

In the de-icing mode M1, the control device 3000 may receive the sensor signal U10 and the user input signal U20. In the de-icing mode M1, the control device 3000 may receive the de-icing signal U21 and the defogging signal U22.

When the driving of the de-icing DI is performed in the de-icing mode M1, the control device 3000 may receive the defogging signal U22. When the defogging signal U22 is input to the control device 3000 in the de-icing mode M1, the control device 3000 may terminate the driving of the de-icing DI. When the driving of the de-icing DI is terminated, the control device 3000 may terminate the de-icing mode M1 and perform the driving of the defogging DF by activating the defogging mode M2.

Although not shown in the drawing, when the driving of the de-icing DI is not performed in the de-icing mode M1, the control device 3000 may receive the defogging signal U22. In this case, the de-icing mode M1 may be terminated before a preset time elapses. When the de-icing mode M1 is terminated, the control device 3000 may perform the driving of the defogging DF by activating the defogging mode M2.

The driving of the defogging DF consumes less energy than the driving of the de-icing DI and thus may be effective in saving fuel. For the above reason, the user may desire the driving of the defogging DF instead of the driving of the de-icing DI in the de-icing mode M1. When manually receiving the defogging signal U22 through the user interface 4200, the control device 3000 may perform the driving of the defogging DF at any time.

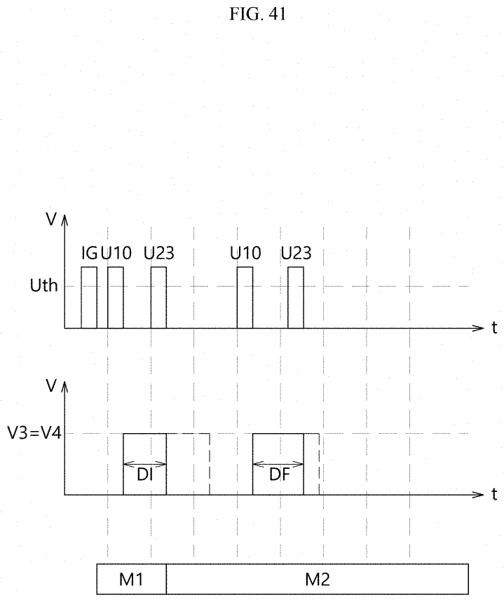

FIG. 41 is a waveform diagram showing the driving of de-icing and defogging of a control device according to a thirteenth embodiment.

The control device 3000 according to the thirteenth embodiment has the same configuration as the control device 3000 according to the tenth embodiment except that an end signal U23 is added. Therefore, in describing the control device 3000 according to the thirteenth embodiment, the same reference numerals are denoted by the components common to the tenth embodiment, and detailed descriptions thereof will be omitted.

Referring to FIG. 41, when the end signal U23 is input to the control device 3000, the control device 3000 may terminate the driving of the de-icing DI or the defogging DF.

In the de-icing mode M1 or the defogging mode M2, the control device 3000 may receive the end signal U23. The end signal U23 may be the user input signal U20. The end signal U23 may be output from the input unit 4000 only when the user inputs a command through the user interface 4200.

When the end signal U23 is transmitted to the control device 3000, the control device 3000 may terminate the driving of the de-icing DI and defogging DF. When the end signal U23 is transmitted to the control device 3000 while the driving of the de-icing DI is being performed in the de-icing mode M1, the driving of the de-icing DI may be terminated. When the driving of the de-icing DI is terminated, the control device 3000 may terminate the de-icing mode M1 and activate the defogging mode M2. When the end signal U23 is transmitted to the control device 3000 while the driving of the defogging DF is being performed in the defogging mode M2, the driving of the defogging DF may be terminated.

When the fog, frost or ice generated on the vehicle heating window 2000 is removed while the driving of the de-icing DI or the defogging DF is being performed, the user may no longer desire the driving of the de-icing DI or the defogging DF. In this case, the user may output the end signal U23 through the user interface 4200 and terminate the driving of the de-icing DI or the defogging DF. Therefore, it is possible to meet user's needs and save fuel. In addition, since the driving of the de-icing DI and the defogging DF is terminated earlier than a predetermined time, relatively less heat is applied to the vehicle heating window 2000, it is possible to maintain the durability of the vehicle heating window 2000.

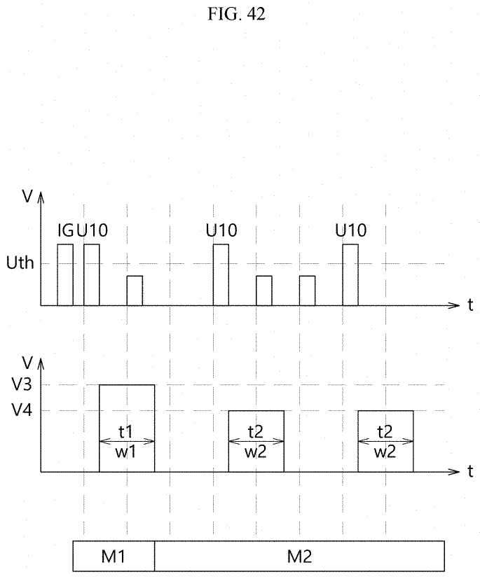

FIG. 42 is a waveform diagram showing the driving of de-icing and defogging of a control device according to a fourteenth embodiment. A horizontal axis of the table indicates a time, and a vertical axis indicates a voltage.

A difference between the control device 3000 according to the fourteenth embodiment and the control device 3000 according to the tenth embodiment is a configuration of the driving of the de-icing DI and the defogging DF, and the remaining configuration is the same. Therefore, in describing the control device 3000 according to the eleventh embodiment, the same reference numerals are denoted by the components common to the tenth embodiment, and detailed descriptions thereof will be omitted. In addition, the fourteenth embodiment may also include the configuration of the control device 3000 according to the eleventh to thirteenth embodiments based on the tenth embodiment.

Referring to FIG. 42, the control device 3000 according to the fourteenth embodiment may perform the driving of the de-icing DI in the de-icing mode M1 and the defogging DF in the defogging mode M2.

The control device 3000 according to the fourteenth embodiment may output a pulse having a first power w1 when driving the de-icing DI, and output a pulse having a second power w2 when driving the defogging DF.

When driving the de-icing DI, the control device 3000 may output the third voltage V3 for the first time t1. At this time, the output power may be the first power w1. When driving the defogging DF, the control device 3000 may output the fourth voltage V4 for the second time t2. At this time, the output power may be the second power w2. The first power w1 may be higher than the second power w2.

The first power w1 may be proportional to the magnitude of the third voltage V3 and the first time t1, and the second power w2 may be proportional to the magnitude of the fourth voltage V4 and the second time t2. In the drawing, the first time t1 and the second time t2 are the same, and the control device 3000 may adjust the magnitudes of the output powers by controlling the magnitudes of the third voltage V3 and the fourth voltage V4. In this case, the third voltage V3 may be greater than the fourth voltage V4.

Compared to the tenth embodiment, the first time t1 in the fourteenth embodiment may be shorter than the first time t1 in the tenth embodiment. The second time t2 in the fourteenth embodiment may be the same as the second time t2 in the tenth embodiment.

When driving the de-icing DI, the control device 3000 may output relatively higher power than when driving the defogging DF. When the control device 3000 performs the driving of the de-icing DI while controlling the magnitudes of the third voltage V3 and the fourth voltage V4, the control device 3000 according to the fourteenth embodiment may perform the driving of the de-icing DI for a shorter time than the control device 3000 according to the tenth embodiment. Therefore, it is possible to secure the driver's view faster than when the vehicle 1000 travels.

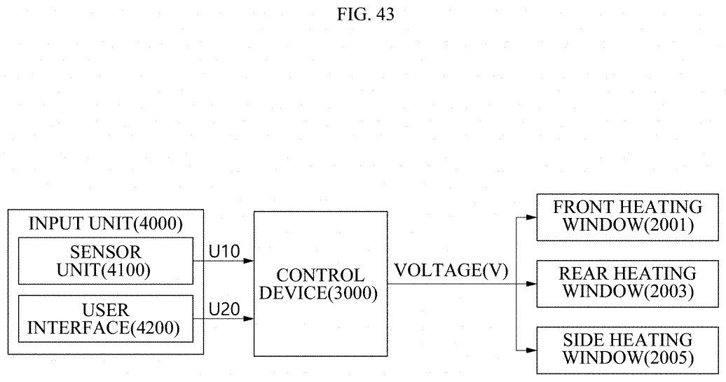

FIG. 43 is a view of a vehicle heating window system.

Referring to FIG. 43, the input unit 4000 may output the sensor signal U10 and the user input signal U20. The control device 3000 may apply a voltage to the vehicle heating window 2000 on the basis of the sensor signal U10 and the user input signal U20. The vehicle heating window 2000 may be heated on the basis of the voltage applied from the control device 3000. The vehicle heating window 2000 may include a vehicle front heating window 2001, a vehicle rear heating window 2003, and a heat-generating vehicle side window 2005.

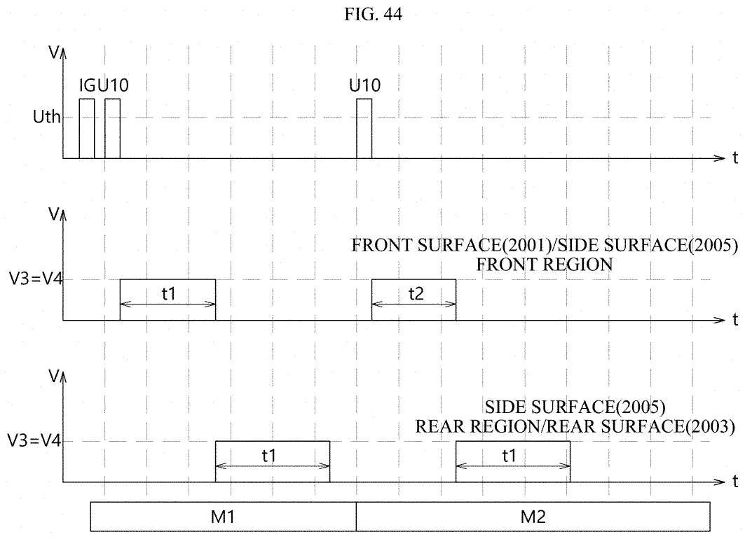

FIG. 44 is a waveform diagram showing a sequence in which the control device applies a voltage to the vehicle heating window.

Referring to FIG. 44, the control device 3000 according to the tenth embodiment may apply a voltage to the vehicle heating window 2000 with a time difference.

Among the vehicle heating windows 2000, the heat-generating vehicle side window 2005 may include the front region Aa and the rear region Ab. The front region Aa and the rear region Ab may be present in a case in which two lower busbars 2320 are included like the heat-generating vehicle side windows 2005 according to the fourth embodiment (see FIG. 14) and the fifth embodiment (see FIG. 15) described above.

The control device 3000 may preferentially perform the driving of the de-icing DI and the defogging DF for the vehicle front heating window 2001 and the front region Aa. The vehicle front heating window 2001 is positioned in a driver's general driving direction, and the front region Aa corresponds to a region adjacent to the side mirror. Since these correspond to regions in which the driver's view is essential when the vehicle 1000 travels, there is a need to preferentially perform the de-icing DI and the defogging DF therefor.

After the de-icing DI and the defogging DF for the vehicle front heating window 2001 and the front region Aa are terminated, the control device 3000 may perform the driving of the de-icing DI and the defogging DF for the rear region Ab and the vehicle rear heating window 2003. The rear region Ab and the vehicle rear heating window 2003 may not be regions in which the driver's view is essential when the vehicle 1000 travels. Therefore, the de-icing DI and the defogging DF may be performed later than the vehicle front heating window 2001 and the front region Aa.

In general, a voltage that the vehicle 1000 may use while traveling is limited to 12 V. When the control device 3000 simultaneously performs the driving of the de-icing DI and the defogging DF by applying the voltage to the vehicle heating window 2000, the control device 3000 may be overloaded because the control device 3000 needs to output a large amount of voltage at once. Therefore, the control device 3000 may generate heat from a region necessary for the vehicle 1000 to travel by dividing the vehicle heating window 2000 and driving the de-icing DI and defogging DF. The control device 3000 may preferentially perform the de-icing DI and the defogging DF for the vehicle front heating window 2001 and the front region Aa, and then perform the de-icing DI and the defogging DF for the rear region Ab and the vehicle rear heating window 2003.

The sequence of starting and ending the driving of the de-icing DI or the defogging DF for the vehicle heating window 2000 may not be dependent on FIG. 44.

The driving of the de-icing DI or the defogging DF for the vehicle front heating window 2001 and the front region Aa may be terminated after the driving of the de-icing DI or the defogging DF for the rear region Ab and the vehicle rear heating window 2003 is started or terminated. The driving of the de-icing DI or the defogging DF for the vehicle front heating window 2001 and the front region Aa may also be simultaneously terminated when the driving of the de-icing DI or the defogging DF for the rear region Ab and the vehicle rear heating window 2003 is terminated. Alternatively, the control device 3000 may separately or simultaneously perform the de-icing DI or the defogging DF for the vehicle front heating window 2001, the heat-generating vehicle side window 2005, and the vehicle rear heating window 2003.

What is claimed is:

1. A heat-generating vehicle side window comprising:
a base including an upper edge, a lower edge, a front edge, and a rear edge;
a heating member positioned adjacent to the base;
an upper busbar positioned on the heating member and electrically connected to the heating member; and
a lower busbar positioned on the heating member and electrically connected to the heating member,
wherein at least a portion of the heat-generating vehicle side window is covered by a frame including an upper frame, a lower frame, and side frames that are a front frame and a rear frame,
wherein the upper busbar has a shape corresponding to the upper edge and is formed in a three-dimensional curved structure having a side curvature and a sectional curvature,
wherein the upper busbar includes a first region and a second region,
wherein the first region is a region adjacent to the rear edge and has a first side curvature, and
wherein the second region is spaced apart from the rear edge and includes a portion having a second side curvature greater than the first side curvature.

2. The heat-generating vehicle side window of claim 1, wherein the lower busbar is formed in a three-dimensional curved structure having the side curvature and the sectional curvature,
wherein the lower busbar includes a third region and a fourth region,
wherein the third region is a region adjacent to the rear edge and has a third side curvature, and
wherein the fourth region is spaced apart from the rear edge and includes a portion having a fourth side curvature greater than the third side curvature.

3. The heat-generating vehicle side window of claim 1, wherein the first region has a first circle that is a virtual circle corresponding to the first side curvature,
wherein the second region has a second circle that is a virtual circle corresponding to the second side curvature, and
wherein a radius of the first circle is greater than a radius of the second circle.

4. The heat-generating vehicle side window of claim 2, wherein the third region has a third circle that is a virtual circle corresponding to the third side curvature,
wherein the fourth region has a fourth circle that is a virtual circle corresponding to the fourth side curvature, and
wherein a radius of the third circle is greater than a radius of the fourth circle.

5. The heat-generating vehicle side window of claim 1, wherein the first region has a first sectional curvature, and
wherein the first sectional curvature is smaller than the first side curvature.

6. The heat-generating vehicle side window of claim 1, wherein the upper busbar includes a straight region,
wherein the straight region is parallel to the lower frame,
wherein the straight region is covered by the side frame when the heat-generating vehicle side window moves in a first direction or second direction,
wherein the first direction is a direction toward the lower frame,
wherein the second direction is a direction toward the upper frame, and
wherein the straight region is the first region.

7. The heat-generating vehicle side window of claim 2, wherein the upper busbar and the lower busbar include regions to which the side curvature corresponds,
wherein the first region and the third region are regions corresponding to each other, and
wherein the second region and the fourth region are regions corresponding to each other.

8. The heat-generating vehicle side window of claim 2, wherein the upper busbar and the lower busbar include regions to which the side curvature partially corresponds,
wherein the first region and the third region are regions corresponding to each other, and
wherein the second side curvature of the second region is greater than the fourth side curvature of the fourth region.

9. The heat-generating vehicle side window of claim 2, wherein the lower busbar includes a first lower busbar and a second lower busbar, and
wherein the first lower busbar and the second lower busbar are positioned to be spaced apart from each other.

10. The heat-generating vehicle side window of claim 9, wherein the first lower busbar is positioned between the upper busbar and the second lower busbar.

11. The heat-generating vehicle side window of claim 9, wherein the first lower busbar and the second lower busbar are formed to extend from the lower edge to the rear edge.

12. The heat-generating vehicle side window of claim 9, wherein the first lower busbar receives a first voltage from a control device,
wherein the second lower busbar receives a second voltage from the control device, and
wherein the first voltage and the second voltage are alternately applied.

13. The heat-generating vehicle side window of claim 9, wherein the second lower busbar includes the third region and the fourth region, and
wherein the first lower busbar is formed in a region corresponding to the fourth region of the second lower busbar.

14. The heat-generating vehicle side window of claim 2, wherein the third region of the lower busbar and the fourth region of the lower busbar are positioned to be spaced apart from each other.

15. The heat-generating vehicle side window of claim 9, wherein the first lower busbar receives a first voltage from a control device,
wherein the second lower busbar receives a second voltage from the control device, and
wherein the second voltage is applied after the first voltage is applied and a preset time elapses.

16. The heat-generating vehicle side window of claim 1, wherein the upper busbar has a higher transmittance from the upper edge toward the lower edge.

17. The heat-generating vehicle side window of claim 1, wherein the upper busbar includes a plurality of first metal lines and a plurality of second metal lines,
wherein the plurality of first metal lines are parallel to each other and formed to extend from the front edge to the rear edge,
wherein the plurality of second metal lines are parallel to each other and formed to extend from the upper edge to the lower edge, and
wherein each of the first metal lines crosses each of the second metal lines and is electrically connected to each other.

18. The heat-generating vehicle side window of claim 17, wherein a metal line adjacent to the upper edge among the plurality of first metal lines has a greater line width than a metal line adjacent to the lower edge among the plurality of first metal lines.

19. The heat-generating vehicle side window of claim 17, wherein an interval between the second metal lines adjacent to the upper edge is smaller than an interval between the second metal lines adjacent to the lower edge.

20. The heat-generating vehicle side window of claim 1, wherein at least any one of one end and the other end of the upper busbar has a curved shape, and
wherein at least any one of one end and the other end of the lower busbar has a curved shape.
